(19) United States
(12) Patent Application Publication
(10) Pub. No.: US 2013/0204536 A1
(43) Pub. Date: Aug. 8, 2013

(54) METHODS OF KINOME ANALYSIS

(71) Applicants: Tony Kusalik, Saskatoon (CA); Yue Li, Toronto (CA); Scott Napper, Saskatoon (CA); Philip Griebel, Saskatoon (CA); Ryan Arsenault, Saskatoon (CA)

(72) Inventors: Tony Kusalik, Saskatoon (CA); Yue Li, Toronto (CA); Scott Napper, Saskatoon (CA); Philip Griebel, Saskatoon (CA); Ryan Arsenault, Saskatoon (CA)

(73) Assignee: UNIVERSITY OF SASKATCHEWAN, Saskatoon, SK (CA)

(21) Appl. No.: 13/805,966

(22) PCT Filed: Jun. 30, 2011
(86) PCT No.: PCT/CA11/00764

§ 371 Date: Feb. 15, 2013

Related U.S. Application Data
(60) Provisional application No. 61/360,177, filed on Jun. 30, 2010.
(60) Provisional application No. 61/434,156, filed on Jan. 19, 2011.

(51) Int. Cl. G06F 19/10

(52) U.S. Cl. CPC G06F 19/10
USPC 702/19

(57) ABSTRACT

Method for analyzing phosphorylation data of a plurality of peptides are provided, the method comprising obtaining one or more datasets, each dataset comprising a phosphorylation signal intensity for each replicate of the plurality of peptides for a sample; transforming the phosphorylation signal intensity of each replicate of the plurality of peptides using a variance stabilizing transformation to provide a variance stabilized signal intensity for each replicate of the plurality of peptides; and identifying one or more peptides of the plurality of peptides that is/are consistently phosphorylated or consistently unphosphorylated.

### RELATED APPLICATIONS

This application claims the benefit of U.S. Provisional Application No. 61/360,177, filed Jun. 30, 2010 and claims the benefit of U.S. Provisional Application No. 61/434,156, filed Jan. 19, 2011, each of those applications being incorporated herein in their entirety by reference.

### FIELD OF THE DISCLOSURE

Disclosed herein are methods and systems for analyzing microarray phosphorylation datasets and identifying peptides differentially phosphorylated.

### INTRODUCTION

Phosphorylation is a central mechanism for regulation of cellular processes. It involves one of the most important classes of enzymes, kinases (66; 37). Series of kinases and proteins which undergo phosphorylation often function in a defined series, or signaling pathway, to regulate, transmit and amplify a signal to particular cellular response. The cascading events of passing phosphate molecules through a sequence of kinases form a network of transductions, which are formally defined as signaling pathways. Deciphering the complex network of phosphorylation-based signaling is necessary for a thorough and therapeutically applicable understanding of the functioning of a cell in physiological and pathological states (55).

The therapeutic and biological prospects of kinases have prompted the development of novel strategies for quantification of their activities. Through high-throughput array technology facilitated by image analysis programs such as ArrayVision or Genepix, it is possible to address global kinase activity of a given species. That is the essence of kinome study. The number of kinase targets or peptides with phosphorylation sites included in an array varies, but is usually much less than the number of oligonucleotides embedded on a transcription array (54; 37).

In addition, the peptides may be recognized by the correct protein kinase, although sometimes with lower efficiency than when the sequence is in the context of an intact protein (37). Moreover, the kinome activities may vary depending on the individual subjects even for the same species. Thus, the reduction of dimensionality and the distinct biological nature of the data generate a concern with using the same systematic approach as in gene expression analysis. This is primarily centered around rigorously testing for the variability between the biological replicates, statistical stringency imposed on the differential analysis, and putting into perspective of known signaling pathways the information obtained from the differential peptides under a specific treatment relative to the control.

Linear Models for Microarray Data (limma), one of the most commonly used Bioconductor packages, provides data analysis and normalization for cDNA microarray data and analysis of differential expression for multi-factor designed experiments (76). The differential analysis component of the limma package is done through an empirical Bayes (eBayes) model that estimates the standard errors for each gene by borrowing information across genes and calculating the moderated t-statistic accordingly (73). Applications of limma for kinome analyses are emerging (71). In the study by Schrage et al., (71), however, the moderated t-statistics appear to be underestimated for the kinome data, and very few phosphorylated substrates have adjusted p-values less than 0.05, a commonly accepted significance level. This reflects the need to treat kinome data differently than transcription profiles (73).

### SUMMARY OF THE DISCLOSURE

An aspect provides a method of analyzing phosphorylation data of a plurality of peptides, the method comprising:
a) obtaining one or more datasets, each dataset comprising a phosphorylation signal intensity for each peptide of the plurality of peptides;
b) transforming the phosphorylation signal intensity of each peptide of the plurality of peptides using a variance stabilizing transformation to provide a variance stabilized signal intensity for each peptide of the plurality of peptides; and
c) identifying one or more peptides of the plurality of peptides that are consistently phosphorylated or consistently unphosphorylated.

Another aspect provides a method of analyzing phosphorylation data of a plurality of peptides, each peptide of the plurality present in at least two replicates, the method comprising:
a) obtaining one or more datasets, each dataset comprising a phosphorylation signal intensity for each replicate of the plurality of peptides;
b) transforming the phosphorylation signal intensity of each replicate of the plurality of peptides using a variance stabilizing transformation to provide a variance stabilized signal intensity for each replicate of the plurality of peptides; and
c) identifying one or more peptides of the plurality of peptides that are consistently phosphorylated or consistently unphosphorylated by calculating a phosphorylation consistency value for each peptide of the plurality of peptides, calculating the phosphorylation consistency value optionally comprising calculating a replicate variability for each peptide using the variance stabilized signal intensity of each replicate of the at least two replicates.

In an embodiment, the phosphorylation consistency value is calculated using a chi-square (χ²) test. In another embodiment, the method further comprises determining a phosphorylation characteristic of at least one of the one or more peptides that are consistently phosphorylated or consistently unphosphorylated.

In another embodiment, the method further comprises outputting a phosphorylation characteristic of the one or more peptides of the plurality of peptides.

In an embodiment, the phosphorylation characteristic is differential phosphorylation compared to a control.

In an embodiment, the results are presented in pseudo-images generated for example based on the p-values from the one-sided t-tests for phosphorylation or dephosphorylation of each peptide. Each peptide is optionally represented by one small colored circle, wherein the depths of the coloration are inversely related to the corresponding p-values.

Another aspect provides a computerized control system for controlling and receiving data, the computerized control system comprising at least one processor and memory configured to provide:
a) a control module to receive one or more datasets, each dataset comprising a plurality of phosphorylation signal intensities, each phosphorylation signal intensity corresponding to a peptide, each peptide present in at least two replicates;
b) an analysis module to:
   i. transform the phosphorylation signal intensity to provide a variance stabilized signal intensity for each replicate of the plurality of peptides using a variance stabilizing transformation;
   ii. determine a phosphorylation consistency value for each peptide; and
   iii. identify for consistently phosphorylated peptides, one or more peptides differentially phosphorylated compared to a control, optionally using a t-test.

A further aspect includes a non-transitory computer-readable storage medium comprising an executable program stored thereon, wherein the program instructs a processor to perform the following:
a) transform a phosphorylation signal intensity for each replicate of a plurality of peptides using a variance stabilizing transformation;
b) determine a phosphorylation consistency value for each peptide; and
c) identify one or more peptides consistently phosphorylated or consistently unphosphorylated based on the phosphorylation consistency value.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

An embodiment of the disclosure will now be discussed in relation to the drawings in which:

FIG. 1: A general workflow of the kinome analysis. The flow chart starts from the top left and follows the directions by the arrows. The rectangles represent procedures, and the oval, the intermediate result.

FIG. 2: Mean-variance-dependence plots before and after normalization by GeneSpring or transformation by variance stabilization (VSN) for the prion datasets. Rank of the mean signal intensities was plotted against the standard deviation (sd) of the corresponding peptide intensities. The plots from left to right represent the raw signal intensities, normalized intensities by GeneSpring, and VSN transformed intensities, respectively. The VSN transformation was done using an R function vsn, and the plot generated by R function meanSdPlot from the vsn package (59).

FIG. 3 (A): Scatter plots of the signal intensities under PrP against the corresponding intensities under Scram treatments from the prion datasets. The raw data were preprocessed in the following ways: top left panel, none; top right, logarithm with base 2 on the positive intensities (discarding the negative ones); bottom left, normalization by GeneSpring software to the median intensities for the same peptide (Section 2.1 in Example 1 for more details); bottom right, VSN transformation. The black and grey dots in each plot represent the averaged positive and negative raw data point after the background corrections, respectively. The correlation coefficient (r²) is indicated below the title of each plot.

FIG. 3 (B): Frequency distributions of the differences between treatments and controls in the prion datasets. The data were transformed by the following methods: top left and middle panels, none; top right and bottom left panels, GeneSpring; bottom middle and right panels, VSN transformation. The differences between treatments PrP and Scram as well as the differences between treatments 6H4 and Iso were plotted against the corresponding frequencies. The transformed data are expected to assume a distribution similar to the one formed by the raw data.

FIG. 4: Pseudo-image of prion datasets based on the p-values from the one-sided paired t-test. One-sided paired t-test was performed to identify differential phosphorylation status among the 300 peptides for human neuron under treatments PrP and 6H4 relative to the controls Scram and Iso, respectively. In each dot, the coloration on the left semi-circle ( [symbol] ) and right semi-circle ( [symbol] ) indicates the p-value from the tests of PrP vs Scram and 6H4 vs Iso, respectively. The “redness” (right side of scale bar) and “greenness” (left side of scale bar) are proportional to the significance level of phosphorylation and dephosphorylation, respectively. The number below each dot is the original position number of the corresponding peptide in the microarray. The dots were rearranged in the following way. In the order from top to bottom by column and from left to right of the array, the consistently phosphorylated, dephosphorylated peptides, and inconsistently phosphorylated peptides are presented. Within the consistently expressed peptides, the ones with the most significant p-values for phosphorylation/dephosphorylation on average over the two treatments are presented first followed by less significant ones. Similarly, the inconsistent ones with the largest differences between the p-values from PrP and 6H4 were presented first followed by ones with smaller differences. The figure was generated using R functions plot, rgb, and polygon.

FIG. 5: Neurotrophin signaling pathway enriched by differential peptides from the prion datasets corresponding to human neuron under treatment 6H4 relative to the Iso control. The significantly phosphorylated or dephosphorylated peptides were identified using one-sided paired t-test at 95% confidence. They are labelled FRS2, B-Raf, Raf, TrkB, PLCγ and CaMK in the diagram obtained from the KEGG database.

FIG. 6: Hierarchical clustering and PCA of the prion datasets. (A) The preprocessed peptides from the prion datasets were subjected to hierarchical clustering analysis. “Complete Linkage+Euclidean Distance” was used for clustering both the treatments (in vertical direction) and the peptides (in horizontal direction). The treatment names are indicated below the corresponding column profiles under the heat map, and the peptides names are indicated on the right side of the 300 corresponding row profiles. R function heatmap.2 from the gplots package was used to generate the figure. (B) The first three principal components from PCA based on the treatments were used for the 3D plot. The percentages of the total variability that the three PC's account for are displayed on the top of the box. The data points are labelled with the same corresponding treatment names as in (A). R functions prcomp and scatterplot3d were used for the PCA and the 3D plot, respectively.

FIG. 7: Mean-variance-dependence plot before and after variance stabilization (VSN) for the MAP datasets. Rank of the mean signal intensities was plotted against the standard deviation (sd) of the corresponding peptide intensities. The plot on the left and right represent the raw signal intensities and the VSN transformed intensities, respectively. The transformation was done using an R function vsn, and the plot generated by R function meanSdPlot from the vsn package (59).

FIG. 8: Scatter plots of raw versus VSN transformed intensities for selected animal-treatment replicates from the MAP datasets. Since there are 3 intra-array replicates for each peptide, 3 bovine animals (represented by their labels “89”, “136”, and “148”), and 4 treatments (i.e., “MAP+IFN”, “IFN”, “MAP”, and “Mono”), 36 plots in total for raw versus transformed replicate intensities for the 300 peptides can be drawn. The presented 12 out of the 36 plots were selected in such a way that the first three treatments all come from the first intra-array replicates, and second three from the second replicates, and so on. In each plot, the raw intensities (x-axis) in the 300 peptide replicates were plotted against the corresponding transformed intensities (y-axis) to determine whether the correlations between the intensities within the original dataset are maintained, which should be indicated by an increasing systematic trend, after the VSN transformation. Since VSN is a nonlinear transformation, curvature plots are expected. The remaining 24 plots all look similar to the ones presented here. The transformation was done using an R function vsn, and the plots generated by R function plot (59; 39).

FIG. 9 (A): Pseudo-image of MAP datasets based on the p-values from the one-sided paired t-test. One-sided paired t-test was performed to identify differential phosphorylation status among the 212 animal-independent peptides for bovine monocyte under treatments IFN, MAP, and MAP+IFN, relative to the Mono control. Each dot in the plot was partitioned into three parts with the top part of the circle representing the p-values from IFN, bottom left MAP, and bottom right MAP+IFN. Refer to the legend from FIG. 4 for details on the coloration. The boxed ones coloured in grey are the 88 animal-dependent peptides identified by the F-test. The ordering strategy was the same as in FIG. 4 except that, among the inconsistently phosphorylated ones across the three treatments, the consistently phosphorylated and dephosphorylated peptides within MAP and MAP+IFN were presented first followed by the remaining ones in no particular order.

FIG. 9(B): Pseudo-image of MAP datasets based on the p-values from the one-sided paired t-test. Comparisons between IFN (left semi-circle, [symbol] ) and MAP+IFN (right semi-circle, [symbol] ) using a method identical to the one for FIG. 4 except for the boxed grey dots for animal-dependent peptides.

FIG. 10: Jak-STAT signaling pathway enriched with differential peptides from the MAP datasets corresponding to bovine monocytes under treatment IFN relative to the Mono control. The significantly phosphorylated and dephosphorylated peptides were identified using the paired t-test at 95% confidence. They are labeled CtokineR, STAT, and CycD in the diagram obtained from the KEGG database.

FIG. 11(A): Hierarchical clustering and PCA of the MAP datasets. (A) The preprocessed peptides from MAP datasets were subjected to hierarchical clustering analysis. “Average Linkage+(1−Pearson Correlation)” was used for clustering both the animal-treatments (in vertical direction) and the peptides (in horizontal direction). Each column profile is labelled with the animal-code and treatment, separated by an underscore. For example, 89_IFN indicates animal 89 treated by IFN alone. The peptides names are indicated on the right side of the 300 corresponding row profiles. The R function heatmap.2 from the gplots package was used to generate the FIGURE.

FIG. 11(B): Hierarchical clustering and PCA of the MAP datasets. The first three principal components from PCA based on the animal-treatments were used for the 3D plot. The percentages of the total variability that the three PC's account for are displayed in the top of the box. The data points were labelled with the same corresponding animal-code and treatment names as in (A). R functions prcomp and scatterplot3d were used for the PCA and the 3D plot, respectively.

FIG. 12: Infection of Bovine Monocytes with Mycobacterium avium subspecies paratuberculosis. Cells were harvested using a trypsin/versene solution. The cells were prepped for cytospins by centrifugation at 325×g for 5 minutes. Cells were resuspended in 200 μL PBSA+0.1% EDTA. Cytospins were performed by adding 100 μL cell suspension to apparatus and spinning at 1000 rpm for 3 minutes onto a glass slide. Slides were allowed to dry overnight in fume hood. Cells were heat fixed to slides by briefly passing through flame. Slides were placed over boiling water and stained with carbol fuchsin for 5 minutes. Slides were rinsed and acid destain was briefly added to each slide before rinsing with water. Slides were counterstained using methylene blue (Sigma) for 1 minute and rinsed with water. Slides were allowed to dry overnight in fume hood. The next day, each “cytospot” was fixed using Entellen New Rapid Mounting Medium (EMScience) with a coverslip. Cells were observed on a light microscope under oil immersion (100×).

FIG. 13: IFNγ Stimulated Production of TNFα in MAP-infected and Non-infected Bovine Monocytes. TNFα levels of MAP-infected and uninfected bovine monocyte cells. Bovine monocyte cells were isolated from whole blood using CD14+ microbeads and MACS separation columns (Miltenyi Biotec). Bovine monocyte cells were infected with a 6 day liquid culture of Mycobacterium avium subspecies paratuberculosis at a 10:1 ratio. Plates were spun down at 2000 rpm for four minutes and then incubated at 37° C. for 3 hours. Cells were washed three times with warm RPMI media. IFNγ was added to appropriate wells at a final concentration of 10 ng/mL. Plates were returned to incubator overnight. Supernatant was collected from each well, diluted (½), and subsequently used to perform the bovine TNFα ELISA. Statistical analysis was through a paired t-test.

FIG. 14: 2D Principle Component Cluster Analysis of Kinome Data. Kinome data sets were subjected to PCA cluster analysis. Data sets for the animals are color coded; Animal 89 (red “R”), Animal 136 (green “G”) and Animal 148 (blue “B”). Treatment conditions are coded by shape; mono (squares), MAP (triangles), IFNγ (circles) and MAP infected IFNγ treated (stars). Individual treatment conditions are indicated. The rectangle indicates a conserved clustering of responses of uninfected monocytes to IFNγ stimulation. FIG. 14 (A) Prior to Subtraction of Biological Controls: FIG. 14 (B) With Subtraction of Biological Controls.

FIG. 15(A): Clustering and Heat Map of Kinome Data. Kinome data sets were subjected to hierarchical clustering analysis. “Average Linkage+(1−Pearson Correlation)” was used for clustering both the animal-treatments (in vertical direction) and the peptides (in horizontal direction). The animal codes are indicated below the corresponding treatment names under the heat map.

FIG. 15(B): Hierarchical Clustering of Kinome Data. Kinome data sets were subjected to hierarchical clustering and analysis “McQuitty+(1−Pearson Correlation)” and “complete Linkage+Euclidean” (right) were used. The leaves of the tree are annotated with the animal-code and treatment, separated by an underscore. For example, 89_IFN indicates animal 89 treated by IFNγ alone.

FIG. 16(A): Signaling within the JAK STAT Pathway in Bovine Monocytes and MAP-Infected Bovine Monocytes in Response to IFN Stimulation. Protein members of the JAK STAT pathway are color coded with respect to fold change differential phosphorylation. Differential phosphorylation of JAK STAT intermediates following IFNγ in bovine monocytes.

FIG. 16(B): Signaling within the JAK STAT Pathway in Bovine Monocytes and MAP-Infected Bovine Monocytes in Response to IFN Stimulation. Protein members of the JAK STAT pathway are color coded with respect to fold change differential phosphorylation. Relative degrees of phosphorylation of MAP-infected versus uninfected bovine monocytes following IFNγ stimulation. Diagrams produced using the cytoscape visualization option of InnateDb.

FIG. 17: Altered Expression of SOCS3 and IFNGR in Response to MAP Infection. RNA was extracted from bovine monocytes after either one or eighteen hour infections with MAP (MOI 5:1). Relative expression of select genes was determined through qRT-PCR as compared to time-matched uninfected monocytes.

FIG. 18: A schematic diagram illustrating an embodiment of a computerized control system for controlling and receiving one or more datasets.

FIG. 19: Mean-variance-dependence plots before and after normalization by log₂ (Log 2), percentile normalization (PNorm), quantile normalization (QNorm) and transformation by variance stabilization (VSN) with or without log₂ scaling for the combined datasets. Rank of the mean signal intensities was plotted against the standard deviation of the corresponding peptide intensities (i.e. black spots). The larger dots depict the running median estimator (window-width 10%). If there is no variance-mean dependence, then the line formed by the larger dots should be approximately horizontal. log₂ is an R built-in function, PNorm was implemented in R, QNorm and VSN were performed using the R functions NormalizationBetweenArrays in the limma package and vsn2 in the vsn package, respectively, and the plot was generated by the R function meanSdPlot from the vsn package [102].

FIG. 20: Histogram of relative frequencies versus intensity before and after normalization by log₂, PNorm, QNorm and VSN with or without log₂ scaling for the combined datasets. “Log 2” refers to a simple log₂ function applied after negative values, resulting from background correction, are eliminated. For the “Raw Data” plot, the y-axis is actual frequency. Refer to Example 3 for details regarding the other transformation procedures.

FIG. 21: Scatter plots of the signal intensities for monocytes under CpG against the corresponding intensities under media control. The raw data were preprocessed in the following ways: top left panel, none; top middle, logarithm to base 2 of the positive intensities (discarding the negative ones); top right, PNorm; bottom left, QNorm; bottom middle, VSN (log-scaled); bottom right, VSN only. The black and grey dots in each plot represent signal intensities after background subtraction and averaging across intra-slide replicates. If the resulting intensity for either treatment (CpG or MonoCpG) is negative, a grey dot is used. Otherwise the average intensity for both treatments is positive and the dot is coloured black. The coefficient of determination (r²) is indicated below the title of each plot.

FIG. 22: Pseudo-image of differential phosphorylation in the IFN, CpG, and LPS datasets based on the p-values from the one-sided paired t-test. The t-test was performed to identify differential phosphorylation status among the 300 peptides for bovine monocyte under treatments IFN, CpG and LPS relative to the corresponding controls. The significance of the (de)phosphorylation of each peptide is represented by a small colored circle. In each circle, the coloration of upper, left and right sectors indicates the p-value from the tests of IFN vs MonoIFN (combined biological replicates), CpG vs MonoCpG and LPS vs MonoLPS, respectively. The “redness” (right side of scale bar) and “greenness” (left side of scale bar) are proportional to the significance level of phosphorylation and dephosphorylation, respectively. On the bottom right corner of the plot, the four circles with the upper sectors colored in grey are the 4 animal-dependent peptides under IFN treatment determined by the F-test and based on 1% significance. The number below each circle is the original position number of the corresponding peptide in the microarray. The circles are arranged in the following way. In order from left to right and top to bottom, the consistently phosphorylated, dephosphorylated peptides, and inconsistently phosphorylated peptides across the three treatments are presented. Within the consistently phosphorylated peptides, the ones with the most significant p-values for phosphorylation/dephosphorylation on average over the three treatments are presented first followed by less significant ones. Similarly, for the inconsistent ones, the consistently phosphorylated and dephosphorylated peptides under CpG and LPS are presented first followed by the remaining ones in no particular order. The figure was generated using R functions plot, rgb, and polygon.

FIG. 23: Pseudo-image of differential phosphorylation in the CpG and IFN datasets based on the p-values from the one-sided paired t-test. The information is the same as used in FIG. 22 except that only CpG and IFN are shown (in the left and right semi-circles, respectively). Refer to the brief description of FIG. 22 for detailed information.

FIG. 24: Network representations of identified signaling pathways. The nodes in each network represent proteins containing peptides that are identified as being significantly differentially phosphorylated. Red coloration of a node indicates an increase in phosphorylation and green a decrease. The hue intensity represents the level of increase or decrease. The non-coloured spots are either not identified (i.e. on the array but not determined to be significantly phosphorylated) or not on the array. The networks were generated through the use of the Cerebral plugin [105] for the interaction viewer Cytoscape [106]. Networks on the left are derived from QNorm+limma while networks on the right are from the new analysis pipeline described herein. An enrichment of each pathway is readily apparent with the methodology described herein as compared to QNorm+limma.

FIG. 25: Hierarchical clustering. The preprocessed peptide intensities from the datasets were subjected to hierarchical clustering analysis following averaging and subtraction of biological controls. “Average Linkage+(1−Pearson Correlation)” was used for clustering both the treatments (in vertical direction) and the peptides (in horizontal direction). In the heatmap, red or darker line indicates (increased) phosphorylation and green or grey line dephosphorylation. Each column profile is labelled with a treatment. MonoCpG and MonoLPS are the media controls for CpG and LPS, respectively. For the IFN experiment, treatment names are followed by animal code. For example, “IFN89” indicates animal “89” treated by IFNγ. The peptide names labelling each row are indicated on the far right of the figure. The R function heatmap.2 from gplots package was used to generate the figure.

FIG. 26: Principal component analysis (PCA). Datasets were first transformed by PNorm, QNorm, VSN from limma using function normalizeBetweenArrays, and the standalone VSN employed in the pipeline described herein. Each normalized or transformed dataset was then subjected to PCA. The first three principal components from PCA based on the animal-treatments were used for the 3D plot. The percentages of the total variability that the three PC's account for are displayed on the top of each panel. The data points are labelled with treatments. MonoCpG and MonoLPS are the media controls for CpG and LPS, respectively. For the IFN experiment, treatment names are followed by animal code. For example, “IFN89” indicates animal “89” treated by IFNγ. The R functions prcomp and scatterplot3d were used for the PCA and the 3D plot, respectively.

Legend: “consistently P”=consistently phosphorylated; “DE P”=consistently dephosphorylated; “inconsistently P”=inconsistently phosphorylated

### DETAILED DESCRIPTION OF THE DISCLOSURE

A kinome is a network of signaling-transduction cellular processes regulated by phosphorylation events that can be quantified through microarray technologies. Characterizations of species-specific kinomes have important biological and therapeutic prospects in understanding the mechanisms of various infectious diseases, and may therefore facilitate the development of effective disease management strategies. However, computational tools for conducting high-throughput kinome analysis are not specifically tailored to the nature of the data, hindering the progress in the field.

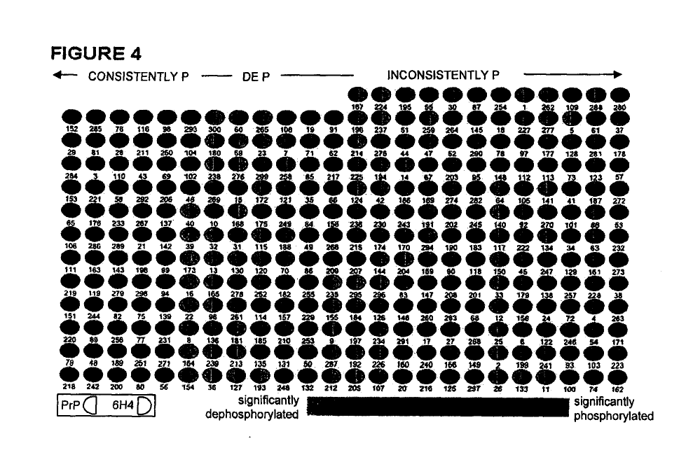

A framework of kinome analysis, which is described herein in an embodiment, has been developed and implemented primarily in the R environment (39). Briefly, the signal intensities measuring specific phosphorylation events of the peptides on a kinome array are subjected to variance stabilization transformation to bring all the data onto the same scale while alleviating variance-mean-dependence. Spot-spot and animal-animal variability are examined using χ² and F-tests to identify and eliminate inconsistently regulated peptides due to technical and biological factors of the experiments, respectively. One-sided paired t-test is used to identify differentially phosphorylated peptides relative to the control from the preprocessed kinome data. The information from the differential peptides can be used to probe gene ontology (GO) annotations and known signaling transduction pathways from online database to discover treatment-specific cellular events from various biological aspects. For comparative visualization of the global kinome profiles induced by selected stimuli, hierarchical clustering and principal component analysis are applied to the data after averaging the replicate intensities. The results from the differential analyses and clustering are compared to draw further insights from the data. The results can be presented for example in pseudo-images (for example see FIGS. 4, 9, 22 and 23), generated based on the p-values from the one-sided t-tests for phosphorylation or dephosphorylation of each peptide. Each peptide is represented for example by one small colored circle. The depths of the coloration in the colors, for example red and green, are inversely related to the corresponding p-values.

The methods were applied to two infection studies, namely prion and Mycobacterium avium subsp. paratuberculosis (MAP) in human neuron and bovine monocytes, respectively (Examples 1 and 2) as well as to studies stimulating immune cells with ligands of well-defined signaling pathways: specifically bovine monocytes treated with interferon gamma, microbial DNA, and lipopolysaccharide (Example 3).

For the prion study, 31 peptides were identified as significantly phosphorylated or dephosphorylated under the treatment of PrP, a peptide fragment from the PrPC prion protein, relative to the scrambled peptide control at 5% level of significance. Remarkably, three most phosphorylated peptides with highly significant p-values starting from 6.4×10⁻⁵ all came from protein inducible nitric oxide synthase (iNOS), which was found from the Kyoto Encyclopedia of Genes and Genomes (KEGG) database to engage in calcium signaling pathway. Earlier studies have shown that the Ca²⁺ ion channel is one of the primary targets for the causative prion agent to attack (64). Other differential peptides from the treatments of PrP and 6H4, a monoclonal antibody for PrPC, were found to be involved in MAPK, neurotrophin, and Toll-like receptor signaling pathways, all of which are highly related to neurodegenerative diseases. For the MAP study, the Jak-STAT pathway was only activated in bovine monocytes treated with gamma interferon (IFNγ) alone, but not in monocytes treated with MAP regardless of the presence of IFNγ.

It is further demonstrated that IFNγ is responsible for the activation of macrophages for clearance of intracellular pathogens primarily through operation of the Jak-STAT pathway. The results indicate that MAP had blocked this central pathway to facilitate its pathogenesis.

As described herein, the kinome data, was subjected to clustering analysis. Clustering analyses of the prion data demonstrated the importance of using specific controls to isolate important effects from the two PrPC-specific ligands, and supported the findings from the MAP data.

For the immune cell stimulation studies using interferon gamma, microbial DNA, and lipopolysaccharide, the datasets for each of the treatments were analyzed using the methodology described herein as well as three other commonly used approaches from the literature. The methods were evaluated based on: 1) statistical confidence of individual data points with respect to technical and biological variability, and 2) the statistical confidence levels (p-values) by which the known signaling pathway could be identified by independent pathway analysis at InnateDB. The results demonstrate that the method described herein was able to identify the known treatment-specific pathways at much higher confidence than any of the existing methods. Specifically, most of the existing data analysis strategies were unable to correctly identify signaling pathways, while the presently described approach identified appropriate pathways for all three ligands with a very high degree of confidence (all p-values less than 0.01).

Creation of a data processing system that considers unique characteristics of kinome data enables researchers to extract more biologically relevant information from kinome microarray experiments.

Accordingly, an aspect provides a method of analyzing phosphorylation data of a plurality of peptides, the method comprising:
a. obtaining one or more datasets, each dataset comprising a phosphorylation signal intensity for each peptide of the plurality of peptides;
b. transforming the phosphorylation signal intensity of each peptide using a variance stabilizing transformation to provide a variance stabilized signal intensity for each peptide of the plurality of peptides;
c. identifying one or more peptides of the plurality of peptides that are consistently phosphorylated or consistently unphosphorylated.

In an embodiment, the phosphorylation data is kinome data.

The term “signal intensity” as used herein refers to a value such as a numerical value corresponding to the strength of a specific signal being measured. For example, “phosphorylation signal intensity”, refers to a value corresponding to the strength of the phosphorylation signal being measured. When referring to a phosphorylation signal intensity of a peptide on an array, the signal intensity is a value corresponding, for example, to the signal intensity of the “spot” where the peptide is spotted on the array.

Each peptide in the dataset can be represented by one or more replicates. In an embodiment, each peptide of the plurality is present in at least 1 replicate, at least 2 replicates, at least 3 replicates, at least 4 replicates, at least 5 replicates, at least 6 replicates, at least 7 replicates, at least 8 replicates, at least 9 replicates, at least 10 replicates, at least 12 replicates, or at least 15 replicates.

In an embodiment, the step of identifying the one or more peptides comprises calculating a phosphorylation consistency value for each peptide of the plurality of peptides.

In an embodiment, the phosphorylation consistency value is calculated using the variance stabilized signal intensity.

In another embodiment, the method includes a method of analyzing phosphorylation data of a plurality of peptides, each peptide of the plurality present in at least two replicates, the method comprising:
a. obtaining one or more datasets, each dataset comprising a phosphorylation signal intensity for each replicate of the plurality of peptides;
b. transforming the phosphorylation signal intensity of each replicate using a variance stabilizing transformation to provide a variance stabilized signal intensity for each replicate of the plurality of peptides;
c. identifying one or more peptides of the plurality of peptides that are consistently phosphorylated or consistently unphosphorylated by calculating a phosphorylation consistency value for each peptide of the plurality of peptides, the phosphorylation consistency value optionally comprising calculating a replicate variability for each peptide using the variance stabilized signal intensity of each replicate of the at least two replicates for each peptide.

In an embodiment, the phosphorylation consistency value is calculated using a chi-square (χ²) statistic. In another embodiment, the method further comprises determining a phosphorylation characteristic of at least one of the one or more peptides that are consistently phosphorylated or consistently unphosphorylated.

A peptide is identified as consistently phosphorylated or consistently unphosphorylated according to the phosphorylation consistency value. Under the same treatment conditions, peptides with a phosphorylation consistency value such as a p-value which is for example, less than a threshold, are identified as inconsistently phosphorylated and peptides with a phosphorylation consistency value which is greater than a threshold are identified as consistently phosphorylated or consistently unphosphorylated. A person skilled in the art would recognize depending on the phosphorylation consistency value calculated, in some instances the opposite applies—peptides with a phosphorylation consistency value greater than a threshold are identified as inconsistently phosphorylated and peptides with a phosphorylation consistency value which is less than a threshold are identified as consistently phosphorylated or consistently unphosphorylated.

A phosphorylation characteristic is determined for at least one of the one or more peptides consistently phosphorylated or consistently unphosphorylated.

As used herein the term “phosphorylation characteristic” means a value, feature or quality that is distinctive of a peptide that relates to its phosphorylation. For example, the phosphorylation characteristic can include but is not limited to the phosphorylation status of the peptide, the phosphorylation consistency value, the location of the peptide on the peptide array, the sequence of the peptide, the phosphorylation signal intensity or the variance stabilized signal intensity or any other property of the consistently phosphorylated or consistently unphosphorylated peptide related to phosphorylation of the peptide. Depending on the desired phosphorylation characteristic, the characteristic can be determined by identifying for example, the sequence, or calculating the variance stabilized signal intensity.

In an embodiment, the method further comprises outputting the phosphorylation characteristic of one or more of the plurality of peptides, optionally a phosphorylation status and/or the phosphorylation consistency value. In an embodiment, the method comprises outputting a phosphorylation characteristic of one of the one or more peptides that is/are consistently phosphorylated or consistently unphosphorylated.

The dataset is generated in an embodiment, using at least one peptide array probed with a sample, wherein each peptide of the plurality of peptides is present on each peptide array in at least one, at least 2 replicates (e.g. each peptide is spotted at least twice) or at least 3 replicates (e.g. each peptide is spotted thrice). Multiple arrays can also be utilized.

The term “a replicate” with respect to a peptide as used herein refers to a peptide that has the same sequence and length as another peptide (e.g. two peptides having the same sequence and length are replicates of each other) treated under the same conditions (e.g. contacted with the same sample). The replicates can for example, be spotted on a same peptide array, or spotted on separate arrays wherein each array is contacted with the same sample (e.g. an aliquot of the same sample, e.g. same treatment same subject).

As used herein “replicate variability” also referred to as “spot-spot variability” refers to variability among replicates (e.g. spots on a peptide array) corresponding to the same treatment (e.g. stressor or control treatment).

In an embodiment, each dataset corresponds to a sample (e.g. a treatment and/or subject). In an embodiment, the sample is an experimental sample treated with a stressor or a control sample. In an embodiment, the method comprises:
a) obtaining one or more datasets, each dataset comprising a phosphorylation signal intensity for each replicate of the plurality of peptides for a sample, wherein the dataset is generated using at least one peptide array probed with the sample, wherein each peptide of the plurality of peptides is present on each peptide array in at least 2 replicates and wherein the sample is optionally an experimental sample treated with a stressor or a control sample;
b) transforming the phosphorylation signal intensity of each replicate of the plurality of peptides using a variance stabilizing transformation to provide a variance stabilized signal intensity for each replicate of the plurality of peptides;
c) identifying one or more peptides of the plurality of peptides that is/are consistently phosphorylated or consistently unphosphorylated by calculating a phosphorylation consistency value for each peptide of the plurality of peptides for each sample, wherein the phosphorylation consistency value is a measure of the phosphorylation status variability among the replicates for each peptide and optionally comprises calculating a replicate variability for each peptide using the variance stabilized signal intensity of each replicate, optionally using a chi-square (χ²) statistic;
d) determining a phosphorylation characteristic of at least one of the one or more peptides that is/are consistently phosphorylated or consistently unphosphorylated; and
e) optionally outputting a phosphorylation characteristic of the one or more of the plurality of peptides, for example a phosphorylation characteristic of one of the one or more peptides that is/are consistently phosphorylated or consistently unphosphorylated.

Phosphorylation data is analysed for example, to determine a phosphorylation characteristic of at least one peptide of the dataset such as the phosphorylation status and/or the phosphorylation consistency value of one or more of the plurality of peptides. In an embodiment, the method comprises determining a phosphorylation status of one or more of the plurality of peptides.

As used herein “phosphorylation status” refers to whether a peptide, polypeptide and/or specific amino acid, such as a peptide on a peptide array, is phosphorylated or unphosphorylated. The phosphorylation status can be determined for example after contact with a sample (e.g. stressor treated or control). The status can for example be an absolute status or a relative status for example relative to a peptide contacted with another sample such as a control or a sample treated with a stressor for a different length of time, e.g. previous time point. When relative to another sample such as a control “unphosphorylated” can include peptides that are “dephosphorylated” (e.g. phosphorylated in a first sample and unphosphorylated in the in the comparator sample). Accordingly, phosphorylation status can further include an indication of whether a peptide is dephosphorylated for example, as a result of a treatment.

The phosphorylation dataset comprises signal intensities (e.g. spot signal intensities) of phosphoimage data measuring specific phosphorylation events for a plurality of peptides, the dataset optionally obtained using a peptide array incubated with a sample using, for example, a microarray scanner and/or a phoshoimager scanner. For example, the peptide array is incubated with a sample such as a treated sample, e.g. treated with a stressor, or a control sample. The peptide array is washed and phosphorylation signal intensity data is captured. The signal intensities are obtained and the captured images processed according to methods known in the art. For example as described in Jalal et al. 2009 (37) sections relating to “using peptide arrays for kinome analysis” incorporated herein by reference, a Typhoon scanner can be set for example at the highest sensitivity setting with a pixel size of 25 microns and used to obtain array images from a phosphoimager screen. The captured image of the phosphoimager screen can be processed using for example ImageQuant TL v2005 software and the images can be cropped to the visible outlines of the peptide arrays in order to obtain individual peptide array images. The coordinates of each spot and the measurements of spacing between spots and blocks, as well as the dimension of spots and blocks can be obtained using, for example Array Vision. The background intensity for each spot can be calculated optionally as the average of pixels from a selected number of regions, such as 4 regions in the immediate vicinity of each spot. The dataset obtained for use in the methods described herein can optionally comprise phosphorylation signal intensity wherein the background intensity has already been subtracted and/or comprise a foreground signal intensity wherein the background intensity is subtracted prior to transformation.

As used herein, the term “plurality of peptides” means at least at least 25 peptides, at least 50 peptides, at least 100 peptides, at least 200 peptides, at least 300 peptides, at least 400, at least 500 or at least 1000 or any number in between.

As used herein, “peptide array” means a plurality of peptides coupled to a support, such as a slide, wherein each peptide comprises a putative or known phosphorylation motif. For example, depending on the dataset to be obtained, the peptide array can comprise peptides with known phosphorylation motifs, optionally phosphorylation motifs for proteins that are found in a signaling pathway or related pathways. Such peptide arrays can be useful for deciphering peptides phosphorylated or signaling pathways activated by a stressor such as an infectious agent or a macromolecule. Alternatively, the peptide array can comprise random peptide sequences comprising putative phosphorylation sites wherein the plurality of peptides or a subset thereof comprise at least one of a serine, threonine or tyrosine residue. Such a peptide array can be used for example for identifying optimal phosphorylation motifs of a kinase.

In an embodiment, the peptide array comprises at least 25 peptides, at least 50 peptides, at least 100 peptides, at least 200 peptides, at least 300 peptides, at least 400, at least 500 or at least 1000 or any number in between. Each peptide is spotted in at least two replicates, or at least 3 replicates per array, optionally as replicate blocks. For example, the peptides could be either random sequences, not necessarily always containing a Ser/Thr or Tyr, or represent known or predicted phosphorylation sites (for example peptides comprising Ser/Thr or Tyr residues).

As used herein, “background intensity” with respect to a peptide array signal intensity means the intensity of any non-specific signal that is detectable, for example in regions of the peptide array or array that are adjacent to the spotted peptides.

As used herein, “foreground intensity” with respect to a peptide array signal intensity means a raw signal intensity that is measured for the area which constitutes a spot on the array or array image. A foreground intensity for example can be subtracted for a background intensity (e.g. foreground intensity−background intensity) to provide a phosphorylation signal intensity usable in the methods described herein. For example, the genepix program which can be used to “read” the array image can collect a foreground signal intensity and background level for each individual spot. The raw data file then contains mean intensity of the spot foreground intensity and mean intensity of the background. To obtain a phosphorylation signal intensity, one subtracts the background from the foreground spot signal. In an embodiment, the background is subtracted from the foreground intensity as a first step of the method.

In an embodiment, one or more of the phosphorylation datasets comprises foreground phosphorylation signal intensities and the phosphorylation signal intensity for each replicate is obtained by subtracting a background phosphorylation intensity from each foreground phosphorylation signal intensity to provide the dataset comprising phosphorylation signal intensities for transformation.

The dataset comprises signal intensities measuring specific phosphorylation events of the peptides on the peptide array. Each dataset is subjected to a “preprocessing step” where the signal intensity of each replicate is subjected to a variance stabilizing and normalization (VSN) transformation to bring all the data onto the same scale and to alleviate variance mean dependence. The VSN transformation model can be trained for example using relevant datasets (e.g. similar cell or subject datasets). In an embodiment, R package vsn can be used for the VSN transformation.

The R package or R environment is a software environment for statistical computing and graphics that is publicly available (39).

Following the preprocessing step, the replicate variability such as spot-spot variability is examined, optionally using a chi square test (χ²) to provide a phosphorylation consistency measure for each peptide. Where the number of replicates for a treatment is less than 6, χ² would not be reliable and would be omitted. Other tests for calculating replicate variability include but are not limited to F-test.

The phosphorylation consistency value comprises a measure of the phosphorylation status variability among the replicates for each peptide (e.g. variability in whether the replicates of a peptide are consistently unphosphorylated or phosphorylated) and optionally comprises calculating a replicate variability for each peptide for each sample, wherein the replicate variability is calculated using the variance stabilized signal intensity of each replicate of each peptide, optionally using a chi-square (χ²) statistic. For example, the null hypothesis H₀ claims that there is no difference among intensities from replicate spots, and the alternative hypothesis H_{A} states that there exists significant variation among the replicates. After calculating a phosphorylation consistency value, the consistency of the phosphorylation status among replicates is determined by determining if the phosphorylation consistency value is above a selected threshold. For example, using χ² a p-value is calculated for peptides for the same treatment conditions (e.g. for all replicates of peptides on same or different arrays incubated with a sample treated with the same stressor), and peptides with a p-value less than a selected threshold are considered inconsistently phosphorylated across the spots and are eliminated from any subsequent clustering analysis. Peptides with a p-value above the threshold are considered consistently phosphorylated or consistently unphosphorylated. A desired p-value is selected; for example 0.05, 0.04, 0.03, 0.02 or 0.01 may be selected depending for example on the nature of the experiment. Other optional p-values typically range from 0.05 to 0.01.

The method can be used to analyze and/or compare phosphorylation data of more than one sample. For example, the method can be used to compare an experimental sample to a control sample, and/or multiple experimental samples to each other and/or a control.

The term “sample” as used herein means any biological fluid, cell or tissue sample from a subject, or fraction thereof which can be assayed for kinase activity, including for example a cell lysate of a cell or cell population treated with a stressor wherein the cell population is obtained from a subject. The sample can also comprise a preparation comprising one or more kinases in a biological buffer. The sample can be an experimental sample treated with a stressor or a control that is optionally untreated or treated with a control treatment. It is disclosed herein that the choice of control can be important in identifying differentially phosphorylated peptides. Depending on the stressor, an appropriate control treatment can be a vehicle only treatment (e.g. stressor dissolution agent) or a control treatment that is similar in composition to the stressor treatment but lacking the specificity of the stressor. For example a control treatment for a macromolecule, such as a peptide or RNA that induces a sequence specific cell response, can comprise a scrambled macromolecule, e.g. sequence scrambled peptide or RNA molecule. Similarly an isotype control antibody can be used as a control treatment wherein the stressor is an antibody. Any population of cells can be treated. For example, the cell or population of cells can comprise subject cells from multiple subjects, each sample optionally corresponding to a different subject, wherein one or more subsets of cells from each subject are treated with a stressor, optionally in vivo (e.g. an animal challenge) or in vitro (e.g. ex vivo treated primary cells). The cells are optionally clonal cells (e.g. cell culture experiment) and comprise propagated cells under defined conditions. Wherein multiple stressors are being compared or when using cells from one or more subjects, a biological control dataset for the same subject and/or sample treatment is optionally obtained and optionally subtracted from an experimental dataset (e.g. a control dataset comprising phosphorylation signal intensities corresponding to an unstimulated level of kinase activity is subtracted from each treatment dataset). Clustering analysis is optionally applied the average of the transformed replicate signal intensities (e.g. for each peptide for each treatment and/or subject) which are optionally adjusted by subtracting the signal intensity of the biological control for each treatment and/or subject. Each sample can be characterized by treatment and/or subject (e.g. cytokine treated sample from subject 1).

The term “subject” as used herein means any living organism, including a plant, an invertebrate and a vertebrate, such as a mammal, including for example a human.

Where the samples are from more than one subject of a given species or strain of a species or different individuals, inter-subject variability can confound results. In embodiments where subject variability is a concern, for example in treatments involving outbred animals, the phosphorylation consistency value comprises determining inter-sample or subject variability (such as animal-animal variability), optionally using a F-test statistic. Other tests can also be applied to determine subject variability including but not limited to t-test (i.e. pairwise comparison).

For example, where a dataset for each of three subjects for each of 4 treatments are being compared, the null hypothesis H₀ claims that the mean phosphorylation intensities for the identical peptide from the three animals are the same, and alternative hypothesis H_{A} states that not all three means are equal. The peptides with a p-value greater than a selected consistency threshold are considered consistently phosphorylated or consistently unphosphorylated and peptides with a p-value less than a selected consistency threshold are considered inconsistently phosphorylated and are eliminated from subsequent analysis.

Accordingly in an embodiment, the phosphorylation consistency value is expressed as a p-value. In an embodiment, the selected consistency threshold is a p-value of 0.05, 0.04, 0.03, 0.02 or, 0.01. Other p-values can be chosen depending on the nature the experiment. A typical range of the p-value is from 0.05 to 0.001. The strict confidence level is used so that as much data as possible is retained.

In an embodiment, the phosphorylation consistency value includes calculating the replicate variability and/or the subject variability, using a x² test to assess the replicate variability and a F-test to assess the subject variability.

In an embodiment, multiple experimental samples are compared. In an embodiment, a biological control signal intensity is subtracted from the experimental signal intensity. In an embodiment, the one or more datasets includes a control dataset and an experimental dataset, a control variance stabilized signal intensity for each replicate of the plurality of peptides is calculated for the control dataset according to a method described herein and subtracted from the variance stabilized signal intensity of each corresponding replicate of the plurality of peptides the experimental dataset prior to determining the subject-subject variability.

In an embodiment, the method comprises identifying peptides that are consistently phosphorylated or consistently unphosphorylated. Accordingly in an embodiment, the method comprises filtering the plurality of peptides according to the phosphorylation status and/or the phosphorylation consistency value and identifying one or more consistently phosphorylated or consistently unphosphorylated peptides. A peptide is identified as consistently phosphorylated or consistently unphosphorylated based on the phosphorylation consistency value, for example, if the phosphorylation consistency value for the peptide is above a selected consistency threshold.

In an embodiment, the disclosure includes a method of identifying one or more peptides of a plurality of peptides that are phosphorylated or unphosphorylated, each peptide of the plurality present in at least two replicates, the method comprising:
a. obtaining one or more datasets, each dataset comprising a phosphorylation signal intensity for each replicate of a plurality of peptides for a sample, the dataset is generated using at least one peptide array probed with the sample;
b. transforming the signal intensity of each replicate of the plurality of peptides using a variance stabilizing transformation to provide a variance stabilized signal intensity for each replicate of the plurality of peptides;
c. determining a phosphorylation consistency value for each peptide of the plurality of peptides wherein the phosphorylation consistency value is a measure of the phosphorylation status variability among replicates and optionally comprises assessing replicate variability of variance stabilized signal intensities using a χ² statistic and/or determining inter-sample variability (such as animal-animal variability for a particular treatment) optionally using an F-test statistic; and
d. identifying one or more peptides identified as consistently phosphorylated or consistently unphosphorylated,
   wherein a peptide is identified as consistently phosphorylated or consistently unphosphorylated if the phosphorylation consistency value for the peptide is above a selected consistency threshold.

In an embodiment, the method additionally comprises outputting at least one of the one or more peptides consistently phosphorylated or consistently unphosphorylated. In embodiment, the method comprises outputting a set of peptides consistently phosphorylated or consistently unphosphorylated.

In certain embodiments, the method entails identifying peptides that are differentially phosphorylated or unphosphorylated (e.g. dephosphorylated) compared to another sample (e.g. a control sample). Accordingly another aspect includes a method of identifying one or more peptides differentially phosphorylated in an experimental sample compared to a control sample, the method comprising:
a. for a plurality of peptides, each peptide of the plurality present in at least two replicates,
   i. obtaining an experimental dataset, the experimental dataset comprising an experimental phosphorylation signal intensity for each replicate of the plurality of peptides, and
   ii. obtaining a control dataset, the control dataset comprising a control phosphorylation signal intensity for each replicate of a plurality of peptides;
b. obtaining a variance stabilized signal intensity for each replicate of one or more peptides of:
   i. the experimental dataset identified as consistently phosphorylated or consistently unphosphorylated according to a method described herein, thereby providing a variance stabilized experimental signal intensity for each replicate;
   ii. the control dataset identified as consistently phosphorylated or consistently unphosphorylated according to a method described herein, thereby providing a variance stabilized control signal intensity for each replicate;
c. for each peptide that is identified as consistently phosphorylated or consistently unphosphorylated in the experimental dataset and consistently phosphorylated or consistently unphosphorylated in the control dataset, calculating a treatment variability value between the variance stabilized experimental signal intensity and the variance stabilized control signal intensity, optionally using a one-sided t-test; and
d. identifying one or more peptides that is/are differentially phosphorylated in the experimental sample compared to the control sample.

In an embodiment, the experimental dataset is generated using at least one experimental peptide array probed with the experimental sample and the control phosphorylation signal intensities are generated using at least one control peptide array probed with the control sample. In an embodiment, the experimental peptide array and the control peptide array have a common set of peptides. In another embodiment, each peptide of the plurality of peptides is spotted on each peptide array in at least 2 replicates.

In embodiments where the variability value is expressed as a p-value such as when using a one sided t-test, a peptide is differentially phosphorylated, if the peptide has a p-value less than a selected treatment variability threshold. In an embodiment, the selected treatment variability threshold is 0.2, 0.1, 0.05, or 0.01. Other p-values can be chosen depending on the nature the experiment. A typical range of the p-value is from 0.2 to 0.01.

In an embodiment, the method of identifying one or more peptides that are differentially phosphorylated in an experimental sample treated with a stressor compared to a control sample, comprises:
a. for a plurality of peptides, each peptide of the plurality present in at least two replicates,
   i. obtaining an experimental dataset comprising experimental phosphorylation signal intensity for each replicate of a plurality of peptides;
   ii. obtaining a control dataset comprising a control phosphorylation signal intensity for each replicate of a plurality of peptides;
b. transforming the signal intensity of each replicate of the plurality of peptides using a variance stabilizing transformation to provide a variance stabilized experimental signal intensity for each replicate of the plurality of peptides of the experimental dataset and a variance stabilized control signal intensity for each replicate of the plurality of peptides of the control dataset;
c. filtering the plurality of peptides to identify one or more peptides that are consistently phosphorylated or consistently unphosphorylated in the experimental dataset, optionally by examining replicate variability of variance stabilized signal intensities using a χ² test and/or subject variability (such as animal-animal variability) optionally using a F-test statistic;
d. identifying an overlapping set of peptides consistently phosphorylated or consistently unphosphorylated in the experimental dataset and the control dataset;
e. for the set of peptides consistently phosphorylated or consistently unphosphorylated in the experimental dataset and the control dataset, calculating a treatment variability value of the variability between the variance stabilized experimental signal intensity and the variance stabilized control signal intensity for each peptide, optionally using a one-sided t-test; and
f. identifying one or more peptides that is/are differentially phosphorylated in the experimental sample compared to the control sample.

In an embodiment, the method comprises comparing multiple treatments and/or subjects. Wherein multiple treatments are employed, they can be all compared to a single control (e.g. as described for MAP in the Examples below), or each treatment can be compared to specific control (e.g. as described for prions in the Examples). In an embodiment, where multiple treatments are to be compared, each experimental signal intensity of each peptide in the experimental datasets is subtracted for the signal intensity of a biological control signal intensity.

Identifying peptides that are consistently phosphorylated or consistently unphosphorylated and/or differentially phosphorylated can be used to identify proteins that are phosphorylated in response to a treatment. For example, the peptide on the peptide array may correspond to a specific protein and or group of related proteins. Identifying which peptides are phosphorylated indicates which proteins can be phosphorylated by a particular treatment or condition.

Peptides identified as differentially phosphorylated in an experimental dataset compared to a control or between experimental datasets, can be further subjected to further analysis including for example, to gene ontology enrichment analysis and/or signal transduction analysis. Accordingly, in an embodiment, the method further comprises generating a list of GO terms for consistently phosphorylated/unphosphorylated or differentially phosphorylated peptides, for example according to treatment. The GO terms can be further filtered to identify GO terms that repeated frequently.

As used herein “GO annotation” or “Gene Ontology annotation” refers to GO terms which is a controlled vocabulary of terms contributed by members of the GO consortium that have been assigned to gene products for classification of those products and describing gene product characteristics and gene product annotation data.

As another example, the identified peptides can be analysed to identify signaling pathways activated by a treatment. Accordingly, an aspect includes a method for identifying one or more cellular signaling pathways modulated in an experimental sample treated with a stressor compared to a control sample comprising:
a. identifying one or more peptides that are differentially phosphorylated in an experimental sample compared to a control sample according to a method described herein;
b. querying a database comprising gene ontology annotations and/or biological information for a plurality of proteins for one or more of the peptides identified as differentially phosphorylated; and
c. identifying one or more cellular pathways comprising the one or more peptides identified as differentially phosphorylated.

In another aspect, preprocessed data is further subjected to cluster analysis. Accordingly, in an embodiment, the method further comprises clustering the transformed signal intensities and/or clustering the one or more consistently phosphorylated or consistently unphosphorylated or differentially phosphorylated peptides.

Another embodiment includes a method for comparing kinome data between a control sample and an experimental sample treated with a stressor, comprising:
a. obtaining an experimental dataset comprising an experimental phosphorylation signal intensity for a plurality of peptides, each peptide present in at least two replicates;
b. obtaining a control dataset comprising control phosphorylation signal intensities for a plurality of peptides each peptide present in at least two replicates;
c. transforming the phosphorylation signal intensity of each replicate of the plurality of peptides of
   i. the experimental dataset using a variance stabilizing transformation to provide an experimental variance stabilized signal intensity for each replicate; and
   ii. the control dataset using a variance stabilizing transformation to provide a control stabilized signal intensity for each replicate;
d. averaging the replicate experimental variance stabilized signal intensities for each peptide to obtain an average experimental intensity and averaging the replicate control variance stabilized signal intensities for each peptide to obtain an average control intensity; and
e. clustering the average replicate intensities optionally by hierarchical clustering or principal component analysis.

Clustering can optionally be employed to compare clusters of treatments, clusters of peptides or signaling pathways.

In embodiments wherein multiple treatments (e.g. stressors) are compared, the method can further comprise subtracting intensities of one or more biological controls from the experimental intensity and performing the cluster analysis on the subtracted treatment intensity.

In an embodiment, the peptides identified as differentially phosphorylated are clustered according to a subgroup of a treatment cluster based on GO annotations.

The stressor can be any agent that causes a biological response. For example, the stressor can comprise a biological agent, a physical agent, or a chemical agent. In an embodiment, the biological agent comprises an infectious agent or a macromolecule. In an embodiment, the infectious agent comprises a microorganism, such as a bacterial entity or fragment thereof, a viral entity or fragment thereof, or a fungal entity or fragment thereof, wherein the fragment is antigenic.

As demonstrated herein, the infectious agent can be polypeptide such as a prion polypeptide.

The term “peptide”, “polypeptide” and/or “protein” as used herein refers to a molecule comprising a chain of amino acid residues. A peptide in the context of a peptide array typically comprises a peptide having from about 7 to about 21 amino acid residues or any number in between. A polypeptide and/or protein can comprise any length of amino acid residues.

In an embodiment, the phosphorylation data is obtained by contacting one or more experimental cell populations each with a stressor, contacting a control cell population with a control treatment, lysing the cells to obtain an experimental sample and a control sample respectively, contacting the experimental sample with the experimental peptide array and contacting the control sample with the control peptide array, under conditions suitable for kinase phosphorylation. Conditions that are suitable for kinase phosphorylation are well known in the art and include for example incubation at a suitable temperature such as 37° C. for mammalian kinases, and providing an ATP source. Suitable conditions are for example described by Jalal et al. 2009 (37).

In an embodiment, the phosphorylated peptides are visualized by incubating the peptide array with a phosphospecific fluorescent stain, such as ProQ Diamond Phosphoprotein Stain (Invitrogen), and destaining.

In an embodiment, the conditions comprise providing a labeled phosphate ATP source that is a suitable substrate for kinase transfer; and acquiring phosphorylation signal intensities using for example a phosphoimager. In an embodiment, the labeled phosphate source comprises ATP wherein the terminal phosphate is labeled, optionally with a radioactive or fluorescent label. In an embodiment, the phosphorylation signal intensity comprises a radioactive signal.

The methods are useful for example for identifying novel biomarkers that are phosphorylated consistently or unphosphorylated consistently in a disease, condition or disorder or that are phosphorylated consistently or unphosphorylated consistently by a treatment.

As mentioned above, R package statistical programs can be used to calculate one or more of the values and/or transformations. In an embodiment, the signal intensity of each replicate is VSN transformed using the R package vsn.

In an embodiment, the phosphorylation consistency value comprises determining χ² statistic (TS₁) as described for example in Example 1 and/or 3. In an embodiment, the p-value is calculated using R package pchisq.

In certain embodiments, the method comprises comparing more than one sample or experimental sample. Wherein intersample variability may be confounding, inter-sample variability is determined by assessing whether there are significant differences among samples (e.g. corresponding to a subject) treated with a same stressor using a F-test statistic

TS₂=MS_{B}/MS_{W}

wherein MS_{B} is a mean squared between subjects and wherein MS_{W} is a Mean Squared Within Subjects and each are calculated as described in Example 1 and/or 3.

In an embodiment, the one or more peptides that is/are differentially phosphorylated in the experimental sample compared to the control sample, or compared to a second experimental sample is identified using a one-sided paired t-test (alternatively referred to as a “paired t-test” herein), wherein the t-test statistic is calculated as described in Example 1 and/or 3.

### Wherein

p-value=P[TS₃>t(n−1)](phosphorylation)

p-value=P[TS₃<−t(n−1)](dephosphorylation)
wherein peptides with a p-value less than a selected threshold are differentially phosphorylated.

In an embodiment, the one-sided paired t-test is calculated using R package t.test with paired=True.

In an embodiment, the method further comprises querying a database comprising protein annotations comprising descriptive terms associated with a catalogue of proteins, optionally gene ontology (GO) terms, optionally wherein the query comprises inputting a protein identifier for a protein comprising a peptide selected from the peptides identified as differentially phosphorylated, optionally an accession number such as a UniProt accession number or an Entrez Gene ID, and optionally generating a list of descriptive terms, optionally GO terms, for one or more of the plurality of peptides identified as differentially phosphorylated. In order to identify patterns and/or signaling pathways activated by a treatment, the frequency of each term for the one or more peptides phosphorylated or differentially phosphorylated is ranked according to frequency. The ranked list can be further filtered to identify common terms, for example descriptive terms that are identified for more than one of the peptides, such as descriptive terms that are identified with a selected frequency, for example at least 2 times, at least 3 times, at least 4 times, at least 5 times or more depending for example on the number of peptides being queried.

In another embodiment, the method comprises querying a database comprising signaling pathway annotations for a signaling pathway associated with a protein comprising a peptide selected from the peptides identified as differentially phosphorylated, optionally querying a KEGG or InnateDB database, optionally wherein the query comprises inputting a protein identifier for the protein comprising the peptide, optionally an accession number such as a UniProt accession number or an Entrez Gene ID, and optionally generating a list of one or more signaling pathways for one or more of the plurality of peptides.

As mentioned, the identified peptides can be clustered. In an embodiment, the one or more peptides consistently phosphorylated are clustered by a hierarchical clustering method and/or a principal component analysis (PCA) to cluster the one or more peptides according to treatment and/or subject-treatment combinations. In an embodiment, the hierarchical clustering method comprises considering each subject/treatment combination as a cluster with a single element; identifying two most similar clusters and merging the two most similar clusters; and iteratively calculating a distance between remaining clusters and the merged cluster to cluster the one or more peptides consistently phosphorylated. In another embodiment, the hierarchical clustering method comprises a clustering method and a distance measurement optionally “Average Linkage+(1-Pearson Correlation)”, “Complete Linkage+Euclidean Distance”, and “McQuitty+(1−Person Correlation)”. In yet a further embodiment, the hierarchical clustering is performed using R package heatmap.2 from the glpots package. In another embodiment, the PCA is performed using R program prcomp from the stats package.

As described herein, the preprocessing step uses a variance stabilizing module to bring negative and positive signals (after background corrections) onto the same positive scale while maintaining their correlations and minimizing the mean-variance dependence issue. Given the nature of the kinome data, this is not sufficiently dealt with by the typical normalization techniques in popular software such as GeneSpring or the limma package from Bioconductor. Because of the stabilization of variance in the data, the present method allows use of more standard statistical tests such as t-tests and F-tests. Consequently, spot-spot and subject-subject variation are rigorously considered to take into account both the technical and biological variation, which are more of a concern in kinome analysis than in conventional gene expression analysis. The paired t-test allows more peptides to be taken into consideration in the pathway analysis. Other multiple hypothesis testing such as Bonferroni and moderated t-test from limma have proven over-stringent in kinome analysis. Relevant databases are probed for known signaling pathways using the identified differentially phosphorylated peptides. In addition, Gene Ontology enrichment and clustering analysis are used to draw further insights from the data.

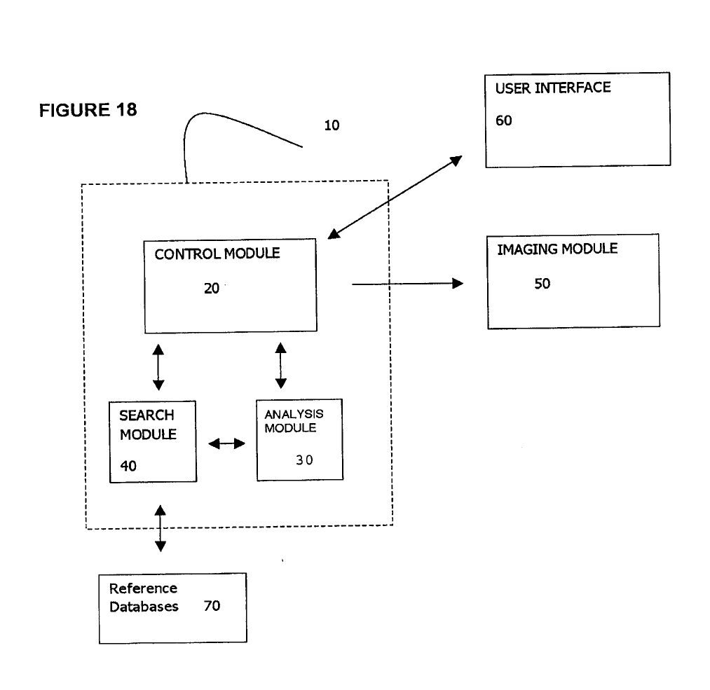

In an embodiment, the method comprises outputting, for example to a user interface (for example, 60 in FIG. 18), at least one of the differentially phosphorylated peptides and/or a phosphorylation characteristic of the one or more of the plurality of peptides, optionally the phosphorylation status and/or phosphorylation consistency value of one or more of the plurality of peptides. In an embodiment, the output comprises a graphic representation of the phosphorylation status and/or the phosphorylation consistency value, optionally using colour coding and/or a colour scale.

In an embodiment, the user interface 60 can be, for example, but not limited to a graphical user interface.

In an embodiment, the method further comprises outputting a phosphorylation characteristic of the one or more peptides that are consistently phosphorylated or consistently unphosphorylated, optionally as a graphic representation of phosphorylation status and/or phosphorylation status variability, optionally using colour coding and/or a colour scale. In an embodiment, the p-value for each differentially phosphorylated peptide or subset thereof is displayed in a Table, or as a graphic optionally as a pseudoimage. In an embodiment, the pseudoimage is generated based on the p-value calculated for the differentially phosphorylated peptide. In an embodiment, the p-value is represented using a colour scale, wherein depth of coloration is inversely related to the corresponding p-value. In an embodiment, more than one treated sample is being compared, the pseudoimage is a composite wherein each part represents a different treated sample, optionally a p-value for each treated sample.

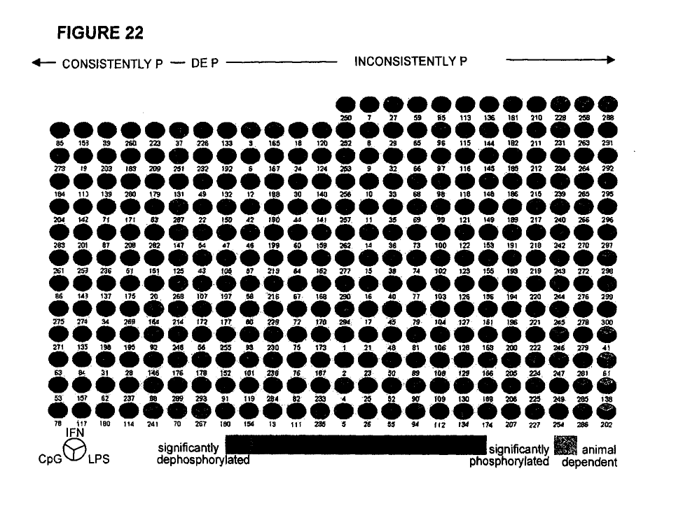

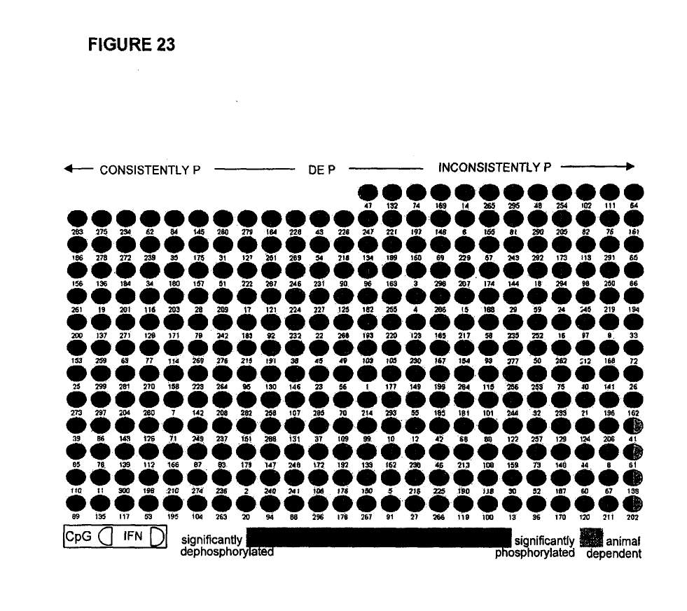

An example of such a display or pseudoimage is shown in FIG. 22. A pseudoimage with labels indicating the actual microarray layout depicts the significance level of the phosphorylation status of each peptide elicited from bovine monocytes treated by IFN, CpG and LPS relative to the corresponding controls (the upper, bottom left, and bottom right sectors in each circle in FIG. 22, respectively). The animal-dependent peptides under IFN treatment identified from the F-test in Subject-Subject Variability Analysis are indicated by a grey color in the corresponding upper sectors in the circles at the bottom right corner of the plot. Significant phosphorylation and dephosphorylation are presented in colors red and green, respectively. The color depths are inversely proportional to the corresponding p-values from the one-sided paired t-test. Facilitated by the plot, it is evident that 96 peptides have common differential phosphorylation status across the three treatments (circles from 85 on the top to 160 at the bottom). Fifty-seven peptides appear to have the similar phosphorylation under treatment CpG and LPS but not IFN (circles from 3 on the top to 294). These commonly active peptides may be involved in shared signaling pathways specifically induced by the two similar ligands, CpG and LPS. The similarities and differences of phosphorylation results for CpG and LPS are more evident in FIG. 23.

Accordingly, in an embodiment the method comprises selecting the display output options, including for example the number of treatments to be displayed for comparison.

In an embodiment, the graphic is generated using R program plot, rgb and/or polygon. In an embodiment, the method comprises outputting a list of descriptive terms associated with a subset of the one or more peptides, optionally a list of GO terms, for example wherein the list of GO terms, optionally common GO terms, is outputted to a table.

The methods described herein can be used to analyse a number of biological questions. For example, the method can be applied, as described herein, to identify peptides that are phosphorylated in response to a particular treatment. The methods can also be used to identify if a particular signaling transduction pathway has been activated or deactivated by a stimulus, an optimal kinase recognition motif, to determine an unknown kinase recognition motif depending on the peptide array employed, and/or to examine global similarity/distinction in kinomic patterns of samples under distinctive treatments.

Another aspect includes, referring to FIG. 18 by way of example, a computerized control system 10 for carrying out the methods of the disclosure. In an embodiment, the computerized control system 10 comprises at least one processor and memory configured to provide:
a) a control module 20 to receive one or more datasets, each dataset, comprising, a plurality of phosphorylation signal intensities, each signal intensity corresponding to a replicate of a peptide for a plurality of peptides, each peptide present in at least two replicates, a phosphorylation signal intensity for each replicate;
c) an analysis module 30 to:
   i) transform the phosphorylation signal intensity to provide a variance stabilized signal intensity for each replicate of the plurality of peptides using a variance stabilizing transformation;
   ii) determine a phosphorylation consistency value for each peptide of the plurality of peptides; and
   iii) identify for consistently phosphorylated or consistently unphosphorylated peptides, one more peptides differentially phosphorylated compared to a control;
      wherein a peptide is consistently phosphorylated or consistently unphosphorylated when the phosphorylation consistency value is greater than a selected threshold.

In an embodiment, the phosphorylation consistency value is determined by calculating a replicate variability for each peptide for each treatment and/or calculating a subject variability for each peptide.

A schematic representation of an embodiment of a computerized control system is provided in FIG. 18.

In an embodiment, the sample corresponds to a treatment and/or subject. In an embodiment, each dataset is generated using at least one peptide array probed with a sample. In an embodiment, the computerized control system controls and/or receives data from an imaging module 50. In an embodiment, the image data module is a phosphoimager. In an embodiment, the image data module is a microarray scanner, which optionally detects dye fluorescence. In an embodiment, the image data module is configured to collect the images and spot intensity signal. In an embodiment, the computerized control system further comprises an image data processor for processing the phosphoimage data.

In an embodiment, the analysis module 30 further determines a phosphorylation characteristic of at least one of the one or more peptides that is/are consistently phosphorylated or consistently unphosphorylated.

In a further embodiment, the analysis module 30 further determines if a peptide is differentially phosphorylated compared to a control dataset or other experimental dataset. In an embodiment, the computerized control system further comprises a display module.

In an embodiment, the computerized control system further comprises a search module 40 for searching or querying a database 70 such as a protein reference database, a gene reference database and/or an online database to identify and retrieve for example descriptive terms and/or signal transduction pathway information associated with at least on or more of the peptides identified as differentially phosphorylated.

In an embodiment, the computerized control system further comprises a user interface 60 operable to receive one or more selection criteria, wherein the processor is further operable to configure the analysis module 30 to include the criteria received in the user interface 60. For example, the selection criteria can comprise a selected threshold such as a consistency value threshold or a treatment variability threshold. Selection criteria can also include display options, for example for selecting which phosphorylation characteristics to display (e.g. for comparing a subset of treatments as in FIG. 23). In an embodiment, the user interface 60 can be, for example, but not limited to, a graphical user interface.

A further aspect comprises a non-transitory computer-readable storage medium comprising an executable program stored thereon, wherein the program instructs a processor to perform the following steps for a plurality of peptides, each peptide represented by at least 2 replicates: transform a phosphorylation signal intensity data for each replicate of the plurality of peptides using a variance stabilizing transformation; determine a phosphorylation consistency value for each peptide of the plurality of peptides; and identify one more peptides as consistently phosphorylated or consistently unphosphorylated.

In an embodiment, the program further instructs the processor to determine a phosphorylation characteristic for at least one of the one or more peptides that is/are consistently phosphorylated or consistently unphosphorylated.

In an embodiment, the program further instructs the processor to filter the results based on the phosphorylation consistency value and optionally output a phosphorylation characteristic such as phosphorylation status and/or a phosphorylation consistency value for at least one of the peptides.

As used in this specification and the appended claims, the singular forms “a”, “an” and “the” include plural references unless the content clearly dictates otherwise. Thus for example, a composition containing “a compound” includes a mixture of two or more compounds. It should also be noted that the term “or” is generally employed in its sense including “and/or” unless the content clearly dictates otherwise.

The following non-limiting examples are illustrative of the present disclosure:

### EXAMPLES

### Example 1

Established is a framework for kinome analysis for tackling the challenges of kinome analysis. A set of statistical testings has been chosen to address the variability issues existing between technical replicates and between biological replicates. The aim is to identify true differential peptides specific to a treatment under investigation while eliminating misleading factors that interfere with the interpretations of the results. Based on the deliberately selected gene ontology (GO) annotations of the genes corresponding to the significantly phosphorylated or dephosphorylated peptides, certain generalizations can be made on the physiological responses of the cell lines induced by a particular stimulus. Furthermore, the GeneSymbols of the differentially regulated peptides can be used to probe for known signaling pathways from reliable resources such as Kyoto Encyclopedia of Genes and Genomes (KEGG) (www.genome.jp/kegg/tool/search_pathway.html) (60; 61; 62). The results may elucidate the pathways specifically induced by the treatment under study, thus providing insight into the mechanisms that particular cell lines employ in response to the stimulants. Finally, clustering analyses such as hierarchical clustering and principal component analysis (PCA) have been incorporated into the workflow for comparative visualization of kinome patterns from the cells under various treatments.

The framework has been implemented primarily in the language R (39) facilitated by some PERL and BASH scripts. To demonstrate the plausibility of the approach, the programs have been applied to two kinome datasets in the studies of prion and Mycobacterium avium subsp. paratuberculosis (MAP) infection diseases. The detailed information of the datasets are explained in the next section. Prions are unprecedented infectious pathogens that cause a group of invariably fatal neurodegenerative diseases in bovine, sheep, and humans by an entirely novel mechanism. Prions are transmissible particles that are devoid of nucleic acid and seem to be composed exclusively of a modified protein, PrPSc. The PrPSc acts as a template upon which the normal prion protein (PrPC) prevalent in neural cells is refolded into PrPSc, which then propagates through a process facilitated by other biomolecules to cause deleterious effects to the hosts (69). The physiological roles of PrPC, and the mechanisms by which PrPSc mediates disease pathology, remains unclear (64; 69). MAP is a causative agent of a severe gastroenteritis in ruminants known as Johne's disease.

Economic losses to the cattle industry due to MAP infections in the North America are as high as $1.5 billion annually (1). Very little success to date in developing vaccine conferring high efficacy to the outbred bovine populations underlines the lack of detailed understanding of the biology and virulence mechanisms of MAP.

### 2. Methods

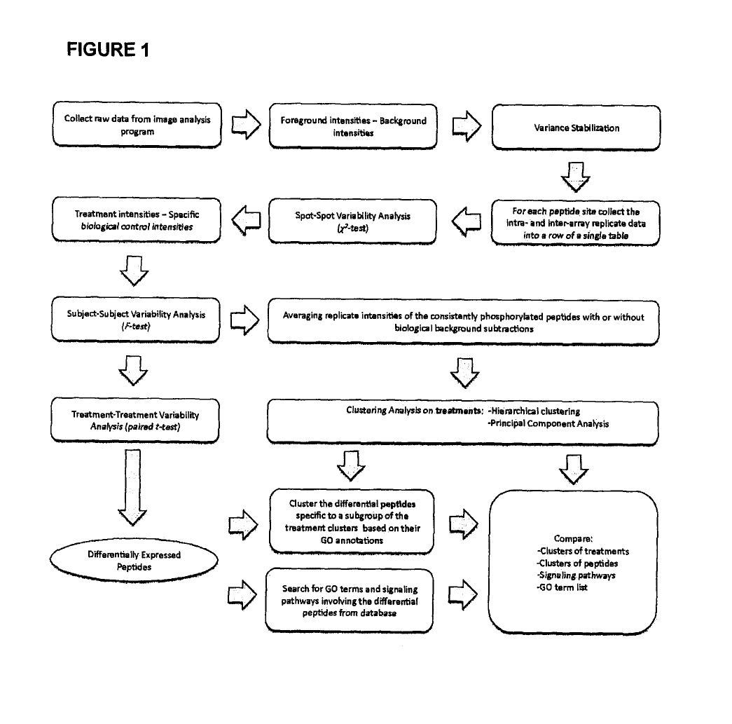

A general workflow of the following analytical steps is outlined in FIG. 1. All the calculations below can be done by R console unless noted otherwise (39). Specific R packages used are mentioned wherever applied. All the R packages used are publicly available from: www.R-project.org and www.bioconductor.org (121).

### 2.1 Data Preprocessing

In all datasets, the specific responses of each peptide are calculated by subtracting background intensity from foreground intensity.

The resulting data is transformed using a variance stabilization (VSN) model (38). The transformation brings all the data onto the same scale while alleviating variance-mean dependence. Only for the subsequent clustering analysis, is the average for each of the peptides in a single treatment taken over the transformed replicate intensities. If applicable, the intensities induced by the treatments are adjusted by subtracting the intensities of the biological control of the same subject. R package vsn can be used for the VSN transformation (59).

To compare the VSN transformation method, the prion raw data was also transformed by logarithm or using GeneSpring software (Silicon Genetics, Redwood City, Calif.). Briefly, the latter program first divides each raw intensity value by the median of the chip. Then each value is further divided by the median value of each peptide across samples (56). Finally, the negative transformed values are arbitrarily set to 0.01.

### 2.2 Spot-Spot Variability Analysis (Replicate Variability)

Chi-squared (χ²) test is used to examine the variability among the spots corresponding to the same treatment (53). Formally, the null hypothesis H₀ claims that there is no difference among intensities from the replicate spots, and alternative hypothesis H_{A} states that there exists significant variation among the replicates. The χ² test statistic (TS₁) is:

$${TS}_{1} = \frac{( n - 1 ) {s}^{2}}{{σ}^{2}}$$

where n is the number of replicates for each peptide in the treatment,

s²=1/nΣᵢ₌₁ⁿ(yᵢ− y̅)²

is the sample variance of the replicates for each peptide in a treatment,

\hat{σ}²=1/MΣⱼ₌₁^{M}sⱼ²

is the mean of all the variances for the replicates of the M peptides in the treatment (i.e., total number of distinct peptides included in an array), and

p-value=P[TS₁>χ²(n−1)]

Under the same treatment condition, the peptides with p-value less than a threshold are considered inconsistently phosphorylated or inconsistently unphosphorylated across the spots and will be eliminated from the subsequent clustering analyses. A strict confidence level (say, 0.01) can be used so that as much data as possible is retained. The p-value can be calculated using R program pchisq from the stats package.

### 2.3 Subject-Subject Variability Analysis

This step is done after biological background subtractions (if applicable) and only applied to datasets, where there is a concern of animal variation. For each of the peptides, an F-test is used to determine whether there are significant differences among the subjects under the same treatment condition (40).

Formally, let a be the number of subjects, n the number of intraarray replicates, N the total number of replicates for each peptide for each treatment, μᵢ the mean response of each peptide in the i^{th} subject for each treatment, and m the m^{th} replicate of a peptide in the i^{th} subject for each treatment. The null hypothesis H₀ claims that μ₁=μ₂= . . . =μₐ, or the mean phosphorylation intensities elicited by the identical peptide among the subjects are the same, and alternative hypothesis H_{A} states that not all subject means are equal. The F-statistic (TS₂) is calculated as:

$${TS}_{2} = \frac{{MS}_{B}}{{MS}_{W}}$$

$$where , \\ {MS}_{B} = \frac{{SS}_{B}}{{df}_{B}} = \frac{{\sum }_{i = 1}^{a} {( {\overline{y}}_{i} - \overline{y} )}^{2}}{a - 1}$$

$$( Mean Squared Between Subjects )$$

$${MS}_{W} = \frac{{SS}_{W}}{{df}_{W}} = \frac{{\sum }_{i = 1}^{a} {\sum }_{m = 1}^{n} {( {y}_{im} - {\overline{y}}_{i} )}^{2}}{N - a}$$

$$( Mean Squared Within Subjects )$$

where y̅ᵢ≡\hat{μ}ᵢ is the sample mean for i^{th} subject, y̅≡\hat{μ} the grand mean of all the subjects, and yᵢₘ the individual response of the m^{th} replicate in the i^{th} subject. Finally,

p-value=P[TS₂>F(a−1,N−a)]

Under the same treatment condition, the peptides with p-value less than a threshold are considered inconsistently expressed among the subjects and will be eliminated from the subsequent analyses. A strict confidence level (say, 0.01) can be used so that as much data as possible was retained.

### 2.4 Treatment-Treatment Variability Analysis

All peptides identified by the F-tests as having consistent patterns of response to various treatments across the subjects are subjected to one-sided paired t-tests to compare their signal intensities under a treatment condition with those under control conditions (40). Formally, the t-test statistic (TS₃) is calculated as:

$${TS}_{3} = \frac{\overline{D}}{{S}_{D} / \sqrt{n}}$$

where D̅ is the mean of the differences between responses for the same peptides induced by two different treatments, S_{D} the standard deviation of the differences, and n the number of replicate differences for that peptide between each treatment and control.

Finally,

p-value=P[TS₃>t(n−1)](phosphorylation)

p-value=P[TS₃<−t(n−1)](dephosphorylation)

The peptides with p-value less than a threshold (say, 0.05) are considered as differentially regulated and will be used for the subsequent analyses. No adjustment (as in the multiple testings) to the p-value is made to retain as much data as possible. The paired t-test is used here because it takes into account the interdependence between the same peptides under treatment and control conditions. Also note that the t-test is able to account for the variability (in terms of S_{D}) among the replicates so that replicates with significant p-values from the χ² tests will automatically have insignificant p-values from the t-test. However, this does not apply to datasets with multiple subjects, because significant variation for the same peptide among the subjects under the same treatment condition might be biologically meaningful, and it may confound the analysis, if treating these peptides as if they came from the same source.

The paired t-test can be done using R built-in function t:test from the stats package with paired=True. The results are presented in pseudoimages.

The latter can be generated based on the p-values from the one-sided t-tests for phosphorylation or dephosphorylation of each peptide. The depths of the coloration in red and green are inversely related to the corresponding p-values. For example, if the p-value for phosphorylation is 0.0001, then the redness in percentage will be 100%×(1−0.001)=99.9%. The same rationale is applied to dephosphorylated peptides. Thus, the combined colour depths of red and green will give an accurate account for the phosphorylation status of each peptide in the microarray. In addition, each dot in the plot is partitioned into parts, each of which represents a different treatment from the datasets. Moreover, the dots are rearranged in such a way that, going downwards by column and from left to the right of the array, the consistently expressed peptides across treatments are presented first followed by the inconsistent ones. Within the consistently expressed peptides, the ones with the most significant p-values for phosphorylation/dephosphorylation on average over the treatments being compared are presented first followed by less significant ones. Similarly, the inconsistent ones with the largest differences between the p-values from the treatments are presented first followed by the ones with smaller differences. The original numberings for each peptide (i.e., the label below each circle) from the initial array layout are unchanged for indexing detailed information of the peptide. This representation of the results from differential analysis may facilitate the visualization process to identify conspicuous intensities of the peptides across treatments from various perspectives. The plots can be generated using R functions plot (for plotting the dots in different coordinates), rgb (for coloration), and polygon (for drawing half and ⅓ of the circle to represent each treatment in each partition of the circle).

### 2.5 Gene Ontology Enrichment Analysis

A complete list of the GO terms for all the peptides is generated from the GOTermFinder on-line server (go.princeton.edu/cgi-bin/GOTermFinder) based on their UniProt accession numbers from the Protein Knowledgebase (www.uniprot.org) (51). The GOTermFinder determines the significant GO terms using Bonferroni hypergeometric test. Briefly, the probability for annotating a GO term to a list of genes is assumed to have a hypergeometric distribution. The p-value for a GO term is calculated using the equation for the hypergeometric distribution taking into account the number of annotated genes with that GO term in the query list and in the genome database. The calculated p-value is then adjusted using a simulation technique. Specifically, if the number of the genes in the input data is n, then n genes are randomly sampled from a total gene pool from a selected database of the server. This random sampled gene population is used to calculate the p-value for a GO term the same way described above. The procedure is repeated 1000 times. The Bonferroni adjusted p-value for a GO term is determined as the fraction of the 1000 tests that produce p-values better than the p-value calculated for that GO term using the input gene list (51). Based on the nature of the studies, the GO terms provided by GOTermFinder can be further reduced. Using this reference list, the GO terms for each significantly phosphorylated or dephosphorylated peptide identified by the paired t-tests above in every treatment are obtained. The number of times each GO term appears for all the selected peptides is recorded. The GO terms that appear more than 5 times under all the treatments are captured as the common GO terms, and their descriptions become the column names for the output table. The remaining GO terms' descriptions are organized into a single column named “Others”. From column 3 downstream, each cell entry corresponds to a single GO term and a peptide. If the peptide is found to belong to the GO term category, the cell is filled with “1”; “0” otherwise. The encoding was done for the peptides that were found to be significantly phosphorylated or dephosphorylated exclusively or non-exclusively in a single treatment. A sample in Table 1 illustrates the idea above.

2.6 Probing Signaling Transduction Pathways from Database

The identifiers such as GeneSymbols corresponding to the differential peptides detected in each treatment can be used to probe database such as KEGG (www.genome.ip/kegg/tool/search pathway.html) or InnateDB (www.innatedb.com) to discover known signaling pathways that are specifically induced by the treatment under investigation (60; 61; 46; 62).

### 2.7 Clustering Analysis

The preprocessed data is subjected to hierarchical clustering and principal component analysis (PCA) to cluster peptide response profiles across treatments or subject-treatment combinations. For hierarchical clustering, three popular independent combinations of clustering method and distance measurement are recommended, namely “Average Linkage+(1−Pearson Correlation)”, “Complete Linkage+Euclidean Distance”, and “McQuitty+(1−Pearson Correlation)” (44; 43; 41; 42). In general, each subject/treatment vector is considered as a singleton (i.e., a cluster with a single element) at the initial stage of the clustering. The two most similar clusters are merged and the distances between the newly merged clusters and the remaining clusters are updated, iteratively. The calculations of similarity/distance between the clusters and the update step are algorithmically specific. The “Average Linkage+(1−Pearson Correlation)” is the method used by Eisen et al. (45). It takes the average over the merged (i.e., the most correlated) kinome profiles and updates the distances between the merged clusters and other clusters by recalculating the correlations between them. Formally, the Pearson correlation between any two vectors of subject/treatment of M peptides, say X and Y, is computed as

$${r}_{XY} = \frac{{\sum }_{i = 1}^{M} ( {x}_{i} - \overline{x} ) ( {y}_{i} - \overline{y} )}{\sqrt{{\sum }_{i = 1}^{M} {( {x}_{i} - \overline{x} )}^{2} {\sum }_{j = 1}^{M} {( {y}_{j} - \overline{y} )}^{2}}}$$

In “Complete Linkage+Euclidean Distance”, the distance between any two clusters is considered as the Euclidean distance between the two farthest data points in the two clusters (41; 42). Formally, the Euclidean distance between two subject/treatment vectors of M peptides, say X and Y, is calculated as:

dist(X,Y)=\sqrt{(x₁−y₁)²+(x₂−y₂)²+ . . . +(x_{M}−y_{M})²}

Finally, the McQuitty method updates the distance between the two clusters in such a way that upon merging clusters C_{X} and C_{Y} into a new cluster C_{XY}, the distance between C_{XY} and each of the remaining clusters, say C_{R}, is calculated taking into account the sizes of C_{X} and C_{Y} (43). Mathematically, let the size of C_{X} be n_{X} and size of C_{Y} be n_{Y}, then:

$$dist ( {C}_{XY} , {C}_{R} ) = \frac{{n}_{X} \times dist ( {C}_{X} , {C}_{R} ) + {n}_{Y} \times dist ( {C}_{X} , {C}_{R} )}{{n}_{X} + {n}_{Y}}$$

PCA is a variable reduction procedure. Basically, the calculation is done by a singular value decomposition of the centered and scaled data matrix (67). As a result, PCA transforms a number of possibly correlated variables into a smaller number of uncorrelated or orthogonal variables (i.e., principal components).

The first principal component accounts for the most variability in the data, and each succeeding component accounts for as much of the remaining variability as possible. Usually, the first three components account for larger than 50% of the variability in the data, and can be used as a set of the most important coordinates in a 3D plot to reveal the internal structure of the data.

R functions heatmap.2 from package gplots and prcomp from stats are used for hierarchical clusterings and PCA, respectively.

The 3D plot for the PCA using the first three principal components that account for the largest variability of the data is produced by R function scatterplot3d from package scatterplot3d.

### 3 Applications

### 3.1 Datasets

### 3.1.1 Prion Datasets

The prion datasets contain signal intensities from ArrayVision associated with each of the 300 peptides for the human neuron treated with 5 different stimulants (37).

The stimulants were labelled with “PrP” (prion protein fragment of amino acids 106-126, GenBank accession number NP_{—}898902) from the human PrPC sequence), “Scram” (scrambled peptide control for PrP), “6H4” (prion related antibody, which induces antibody mediated dimerization that leads to the activation of PrPC), “Iso” (isotype antibody control for 6H4), and “Media” (no treatment).

For each treatment other than the Media, there are 3 intra-array replicates in 3 replicate arrays (2 replicate arrays for the Media).

Therefore, there are 9 replicates for each peptide in a treatment (6 replicates for the Media)

### 3.1.2 MAP Datasets

The MAP datasets contain the signal intensities from ArrayVision associated with each of 300 peptides (a selected set of peptides that is different from the set used in the above prion datasets) for the monocytes from 3 outbred cattle, labelled with “89”, “136”, and “149”, treated with 4 different stimulants (37). The stimulants were labelled with “IFN” (IFN treatment alone), “MAP” (MAP infection alone), “MAP+IFN” (MAP infection followed by IFN treatment), and “Mono” (no treatment). For each animal under each treatment, there are 3 intra-array replicates.

### 3.2 Results for Prion

### 3.2.1 Data Preprocessing

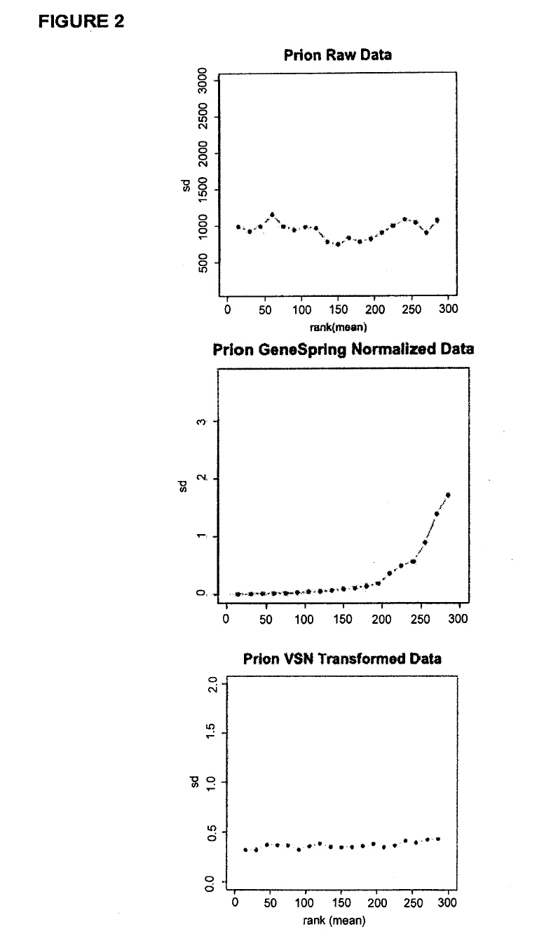

The overall initial raw data did not exhibit noticeable mean-variance-dependence for signals elicited by the 300 peptides across treatments in the plot, where ranks of the 300 means of the peptide signals were plotted against the corresponding standard deviations (sd) (left panel of FIG. 2).

However, considerable fluctuation exists in the standard deviation (sd). This may lead to unstable statistical inference in the paired t-test, because sd is used in the denominator of the test statistic TS₃. In addition, calibration was required regardless for the raw data to bring the negative and positive values to the same scale. Normalization by the GeneSpring software resulted in a steady increasing non-linear trend, indicating a systematic relationship between the means and variances (middle panel of FIG. 2). Since many statistical inferences such as t-test assumes independence between the mean and variance, the above violation may result in misleading conclusions (38).

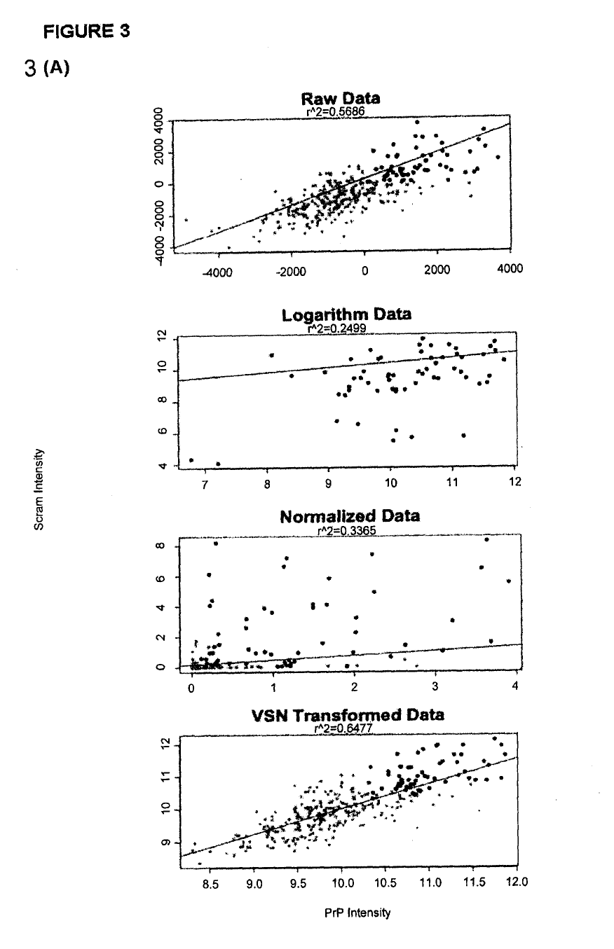

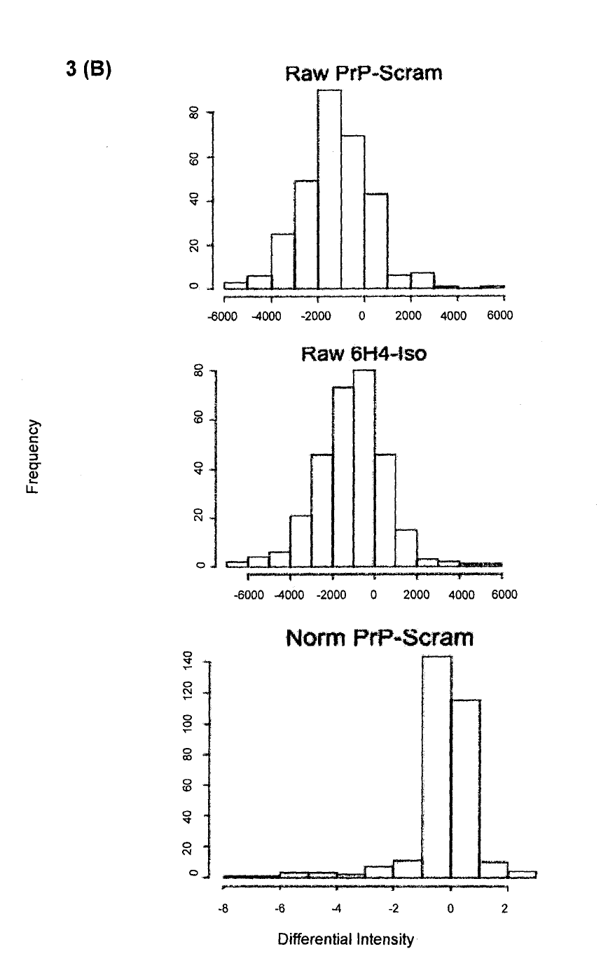

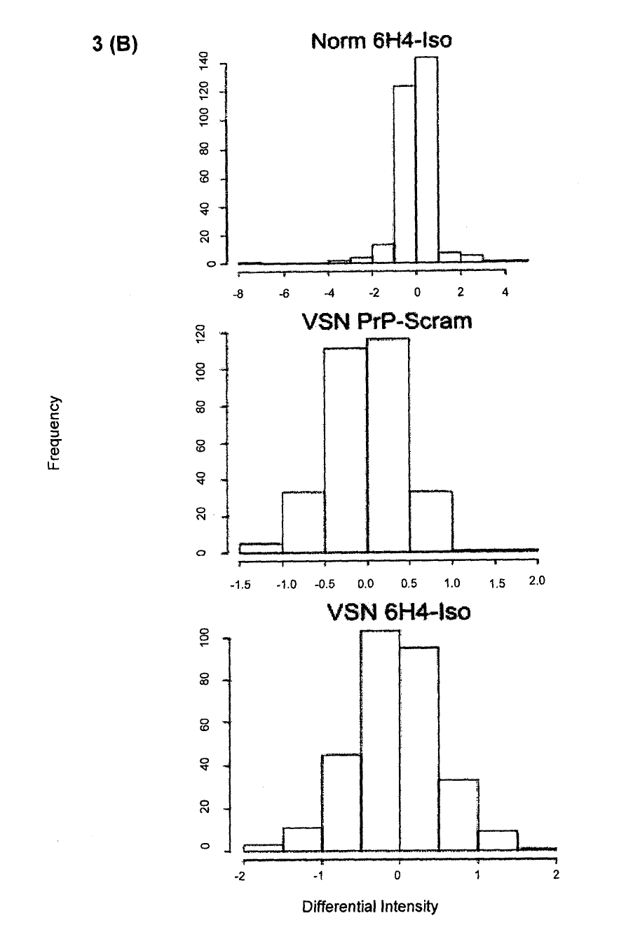

On the other hand, the VSN transformation achieved an almost horizontal line, indicating that the variance of the transformed data is approximately a constant, and that the mean-variance-dependence was reduced to the minimum after the procedure (right panel of FIG. 2). Furthermore, in contrast to normalization by GeneSpring and logarithm transformation on positive values only (top right and bottom left panels in FIG. 3A), the correlations between the responses of the same peptides under any two different treatments (exemplified by PrP vs Scram in the scatterplots in FIG. 3A) in the raw data were preserved after the VSN transformation, indicating no information was lost from the original data (top left and bottom right panels in FIG. 3A). In addition, the VSN transformed prion data assumed normal distribution whereas the data preprocessed by GeneSpring did not (FIG. 3B).

### 3.2.2 Spot-Spot Variability Analysis

In general, less than 10 peptides were inconsistently expressed (i.e., p-value <0.01 based on the χ²-test statistic TS₁) in each treatment, and 35 peptides in total were inconsistently expressed due to some technical variations among the five treatments in the prion datasets.

### 3.2.3 Subject-Subject Variability Analysis

Since all experiments were done on the human neuron from the same subject, there was no concern of subject variation in the prion datasets.

### 3.2.4 Treatment-Treatment Variability

The pseudo-image (FIG. 4) with labels indicating the actual microarray layout depicts the significance level of the phosphorylation status of each peptide elicited from human neuron, treated by PrP (left circle in each dot in FIG. 4) and 6H4 (right circle in each dot in FIG. 4) relative to the controls Scram and Iso, respectively. The kinomic patterns from the human neuron induced by the two prion related ligands appear to differ greatly. Illustrated in the right half of FIG. 4, 161 out of the 300 peptides behave in opposite ways when treated by PrP and 6H4. This indicates the complexity of the PrPC activation event. Only 9 peptides appear commonly expressed in both treatments at 0.2 significance level (a rather arbitrarily chosen level for illustration purpose) in either up or down-regulation, and one and none peptide appear commonly phosphorylated and dephosphorylated at 95% confidence, respectively (Table 2).

Exclusively in the PrP treatment, 16 peptides were significantly dephosphorylated with p-values ranging from 0.0034 to 0.044, and 15 differentially phosphorylated peptides with p-values from 6.4×10⁻⁵ to 0.049 were detected by the one-sided paired t-test at 5% significance level. Remarkably, the top three significantly up-regulated peptides all came from the same protein, inducible nitric oxide synthase (iNOS). The three phosphorylation sites on the protein are S739, Y151, and S909, achieving distinctively high p-values of 6.4×10⁻⁵, 3.8×10⁻⁴, and 3.8×10⁻³, respectively.

Fifteen and 10 6H4-specific peptides had dephosphorylation and phosphorylation signals, respectively that significantly differ from the ones in the Iso control at the 0.05 level of significance. Among these, PLCG1 and MKP-1 achieve the most significant p-values of 2.92×10⁻⁵ and 2.61×10⁻⁵, indicating significant dephosphorylation and phosphorylation on their corresponding sites of Y783 and S296, respectively.

### 3.2.5 Gene Ontology Enrichment Analysis

To elucidate the physiological roles of the differential peptides identified by the previous analyses at the 95% confidence level, the GO terms based on the corresponding UniProt accession numbers of the kinase targets were retrieved from public database using GOTermFinder (51). Based on the nature of the infection study, the GO terms provided by GOTermFinder were further reduced to the most relevant ones in the main aspects of biological process and biological function, excluding all the terms from cellular component branch. All of the PrP-specific peptides (31 in total) except for CTLA4 (down-regulated) and JIP1 (up-regulated) belong to cell communication. CTLA4 appears to engage in immune system process, regulation of cell activation, and regulation of leukocyte activation, and JIP1 in regulation of JNK cascade and regulation of MAPKKK cascade. Equal numbers of phosphorylated and dephosphorylated peptides appear to have the second most common GO term, cell surface receptor linked signal transduction. This is consistent with the primary role of PrPC, which is one of the members of the glycophosphatidylinositol (GPI) anchored proteins in transmembrane signaling (72).

In addition, 10 out of 16 dephosphorylated peptides are involved in regulation of gene expression, but only 1 in 14 phosphorylated peptides (IRAK1) is in that category. This remarkable contrast may imply that gene expressions of certain kinases in the human neuron were manipulated by the PrP fragment in a particular way related to the prion disease. The fact that 9 down-regulated and 1 up-regulated peptides appear in regulation of transcription provides some ground for the above speculation. Moreover, the 9 dephosphorylated peptides are also involved in transcription factor activity but none of the phosphorylated ones are in this category, further indicating the association between PrP and specific gene regulations. Some GO terms also appear exclusively in the phosphorylation list. For instance, MAPKKK cascade, JNK cascade, blood vessel morphogenesis, and blood vessel development appear in at least 3 up-regulated but 0 down-regulated peptides.

The physiological roles of the corresponding peptides and their connections with other biomolecules remain unclear. Finally, the GO terms for iNOS, which have all three the most significantly upregulated peptides due to the PrP treatment, are centered around response to oxygen. The iNOS protein modulates production of nitric oxide (NO), which is toxic to malaria parasites (58). The induction of iNOS through phosphorylation may thus have profound indication in the immune mechanism against prion infection.

Under the induction of 6H4, the significantly responsive peptides are also primarily involved in cell communication. Three exceptions, namely CaMK2α, ATF-2, and LEF-1, were all significantly phosphorylated, and are commonly and exclusively involved in regulation of gene expression and regulation of transcription.

It appeared that very little is known about the gene PLCG1 corresponding to the most significantly dephosphorylated peptides at the Y783 site. Similarly, not much is known about the gene DUSP1 corresponding to the most phosphorylated protein MKP-1 at the site S296 except that it has been identified in some rather general categories including cell communication, response to chemical stimulus, response to stress, and cell cycle.

3.2.6 Probing Signaling Transduction Pathways from KEGG

The known signaling transduction pathways that involve the proteins for the significantly phosphorylated or dephosphorylated peptides at 5% level were obtained from the KEGG database using the corresponding GeneSymbols (60). Table 3 contains the top 10 pathways ordered by the number of differential peptides induced by PrP or 6H4. The five common pathways in the list were highlighted in boldface. The proportions of the common and uncommon pathways seems in a very close agreement with those of the consistently (139/300) and inconsistently (161/300) expressed peptides under stimulants PrP and 6H4 in the paired t-test (FIG. 4 and Section 3.2.4). Based on the information from the KEGG database, pathways in cancer, MAPK signaling, and prostate cancer are all related to neurodegenerative diseases including Alzheimer's, Parkinson, Amyotrophic, Huntington and Prion diseases. This may provide some insights into the commonality of the diseases as understanding one disease may help in solving the other similar mysteries. In addition, the MAPK signaling pathway is a central pathway to many key cellular functions including cell proliferation, cell cycle, differentiation, immunity and apoptosis (52). Therefore, it is not surprising that the MAPK signaling pathway would have some function in PrPC signaling. Neurotrophins are a family of trophic factors involved in differentiation and survival of neural cells (74). It was shown to mediate both positive and negative survival signals, by signaling through the Trk and p75 neurotrophin receptors, respectively (68).

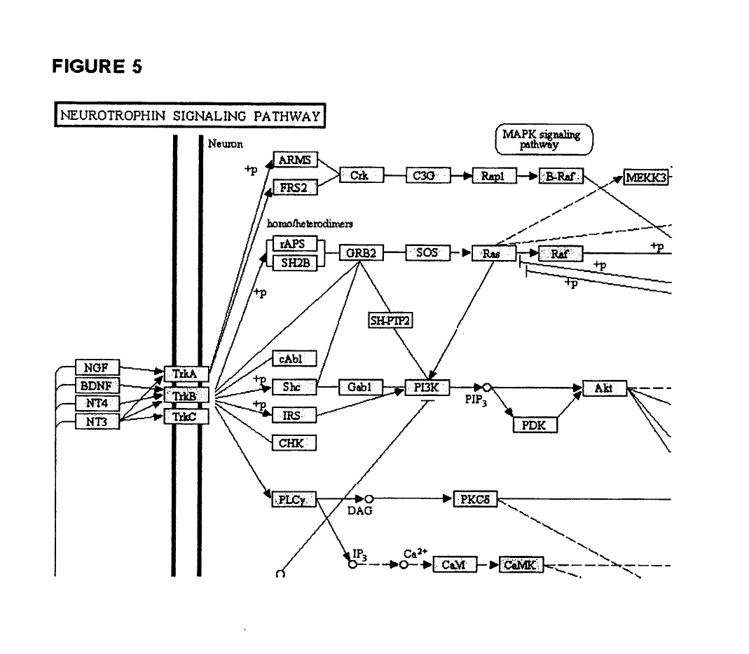

FIG. 5 shows that the key player Trk (p-value=0.047) along with other 5 components from the differential peptides under 6H4 treatments are present in the neurotrophin signaling pathway (only partially shown). The same pathway also appeared in PrP treatment, but 3 out of 4 differential proteins were not found significantly expressed in 6H4. This may imply that PrP and 6H4 have distinct ways of activating the same pathways. Toll-like receptors (TLRs) are expressed in mammalian innate immune cells such as macrophages and dendritic cells. Pathogen recognition by TLRs provokes rapid activation of innate immunity by inducing production of proinflammatory cytokines and up-regulation of costimulatory molecules (63). Therefore, it is likely that TLR signaling pathway has a crucial role in the immune system against prion pathogen. Furthermore, the TLR pathway is also linked to the neurotrophin and MAPK signaling pathway.

Thus, it is important to appreciate the complex network involved in the defense system to be able to make progress in exploring prion disease. The top 5 treatment-specific pathways in PrP or 6H4 added further diversity to the paths that could possibly reach to the same PrPC activation event (non-boldface in Table 3). Further investigation is required to incorporate their roles into the prion related immune network. Finally, the calcium signaling pathway deserves special attention, because it is in the top 10 list for 6H4 and involves the three most significantly phosphorylated peptides, all of which came from iNOS, under PrP treatment. Indeed, earlier findings indicated that scrapie infection induces abnormalities in receptor-mediated Ca2+ responses and raises the possibility that nerve cell dysfunction and degeneration in prion diseases is related to ion channel aberrations (64).

### 3.2.7 Clustering Analysis

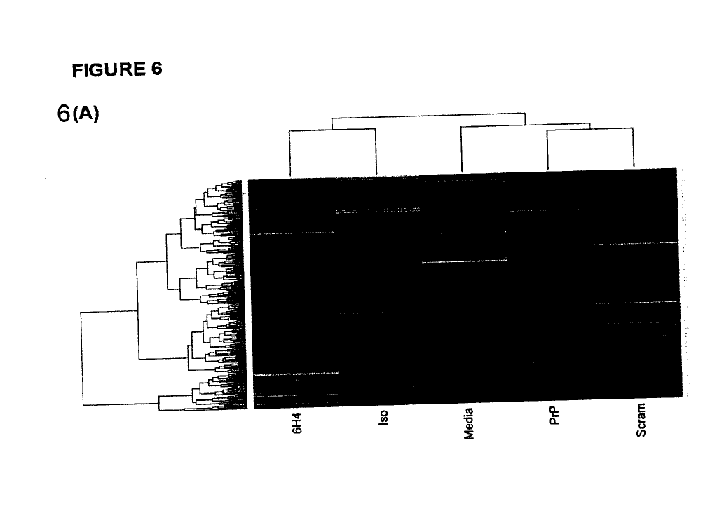

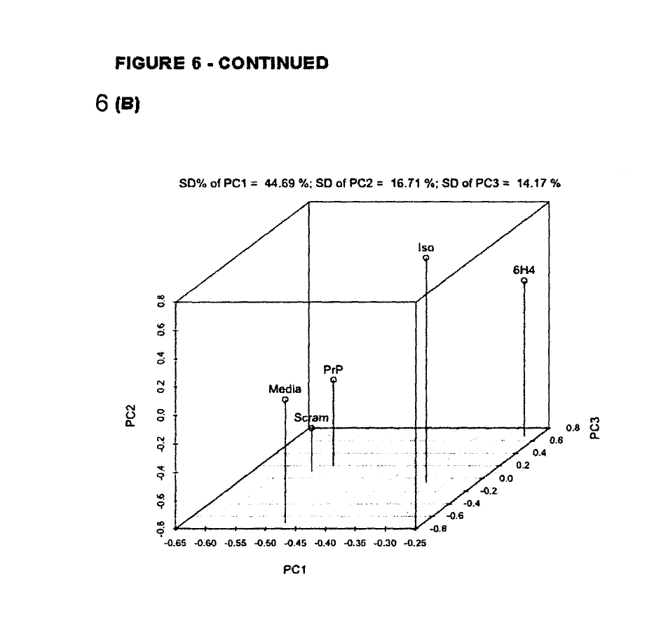

Clustering analysis of prion datasets was performed for comparative visualization of the kinome responses under the five treatment conditions, namely Media, PrP, Scram, 6H4, and Iso. To avoid misleading results, only the 265 peptides that do not differ significantly from each other across all replicates under each treatment at 0.01 significance level from the t-tests (Section 2.2) were used in the analysis. The cladogram from the heat map computed by the “Complete Linkage+Euclidean Distance” method shows that treatments of antibodies (i.e., 6H4 and Iso) form a single clade, and the cells treated with peptides (i.e., PrP and Scram) form their own cluster, isolated from the Media control (FIG. 6A). This is consistent with the results from PCA (FIG. 6B). PrP and Scram are close together in all the three components. 6H4 and Iso are in the vicinity of each other based on PC1 and PC2, which account for more than 61% variability of the prion datasets, and Media is much closer to PrP and Scram than it is to 6H4 and Iso in PC1 and PC2. The results strongly suggest the use of specific controls, namely Scram and Iso, to extract specific treatment effects respectively from PrP and 6H4 rather than using the Media control in the differential analysis such as the paired t-tests above. The other two hierarchical clustering methods produced very similar results except that the 6H4 was broken up from Iso to form its own outgroup. This may indicate that not all these computational methods are able to reflect the true biology underlying the data, and that it is worthwhile to experiment with different methods to thoroughly explore the datasets.

### 3.3 Results for MAP

### 3.3.1 Data Preprocessing

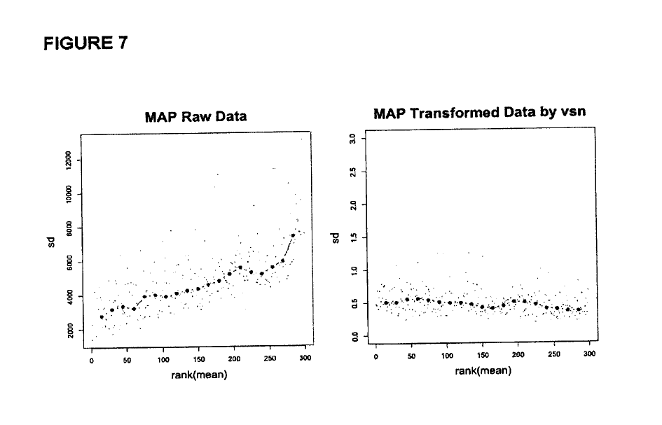

The data were transformed using a variance stabilization (VSN) model (38), previously trained using three datasets from time-series kinomic investigations of bovine monocytes from a different set of three outbred cattle. The initial raw data exhibited noticeable mean-variance-dependency for signals elicited by peptides across all animals and treatments. This was diagnosed as an increasing linear trend (left panel in FIG. 7).

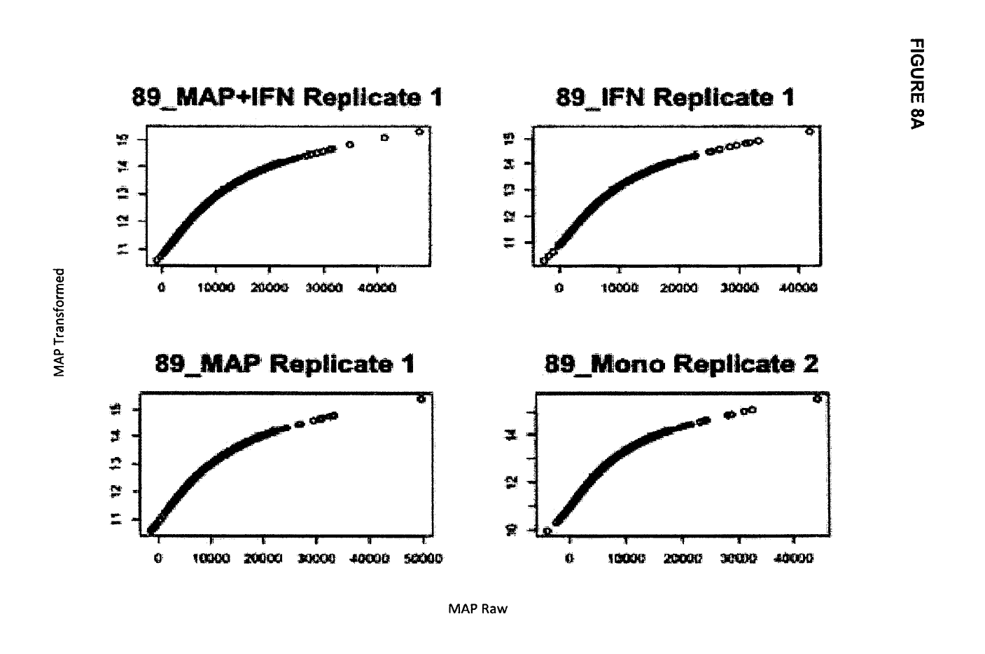

After the transformation, no systematic trend was observed (right panel in FIG. 7), while the correlation between the responses from different peptides was preserved, indicating no information was lost from the original data (FIG. 8). Since the GeneSpring normalization method seems to disrupt the internal structure of the data as demonstrated in the prion studies, it was omitted from this study.

### 3.3.2 Spot-Spot Variability Analysis

Since there are only 3 replicates for the same treatment and animal in the MAP datasets, the χ²-test statistic (TS₁) has only 2 degrees of freedom (Section 2.3). In this case, the test would not be reliable and was omitted. A commonly acceptable minimum degree of freedom is 8 (i.e. 9 replicates).

### 3.3.3 Subject-Subject Variability Analysis

In an outbred species, such as cattle, a degree of variability in biological responses is anticipated. To identify conserved biological processes, an F-test was applied to the MAP datasets after biological subtractions (i.e., considering only the IFN, MAP, and MAP+IFN after subtracting the corresponding Mono control signals) from the three bovine animals to determine animal dependent and animal-independent responses.

Animal-Animal Variability Analysis: Let a be the number of animals (i.e. 3), n the number of intra-array replicates, N the total number of replicates for each peptide for each treatment (i.e. N=n×a=3 replicates/array×3 animals=9 samples in total), μᵢ the mean response of each peptide in i^{th} animal (i□{1, 2, 3}), and m□{1, 2, 3} the m^{th} replicate of a peptide in the i^{th} animal. The null hypothesis H₀ claims that μ₁=μ₂=μ₃, or the mean phosphorylation intensities elicited by the identical peptide from the three animals are the same, and alternative hypothesis H_{A} states that not all three means are equal. The F-statistic was calculated as:

$${TS}_{1} = \frac{{MS}_{B}}{{MS}_{W}} ∼ F ( a - 1 , N - a )$$

$$where , \\ {MS}_{B} = {SS}_{B} / {df}_{B} = \frac{{\sum }_{i = 1}^{a} {( {\overline{y}}_{i} - \overline{y} )}^{2}}{a - 1}$$

$$( Mean Squares Between Animals )$$

$${MS}_{W} = {SS}_{W} / {df}_{W} \frac{{\sum }_{i = 1}^{a} {\sum }_{m = 1}^{n} {( {y}_{im} - {\overline{y}}_{i} )}^{2}}{N - a}$$

$$( Mean Squares Within Animals )$$

where y̅ᵢ=\hat{μ}ᵢ is the sample mean for i^{th} animal, y̅=\hat{μ} the grand mean of all the three animals, and yᵢₘ the individual response of the m^{th} replicate in the i^{th} animal. Finally,

p-value=P[TS₂>F(a−1,N−a)]

Under the same treatment condition, any peptides with p-value less than 0.01 were considered animal-dependent. By this criterion, only 2 peptides appear to be animal-dependent in all three treatments relative to the controls. Two hundred and twelve peptides elicit similar responses across all three treatments regardless of the choice of animal.

Eighty-six peptides are not conclusive in that p-values for those peptides are not consistently greater than or less than 0.01 across all three treatments relative to the control. Examining peptides within each treatment revealed 56, 7 and 56 peptides had significantly different reactions in the MAP+IFN, IFN, and MAP treatments, respectively. Thus, it appears that there is greater variance in how individual animals respond to MAP infection as compared to IFN stimulation of uninfected monocytes. This is consistent with the biological complexity of the stimuli.

### 3.3.4 Treatment-Treatment Variability

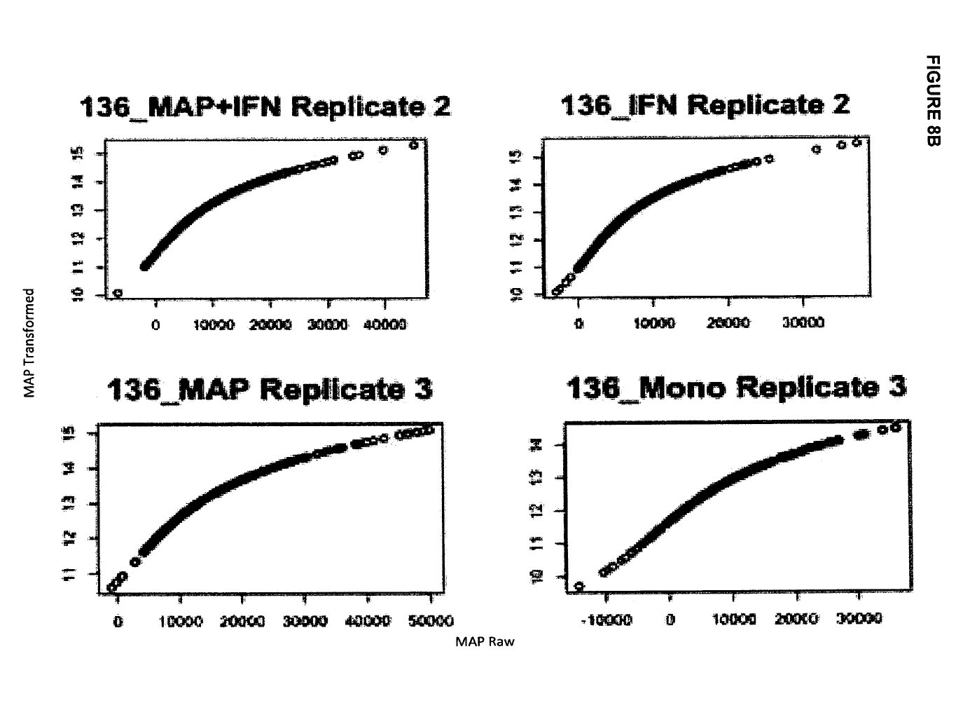

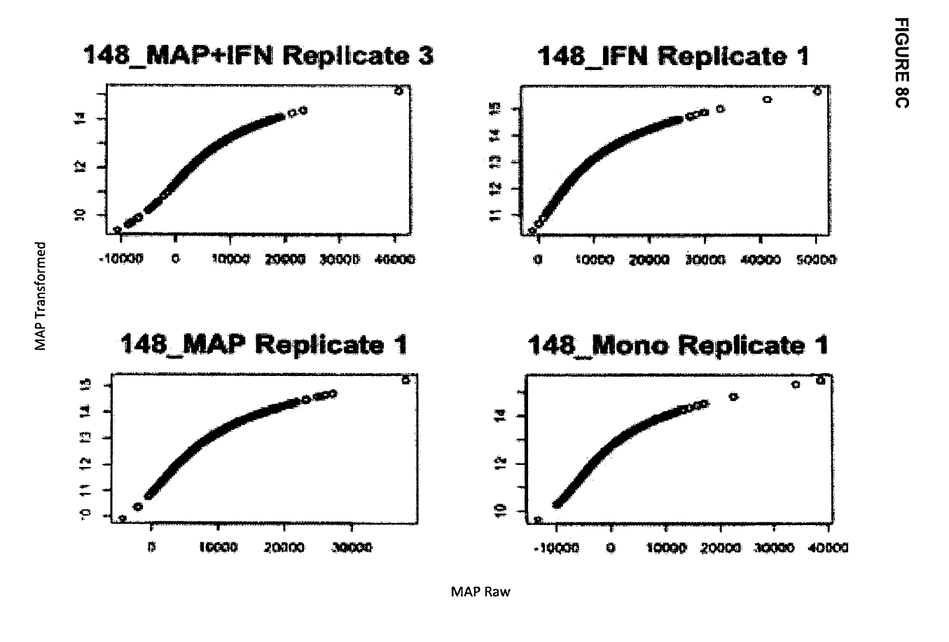

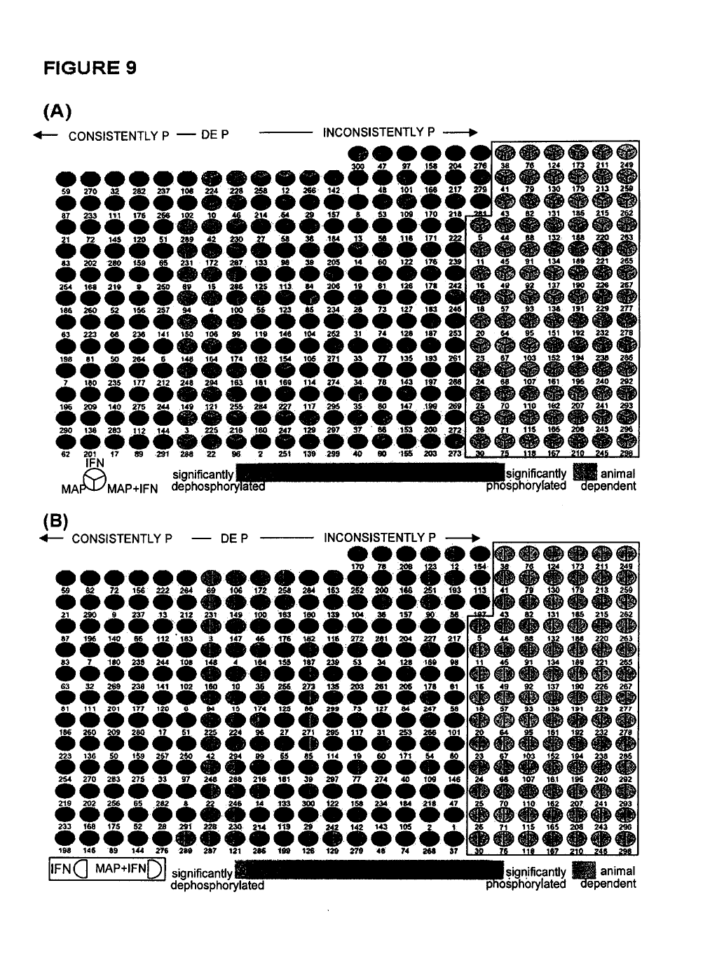

To identify peptides with significant changes in their phosphorylation status relative to the Mono control in the three treatment conditions, the 212 peptides identified as consistently regulated across the three animals were subjected to the paired t-test. The top, bottom left, and bottom right partitions in each dot from FIG. 9A represent the p-values for treatment IFN, MAP, and MAP+IFN, respectively. One hundred and seven peptides appear to have consistent phosphorylation status across all the three treatments relative to the Mono control (left part of FIG. 9A). Among these, 62 and 45 appear phosphorylated and dephosphorylated to various degrees proportional to the corresponding depths of the redness and greenness, respectively.

Among the 105 peptides that vary in responses across two or three treatments (starting from spot labelled “2” and go downwards by column to the right of the array), 14 peptides appear to be consistently phosphorylated under MAP and MAP+IFN but dephosphorylated under IFN (from 2 to 266), 24 dephosphorylated under the former two but phosphorylated due to IFN (from 29 to 300), and different combinations of up and down-regulations were observed in the remaining 67 ones (from 1 to 281).

The considerable number of peptides that were commonly expressed in MAP and MAP+IFN but not in IFN may indicate that MAP might have taken control over the signaling pathways in the bovine monocytes by blocking the immune venues provided by IFN. To further investigate this, comparison was limited to the phosphorylation status between IFN and MAP+IFN (FIG. 9B). This revealed that phosphorylation levels for many peptides that are significantly up-regulated by IFN alone appear significantly down-regulated by MAP despite of the presence of IFN (from 187 to 171). This provides further support to the above hypothesis.

Furthermore, 23 peptides were found significantly phosphorylated or dephosphorylated for IFN vs Mono at 95% confidence level, respectively. Paired t-test for MAP+IFN vs Mono identified 5 and 12 peptides significantly phosphorylated and dephosphorylated at 95% confidence level, respectively. For MAP vs Mono, 24 and 17 peptides were found significantly phosphorylated and dephosphorylated at 95% confidence level, respectively. Since more peptides appear differentially expressed in IFN alone (46 in total), but the number was greatly reduced when MAP was added (17 in total), the results once again may imply that IFN has less of an effect against MAP infected monocytes than it does to the uninfected monocyte.

### 3.3.5 Gene Ontology Enrichment Analysis

Same as in the prion study, only the GO terms from the main aspects of biological process and biological function were used based on the nature of the infection study. Three hundred and ninety-eight GO terms appear ubiquitous across the three treatments in the MAP datasets.

The most common ones are distinct from the ones identified from the prion datasets. The top 5 GO terms include binding, cellular process, biological regulation, regulation of cellular process, and regulation of biological process. The first GO is from biological function, and the latter four are all in the main branch of biological process. The results indicate that completely different mechanisms are involved in MAP infection or protective induction by IFN comparing with prion related biological functions or processes. However, since the sets of 300 peptides and cell lines used in the two studies were also different (human neuron for prion and bovine monocytes for MAP), correlation between MAP and prion is also not expected. Due to the complexity of the MAP datasets, a more systematic way needs to be developed to thoroughly explore the GO terms in this step.

3.3.6 Probing Signaling Transduction Pathways from KEGG

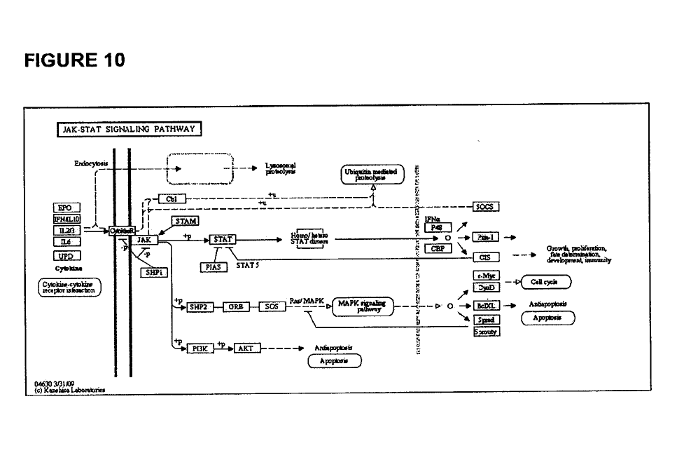

To identify the plausible pathways induced by IFN, MAP, and MAP+IFN, 10 pathways with the most significantly expressed peptides present at 5% level were collected from KEGG (Table 4). The Jak-STAT pathway (highlighted in bold in Table 4 and illustrated in FIG. 10), a hallmark of IFN signaling, emerged in the top list from IFN, but not in the other two treatments. It has been shown that the Jak-STAT pathway can be inhibited at a number of levels including at the receptor, intermediate signal molecules or final effectors (23; and herein). Therefore, it may be possible that some of the pathways associated with Jak-STAT can still be activated in both IFN and MAP+IFN, but fail to activate Jak-STAT due to the interference by MAP. Indeed, this was found to be the case in the current results. Both MAPK and ErbB signaling pathways (highlighted in blue in Table 4) are shared by IFN and MAP+IFN, and appear to be linked with Jak-STAT based on the information from KEGG and FIG. 10. Because neither pathway was present without IFN, as shown to be the case in the MAP treatment, it is likely that IFN is only partially functional due to the addition of MAP. Since IFN is responsible for the activation of macrophages for clearance of mycobacteria, this indicates that the intracellular immunity that IFN confers to the cells may be greatly compromised by MAP (12). Two MAP related pathways (highlighted in red in Table 4), namely NOD-like receptor and Toll-like receptor signaling pathway, also appear in MAP+IFN but not in IFN. Both were found to be associated with the intestinal immune network for IgA production from KEGG.

This is consistent with the symptoms in Johne's disease caused by MAP infection, which is diagnosed by severe gastroenteritis in ruminants (1). Therefore, some but not all MAP induced pathways are prevalent in the presence of IFN, and vice versa. This may indicate considerable interactions between the two stimuli within the bovine monocytes, but it appears that MAP essentially blocks the central venue to the Jak-STAT operated by IFN to facilitate its invasion, which are perhaps reflected by the NOD-like and Toll-like receptor signaling pathways.

### 3.3.7 Clustering Analysis

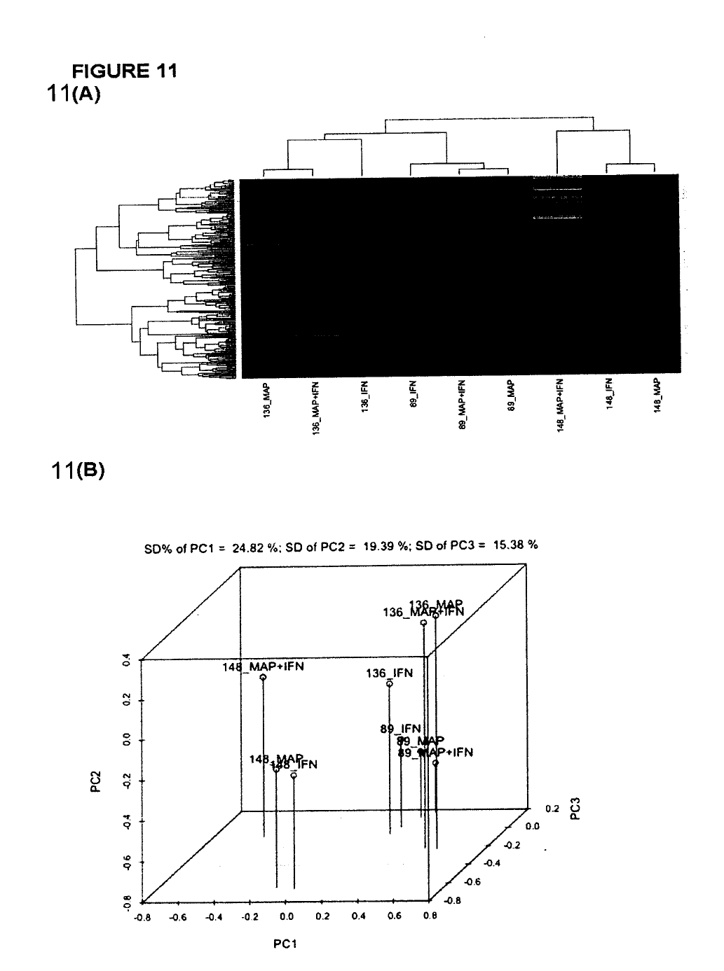

The hierarchical clustering using “Average Linkage+(1−Pearson Correlation)” reveals a strong pattern of clustering based firstly upon animals, and subsequently upon treatment conditions (FIG. 11A).

That the primary clusters still form on the basis of animal was surprising, because only the 212 of the 300 peptides, which were found to be animal-independent by the F-test at 0.01 level of significance, were used in the analysis. But the PCA using the same 212 peptides verifies the animal-dependence in that the data points of the same animal appear closer to each other than to the ones from different animals, according to all three components, which together account for 60% of the total variance within the datasets (FIG. 11B). This animal dependence may reflect accumulative differences of the selected peptides, which together contributed to the notable variations among animals. This is also manifested in the stringent level of confidence used in the Subject-Subject Variability Analysis (Section 3.3.3). Having a lower significance level (e.g., 5%) would mean that more peptides would be determined to have differing expression levels across animals and would be eliminated from further analysis. This may result in less prominent clustering by animal, but would result in fewer peptides being considered in the Treatment-Treatment Variability, GO enrichment and KEGG pathways analyses (Sections 3.3.4, 3.3.5, and 3.3.6), while keeping the inputs consistent for each analysis. Notably the kinome experiments for all the animals were performed simultaneously in a single run minimizing the possibility of technical variances in the analysis. Examining the sub-clusters within each main cluster from FIGS. 11A and 11B revealed that MAP+IFN and MAP tend to cluster together in 2 out of the 3 animal clusters. That the kinome profile of MAP+IFN resembles that of MAP is consistent with the earlier findings from the paired t-test and KEGG pathway analysis, where it was postulated that MAP took over the signal transduction network by blocking some of the pathways induced by IFN co-present in the bovine monocytes. The results from the other hierarchical clustering methods are similar.

### 4 Discussion

A framework for systematically analyzing various aspects of the kinome datasets has been developed and implemented primarily in the R environment (39). The aim is to thoroughly explore the intrinsic structure of the data from statistical, biological, and computational standpoints. Thus, this study inclines to be a proof-of-concept type of work, demonstrating the plausibility of using the approach to elucidate signal transduction pathways from high dimensional datasets and its superiority over other relevant techniques. Several challenges have been identified, and some but not all were solved. The mean-variance dependence problem due to the inherent nature of the microarray data is in general well handled by VSN transformation (38). However, even after the transformation, some replicates still demonstrate considerable fluctuations for the same peptides from the same cell-line under the same treatment effect. In fact, by manually examining some of the differences between the replicates under treatment and control conditions, two replicates for a single peptide from the same experimental condition show opposite phosphorylation directions. That is, one signals up and the other down-regulation. All inconsistently expressed peptides including the above extreme cases can be systematically identified using the χ² test and eliminated from the subsequent analyses. Alternatively, if the datasets were large (e.g., >20 replicates for each peptide for a cell-line under the same treatment), then the conspicuous intensities for each peptide can be treated as outliers and taken out of the data, followed by imputation such as Expectation-Maximization (EM) to fill in the missing values (70). As a result, other experimental data for the same peptide is preserved. However, since sample sizes of both the prion and MAP datasets are fairly small, imputation may not be reliable, and eliminating the entire data for the corresponding peptide seems to be the best option. All the statistical tests, including χ², F, and paired t-tests, assume independence between any two tests for any two peptides. This is unlikely always the case. Several peptides with different phosphorylation sites came from the same kinase protein, and therefore are more or less correlated in phosphorylation events. In other words, the probability for the second site to be phosphorylated following the first site on the same protein may be higher or lower than the chance of the first phosphorylation on that protein. Taking this into account involves multiple hypothesis testing. Corrections and tests of this type, including but not limited to Bonferroni, Scheffe, Tukey, Dunnet, and moderated t-test from the limma package are favoured by statisticians in various type of analyses (73; 76; 40). A potential problem for these tests is the stringency they tend to impose on the inferences in order to achieve a global Type I error (say 5%) throughout the tests. This often works well for gene expression data, because usually ≈10,000 of genes are considered at one time, and the aim is to reduce this size by 100 folds (54). In that case, high specificity is favoured over sensitivity to avoid false positives as much as possible at cost of false negatives. However, the dimensionality of the kinome datasets is not as high as the transcription datasets, and phosphorylation of peptides may not be as efficient as hybridizations of oligonucleotides on transcription arrays in vitro. Therefore, it may be advisable not to easily eliminate any of the peptides as some of them may turn out to be crucial in the pathway analysis. In particular, a recent kinome study used limma to identify phosphorylated substrates in chondrosarcoma (71). Oddly, the top 100 peptides imported into the Ingenuity Pathway Analysis (IPA) (another pathway analysis program) were not based on the adjusted p-values but rather on the averaged phosphorylation signals, rendering the moderated t-test from limma rather futile. From the supplementary table, where those 100 kinase targets are listed, most of substrates have rather insignificant p-values (many even have >0.9) but nonetheless were used in the analysis because of their high averaged intensities. This reflects the over-stringency imposed on the kinome study by the moderated t-test, which was solely designed for transcription not kinome analysis. Furthermore, the signal intensities elicited by the peptides essentially come from the radio-labeled ATP, which can noncovalently link to the peptides occasionally resulting in background intensities higher than the corresponding foreground intensities and consequently leads to negative intensity values after the background corrections (37). This was observed in both the prion and MAP studies. The commonly used workflow with normalization, averaging, and fold-change calculation in the differential analysis for gene expression studies is not directly applicable to the negative values, but was nonetheless applied to kinome analyses in many studies, which presumably excluded any negative values in the first place and were therefore subject to loosing valuable information (57; 65; 75). The affine linear mapping as the calibration step in the vsn package brings all the data points including the negative ones onto the same positive scale, while maintaining the correlations between them as illustrated in FIG. 3 (38). Therefore, all the information from the kinome experiments is preserved in the VSN transformation.

Currently, the most common GO terms for the differential peptides from all the treatments in the same datasets are listed first followed by the less common ones in a table (Section 2.5 and Table 1). These can be clustered the differential peptides specific to a subgroup of the treatments based on their GO annotations, which have been encoded by binary to indicate the presence or absence of that GO term for the corresponding peptides (blue step in FIG. 1 and Table 1). The treatment subgroup can be selected from the hierarchical or PCA clusters (e.g., the subgroup of 136 MAP and 136 MAP+IFN). It is expected that clusters of such may be correlated with the known signaling pathways from KEGG identified from the pathway analysis (Section 2.6). If the two types of results confirm each other under certain criteria, this could suggest that the peptides not included in the known pathways do in fact play some roles in them. Presumably, this may facilitate discovery of novel pathways. In addition, an early study presented a framework for identifying signaling pathways in protein-protein interaction networks (50).

Briefly, functional annotations such as GO terms of proteins are extracted from a comprehensive set of known pathways. These annotations are used to derive association rules that characterize the patterns of the transduction events. A weighted protein protein interacting network (PPIN) is constructed for searching candidate pathway segment based on the association rules. The edges in a feasible path are weighted by the corresponding gene correlations from expression profiles of related microarray data. Paths with averaged weights above a threshold are hypothesized to be biologically meaningful and tested for the known signaling pathways. Based on this study, an inspired alternative workflow in the Gene Ontology Enrichment Analysis (Section 2.5) step is outlined as follows. First, the association rules are extracted from several important pathways from public database such as KEGG. Second, the genes involved in the pathways are mapped into their corresponding GO annotations. Third, the differential peptides identified by the paired t-test are ordered based on their GO terms that are matched against the GO term pairs in the association rules. Because the number of significantly expressed peptides relative to the control is usually small, the search can be exhaustive in favour of thoroughness. It is expected that the path of the selected peptide is representative to a segment of one or more pathways induced by a particular treatment. Finally, to be widely used by researchers from various disciplines, a graphical user interface implemented on top of the R scripts may be desirable.

### 5 Conclusions

The kinome-analysis programs developed in this study is able to identify key kinase substrates specific to a treatment, their GO annotations, and the pathways from KEGG, in which they are involved, in prion and MAP studies. This is done primarily through differential analysis based on the signal intensities, which indicate the phosphorylation status of the selected kinase targets in an array.

In addition, clustering analysis can be used to confirm the findings from the preceding analyses by examining the differences between the global patterns of kinase responses between the treatments, and may also provide new insights in a data-driven approach. The results obtained from both infection studies provide substantial supports to the feasibility of using the framework in other independent kinome studies.

### Example 2

Mycobacterium avium subsp. paratuberculosis (MAP) is the causative agent of Johne's disease in cattle and is implicated in Crohn's disease in humans. Establishment of chronic infection by MAP depends on its subversion of host immune responses. This includes blocking the ability of infected macrophages to be activated by gamma interferon (IFNγ) for clearance of this intracellular pathogen. To define the mechanism by which MAP subverts this critical host cell function patterns of signal transduction to IFNγ stimulation of uninfected and MAP-infected bovine monocytes were determined through bovine-specific peptide arrays for kinome analysis. Pathway analysis of the kinome data indicated activation of the JAK-STAT pathway, a hallmark of IFNγ signaling, in uninfected monocytes. In contrast, IFNγ stimulation of MAP-infected monocytes failed to induce patterns of peptide phosphorylation consistent with JAK-STAT activation. The inability of IFNγ to induce differential phosphorylation of peptides corresponding to early JAK-STAT intermediates in infected monocytes indicates MAP blocks responsiveness at, or near, the IFNγ receptor. Consistent with this hypothesis, increased expression of negative regulators of the IFNγ receptor, SOCS1 and SOCS3, as well as decreased expression of IFNγ receptor chains 1 and 2 are observed in MAP infected monocytes. These patterns of expression are functionally consistent with the kinome data and offer a mechanistic explanation for this critical MAP behaviour. Understanding this mechanism may contribute to the rational design of more effective vaccines and/or therapeutics.

Mycobacterium avium subsp. paratuberculosis (MAP) is the causative agent of Johne's disease, a chronic inflammatory disorder of the gastrointestinal tract of ruminants (1, 2). Johne's disease is of considerable economic importance to the dairy industry as it is responsible for the highest average production losses among five production-limiting diseases (3, 4). There is additional growing concern that MAP may be a causative, or contributing, factor to Crohn's Disease in humans. While this link has yet to be conclusively determined there is considerable circumstantial evidence implicating MAP in Crohn's disease (5-7). The potential zoonotic threat, and realized economic impact, of Johne's Disease has energized efforts for development of effective disease management strategies. The limited success of these efforts to date indicates that greater understanding of the biology and virulence mechanisms of MAP is required to adopt a more strategic approach to vaccine design. Specifically, that an understanding of the mechanisms by which MAP subverts host immune responses could form the basis for development of successful vaccine formulations and strategies.

Mycobacteria have developed numerous strategic mechanisms to achieve chronic infections. For example, MAP establishes persistent infections within host macrophages in the small intestine. This requires MAP to subvert the normal functions of the macrophage which would result in destruction of the internalized bacteria (8, 9). While MAP has been well characterized for its ability to block maturation of the phagolysomes, MAP also appears to interfere with other host processes which are equally essential for effective clearance of intracellular pathogens. This includes blocking responsiveness of the infected host cells to gamma interferon (IFNγ) stimulation.

Cattle in the excretory subclinical stage of Johne's disease have increased IFNγ at the site of infection (10) as well as higher IFNγ production in culture supernatants after stimulation of peripheral blood mononuclear cells (PBMC) with MAP antigens (11). Furthermore, while macrophages pre-treated with IFNγ are able to effectively clear mycobacteria (12, 13), the same treatment, given post-infection, is unable to achieve efficient destruction of the bacterium (14, 15). Collectively these results indicate an inability of the infected animals to respond to, rather than produce, IFNγ. The mechanism(s) by which MAP blocks host cell IFNγ responsiveness has yet to be determined.

Gamma interferon plays a central role in immune defense against a variety of intracellular pathogens including mycobacteria (16, 17). Mice deficient in IFNγ show increased susceptibility to intracellular pathogens (18, 19) and humans with mutations of the IFNγ receptor are susceptible to infection with low virulence mycobacterial strains and suffer severe and recurrent episodes of tuberculosis (20, 21). IFNγ is released from T cells and natural killer cells to activate targets cells through a high-affinity receptor composed of two chains; IFNγ receptor 1 (IFNGR1) and IFNγ receptor 2 (IFNGR2). Signal transduction by IFNγ is classically associated with a specific Janus family kinase-signal transducer and activator of transcription (JAK-STAT) signaling cascade (22, 23). Ligand binding by the IFNγ receptor causes phosphorylation of Jak1 and Jak2 with subsequent phosphorylation of IFNGR1 (24, 25). Phosphorylation of IFNGR1 results in recruitment and phosphorylation of Stat1 which translocates to the nucleus to activate transcription of IFNγ-inducible genes (26). IFNγ acts primarily through regulation of gene expression to induce macrophages to kill intracellular pathogens.

A number of viral and bacterial pathogens have evolved strategies to block the IFNγ responsiveness of infected cells to avoid destruction by the associated host defense response. This varies from actions targeted to specific gene products to general inhibition of IFNγ signaling. JAK-STAT signaling can be inhibited at a number of levels including at the receptor, intermediate signal molecules or final effectors. At the receptor, a number of pathogens decrease expression of IFNGR1, IFNGR2 or both; Trypanosome cruzi (27) and Leishmania donovani (28) decrease expression of IFNGR1, adenovirus decreases expression of IFNGR2 and Mycobacterium avium decreases expression of both IFNGR1 and R2 (29). IFNγ responsiveness can also be dampened by reducing the quantity, or activation status, of JAK-STAT pathway intermediates; human cytomegalovirus targets JAK kinases for degradation (30), mumps reduces levels of Stat1 (31), varicella zoster virus reduces levels of Jak2 and Stat1 (32) and L. donovani activates protein tyrosine phosphatase SHP-1 for dephosphorylation and inactivation of Jak2 (33). JAK-STAT transcriptional effectors are also targeted by microbes; adenovirus inhibits IFNγ induced gene expression through direct interaction with cellular transcription factors (34, 35). Collectively, targeted disruption of the IFNγ response by a variety of viral and bacterial pathogens emphasizes the importance of this system in host defense against intracellular pathogens. The diverse mechanisms employed suggest that different points of intervention are more appropriate, or easily achieved, by different pathogens.

In this report patterns of host signal transduction in uninfected, and MAP-infected, bovine monocytes are investigated in response to IFNγ stimulation. Analysis is performed through a novel bovine-specific peptide array for kinome analysis. Pathway analysis of the kinome data indicates activation of the JAK-STAT pathway, a hallmark of IFNγ signaling, in uninfected monocytes. In contrast, IFNγ stimulation of MAP-infected monocytes fails to induce patterns of peptide phosphorylation consistent with JAK-STAT activation. The inability of IFNγ to induce differential phosphorylation of peptides corresponding to early JAK-STAT intermediates in infected monocytes indicates MAP blocks responsiveness at, or near, the IFNγ receptor. Consistent with this hypothesis increased expression of negative regulators of the IFNγ receptor, SOCS1 and to a lesser extent SOCS3, as well as decreased expression of IFNGR1 and IFNGR2 in MAP-infected monocytes are reported. These responses are anticipated to contribute to the inability of MAP-infected cells to be activated by IFNγ. This, in turn, contributes to the ability of MAP to convert cells which would normally be responsible for mediating bacterial clearance into protected havens for bacterial proliferation.

### Materials and Methods:

Isolation of Bovine Blood Monocytes:

Blood was collected from 3 cattle (9 month old charolais-cross steers, coded as animals 89, 136 and 143) by venupuncture using tubes containing EDTA as an anti-coagulant. Blood was transferred to 50-mL polypropylene tubes and centrifuged at 1400×g for 20 min at 20° C. White blood cells were isolated from the buffy coat and mixed with PBSA (Ca²⁺ and Mg²⁺ free PBS) to a final volume of 35 mL. The cell suspension was layered onto 15 mL of 54% isotonic PERCOLL (Amersham Biosciences, GH healthcare) and centrifuged at 2000×g for 20 min at 20° C. Peripheral blood mononuclear cells (PBMC) from the PERCOLL-PBSA interface were collected and washed three times with cold PBSA. Monocytes were purified from isolated PBMCs by MACS purification using CD14+ microbeads (Miltenyi Biotec Inc., Auburn, Calif.). Monocytes (>95% pure) were plated at 5×10⁶ cells/well in 6-well plates in RPMI 1640 medium (GIBCO) supplemented with 10% fetal bovine serum (GIBCO). Isolated monocytes were rested overnight prior to stimulation.

Infection of Bovine Monocytes with MAP:

MAP K10 culture was incubated at 37° C. on Middlebrook 7H10 agar (Difco Labs, Detroit, Mich., USA) with OADC enrichment medium (Difco Labs, Detroit, Mich., USA) and mycobactin J (Allied Monitor Inc., Fayette, Mo., USA). After 3-4 weeks of growth, colonies were transferred to Middlebrook 7H9 broth (Difco Labs, Detroit, Mich., USA) containing 0.05% Tween 80 (Sigma Chemical Co., St. Louis, Mo., USA), OADC enrichment medium, and mycobactin J and incubated at 37° C. for 5 days to achieve log phase growth. Colony forming units were determined using the pelleted wet weight method. Briefly, a 50 ml centrifuge tube was weighed prior to the addition of 50 ml of a 5 day liquid MAP culture. The culture was centrifuged at 3400×g for 30 minutes. Supernatant was decanted and the pellet dried for 30 minutes. Tube weight was then recorded and pellet weight determined. According to Hines et al., 2007 whereby 1 mg of MAP pellet is equal to 10⁷ cfu. The MAP pellet was then resuspended in the appropriate volume of cell culture media to achieve a 5:1 MOI. Appropriate bacterial loads were added to each well of five million monocytes/well. Plates were spun at 300 rpm for 2 minutes. All infected plates were incubated for 3 hours at 37° C. Media was removed and cells washed three times with warm RPMI 1640 media. Cells were rested overnight at 37° C. prior to stimulation with 10 ng/mL recombinant bovine IFNγ for 1 hour. Cells were then treated with 10 ng/mL IFNγ then harvested at the appropriate time for either kinome or qRT-PCR analysis. Kinome analysis was performed 1 hour after infection while qRT-PCR was performed after both 1 hour and 18 hours of infection.

RNA Extraction:

Total RNA extraction was performed as per the RNeasy Mini Kit Protocol (Qiagen). Briefly, 1 mL of Buffer RLT+beta-mercaptoethanol was added to each well for five minutes. Cells were collected in a 2 mL tube, vortexed briefly, and stored at −80° C. until further processing. Homogenization of samples was achieved by running samples through a QIAshredder (Qiagen). Molecular grade ethanol was added to each sample before running the sample through an RNeasy mini spin column. An optional DNase treatment was performed on each sample by adding a DNase solution (Qiagen) to the column and allowing the solution to sit for fifteen minutes. Three washes were performed followed by elution in nuclease-free water. Each sample was quantified and checked for purity using a 2100 Bioanalyzer (Agilent Technologies, Inc.).

Preparation of cDNA LIBRARY:

RNA (200 ng) was converted to cDNA by adding 8 μl 2×RT Buffer and 2 μl RT Enzyme (Invitrogen) to a total volume of 10 μl. A master mix of buffer and enzyme was made to eliminate pipeting error. Samples were placed in a thermocycler under the following conditions: 25° C. for 5 minutes; 50° C. for 60 minutes; 70° C. for 15 minutes. RNA template was removed by adding 1 μl E. coli RNase H for 20 minutes. cDNA was stored at −20° C.

qRT-PCR:

Each reaction for qRT-PCR included 9 μl iQ SYBR Green Master Mix (BioRad), 3 μl primer mix (3.3 uM), 2 μl nuclease-free water, and 1 ul cDNA for a total of 15 μl reaction. Thermocycler conditions were as follows: Cycle 1: 55° C. for 2 minutes; Cycle 2: 95° C. for 8.5 minutes; Cycle 3: Step 1-95° C. for 15 seconds, Step 2-55° C. for 30 seconds, Step 3-72° C. for 30 seconds; Cycle 4: 55° C. for 10 seconds with increase set-point temperature after cycle 2 by 1° C. Results were analyzed using the 2^{-ΔΔCT} method described in Applied Biosystems User Bulletin No. 2 (P/N 4303859).

Monocyte TNFα Release in Response to IFNγ Stimulation:

Purified monocytes (uninfected and MAP-infected) were prepared as described earlier. Recombinant bovine IFNγ (Ciba-Geigi) was added at a final concentration of 10 ng/mL. Plates were returned to incubator overnight. Supernatant was collected from each well, diluted (1:2), and used for ELISA assays for bovine TNFα (36).

Cytospins:

Cells were harvested using a trypsin/versene solution. The cells were prepped for cytospins by centrifugation at 325×g for 5 minutes. Cells were resuspended in 200 μL PBSA+0.1% EDTA. Cytospins were performed by adding 100 μL cell suspension to apparatus and spinning at 1000 rpm for 3 minutes onto a glass slide. Slides were allowed to dry overnight in fume hood. Cells were heat fixed to slides by briefly passing through flame. Slides were placed over boiling water and stained with carbol fuchsin for 5 minutes, rinsed and acid destain was briefly added to each slide before rinsing with water. Slides were counterstained using methylene blue (Sigma) for 1 minute and rinsed with water. Slides were allowed to dry overnight in fume hood. The next day, each “cytospot” was fixed using Entellen New Rapid Mounting Medium (EMScience) with a coverslip. Cells were observed on a light microscope under oil immersion (100×).

Peptide Arrays:

Design, construction and application of the peptide arrays is based upon a previously reported protocol with modifications (37). Notably the kinome experiments for all the animals were performed simultaneously in a single run minimizing the possibility of technical variances in the analysis. Briefly, approximately 10×10⁶ cells were collected, pelleted and lysed by addition of 100 μL lysis buffer (20 mM Tris-HCL pH 7.5, 150 mM NaCl, 1 mM EDTA, 1 mM EGTA, 1% Triton, 2.5 mM sodium pyrophosphate, 1 mM Na₃VO₄, 1 mM NaF, 1 μg/mL leupeptin, 1 g/mL aprotinin, 1 mM PMSF) (all products from Sigma Aldrich unless indicated). Cells were incubated on ice for 10 minutes and spun in a microcentrifuge for 10 minutes at 4° C. A 70 μl aliquot of this supernatant was mixed with 10 μl of activation mix (50% Glycerol, 500 uM ATP (New England Biolabs, Pickering, ON), 60 mM MgCl₂, 0.05% v/v Brij-35, 0.25 mg/mL BSA), incubated on the array for 2 hours at 37° C. Arrays were then washed with PBS-(1%) Triton.

Slides were submerged in phospho-specific fluorescent ProQ Diamond Phosphoprotein Stain (Invitrogen) with agitation for 1 hour. Arrays were then washed three times in destain containing 20% acetonitrile (EMD Biosciences, VWR distributor, Mississauga, ON) and 50 mM sodium acetate (Sigma) at pH 4.0 for 10 minutes. A final wash was done with distilled deionized H₂O. Arrays were air dried for 20 min then centrifuged at 300×g for 2 minutes to remove any remaining moisture from the array. Arrays were read using a GenePix Professional 4200A microarray scanner (MDS Analytical Technologies, Toronto, ON) at 532-560 nm with a 580 nm filter to detect dye fluorescence. Images were collected using the GenePix 6.0 software (MDS) and the spot intensity signal collected as the mean of pixel intensity using local feature background intensity background calculation with the default scanner saturation level.

### Data Analysis:

Datasets:

The dataset contains the signal intensities associated with each of 300 peptides for the monocytes from 3 animals under 4 different treatments. Those treatments are labelled “IFN” (IFNγ treatment alone), “MAP” (MAP infection alone), “MAP+IFN” (MAP infection followed by IFNγ treatment), and “Mono” (no treatment). For each animal and each treatment, there are three intra-array replicates.

### Data Preprocessing:

The specific responses of each peptide were calculated by subtracting background intensity from foreground intensity. The resulting data were transformed using a variance stabilization (VSN) model (38), previously trained using three datasets from time-series kinomic investigations of bovine monocytes from a different set of three outbred cattle. The transformation brings all the data onto the same scale while alleviating variance-mean-dependence. In addition, for each of the 300 peptides in a single treatment and animal, the average was taken over the three transformed replicate intensities. Note that the averaging was only applied in the subsequent clustering analysis not in the statistical inferences. Finally, the intensities induced by the treatments were adjusted by subtracting the intensities of the biological control (i.e. Mono) of the same animal. The R package vsn was used for the VSN transformation (39). The initial raw data exhibited noticeable mean-variance-dependency for signals elicited by peptides across all animals and treatments. This was diagnosed as an increasing linear trend (left panel of FIG. 7). After the transformation, no systematic trend was observed (right panel of FIG. 7), while the correlation between the responses from different peptides was reserved, indicating no information was lost from the original data (FIG. 8).

Animal-Animal Variability Analysis:

For each of the 300 peptides, an F-test was used to determine whether there are significant differences among the three animals under the same treatment condition. Therefore, 300 F-tests were carried out for a single treatment on the three animals, and 1,200 tests in total for all four treatments (i.e. 300 peptides×4 treatments) (40). The null hypothesis H₀ claims that the mean phosphorylation intensities for the identical peptide from the three animals are the same, and alternative hypothesis H_{A} states that not all three means are equal. The peptides with p-value less than 0.01 are considered inconsistently expressed among the three animals and will be eliminated from the subsequent analyses. This strict confidence level was used so that as much data as possible was retained.

Treatment-Treatment Variability Analysis:

Peptides identified by the F-test as having consistent patterns of response to the various treatments across the three animals were subjected to a paired t-test to compare their signal intensities under a treatment condition with those under control conditions (40). For each animal-independent peptide, the responses from all three animals were pooled to increase the statistical confidence. Three tests were done for each peptide. Specifically, the tests were IFN vs Mono, MAP+IFN vs Mono, and MAP vs Mono. Peptides with significant (p<0.20) changes in phosphorylation were selected. This level of significance was chosen to retain as much data as possible and thus facilitate subsequent pathway analysis. The paired t-test was done using R built-in function t.test with paired=True (39).

Cluster Analysis:

The preprocessed MAP data were subjected to hierarchical clustering and Principal Component Analysis (PCA) to cluster peptide response profiles across animal-treatment combinations. For hierarchical clustering, three independent combinations of clustering method and distance measurement were used, namely “Complete Linkage+Euclidian Distance”, “McQuitty+(1−Pearson Correlation)”, and “Average Linkage+(1−Pearson Correlation)” (41, 42, 43, 44). In general, each animal/treatment vector was considered as a singleton (i.e. a cluster with a single element) at the initial stage of the clustering. The two most similar clusters were merged and the distances between the newly merged clusters and the remaining clusters were updated, iteratively. The calculations of similarity/distance between the clusters and the update step are algorithmically specific. The “Average Linkage+(1−Pearson Correlation)” is the method used by Eisen et al. (45). It takes the average over the merged (i.e. the most correlated) kinome profiles and updates the distances between the merged clusters and other clusters by recalculating the correlations between them.

PCA was applied to the MAP data both before and after subtractions of biological controls. In either case, the first two principal components, namely PC1 and PC2, which account for the largest variability within the sample data, were used to cluster the animal/treatment data points. R functions hclust and prcomp were used for the hierarchical clustering and PCA, respectively (39).

Pathway Analysis of Differentially Phosphorylated Peptides: InnateDb (www.innatedb.com) is a publically available resource which, based on levels of either differential expression or phosphorylation, predicts biological pathways based on experiment fold change datasets (46). Pathways are assigned a probability value (p) based on the number of proteins present for a particular pathway as well as the degree to which they are differentially expressed or modified relative to a control condition. For the present investigation input data was limited to those peptides selected in the Treatment-Treatment Variability Analysis (above). Since InnateDB requires fold-change data, the antilog of transformed intensity differences was computed and used.

### Results

Infection of Bovine Monocytes with MAP:

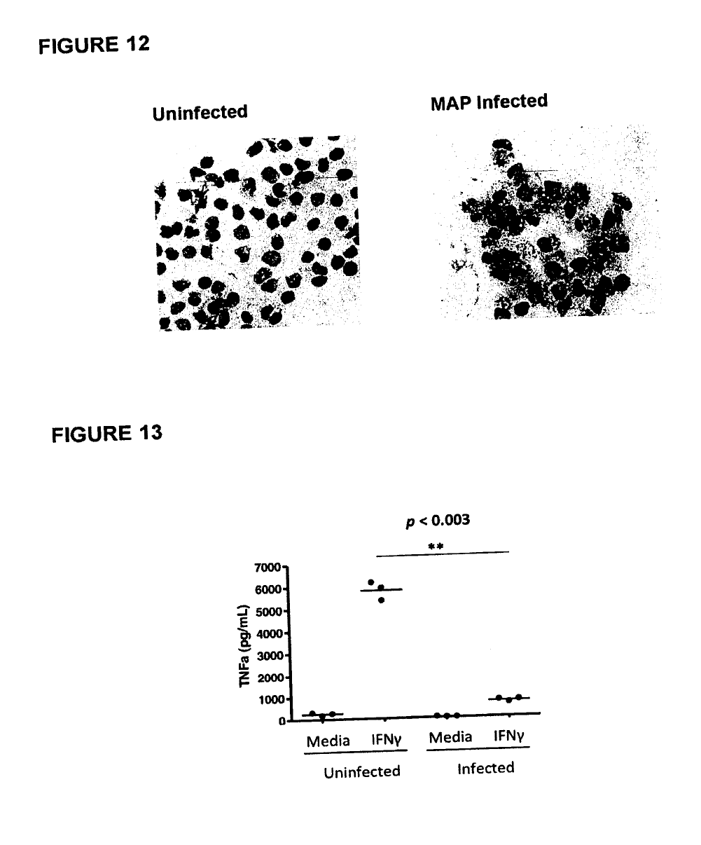

Cytospins were performed following in vitro infection of purified bovine monocytes to confirm and quantify the extent of MAP uptake [FIG. 12]. Over three replicate experiments there was an infection efficiency of 93%+/−4%. The in vitro infection of purified monocytes with MAP therefore provides a cell population of sufficient quantity and homogeneity, with respect to infection status, for kinome analysis.

IFNγ-Induced TNFα Release:

IFNγ responsiveness was evaluated to verify that monocytes infected with MAP in vitro exhibit the same subversion of host responses as reported for naturally infected cells. Release of tumor necrosis factor alpha (TNFα) is a well established and easily quantified marker of macrophage activation by IFNγ (36). For the uninfected monocytes treatment with 10 ng/mL of bovine IFNγ resulted in release of large quantities of TNF([FIG. 13]. In contrast, under identical stimulation conditions, there is minimal release of TNFα from MAP-infected monocytes. This confirms that monocytes infected with MAP in vitro share a similar phenotype of IFNγ unresponsiveness as reported in vivo.

Animal-Animal Variability:

In an outbred species, such as cattle, a degree of variability in biological responses is anticipated. To identify core, conserved biological processes the kinome data from the three animals was analyzed to determined animal-dependent and animal-independent responses. Under the same treatment condition, any peptides with p-value less than 0.01 were considered animal-dependent. By this criteria only 2 peptides appear to be animal-dependent in all three treatments relative to the controls. Two hundred and twelve peptides elicit similar responses across all three treatments regardless of the choice of animal. Eighty-six peptides are not conclusive in that p-values for those peptides are not consistently greater than or less than 0.01 across all three treatments relative to the control. Examining peptides within each treatment revealed 56, 7 and 56 peptides had significantly different reactions in the treatments of MAP infected monocytes treated with IFNγ, monocytes treated IFNγ and monocytes infected with MAP, respectively. Thus, it appears there is greater variance in how individual animals respond to MAP infection as compared to IFNγ stimulation of uninfected monocytes. This is consistent with the biological complexity of the stimuli.

Treatment-Treatment Variability:

To identify peptides with significant (p<0.20) changes in their phosphorylation status relative to the control in the various treatment conditions, the 212 peptides identified as consistently regulated across the three animals were subjected to the paired t-test. A listing of the differentially phosphorylated peptides at 0.05 significance level in treatments MAP, MAP+IFN, and IFN relative to their corresponding controls are included in Table 7 and 8.

Cluster Analysis:

The kinome data sets were subjected to cluster analysis for comparison and visualization of patterns of response of the different animals to the different treatments. To this end, principal component cluster analysis (PCA) was applied to the data sets with and without subtraction of the corresponding biological controls. The data was analyzed in this way to consider both the absolute kinome profile of each animal in each treatment condition (without subtraction of biological controls), as well as the dynamic response of each animal to each treatment (with subtraction of biological controls).

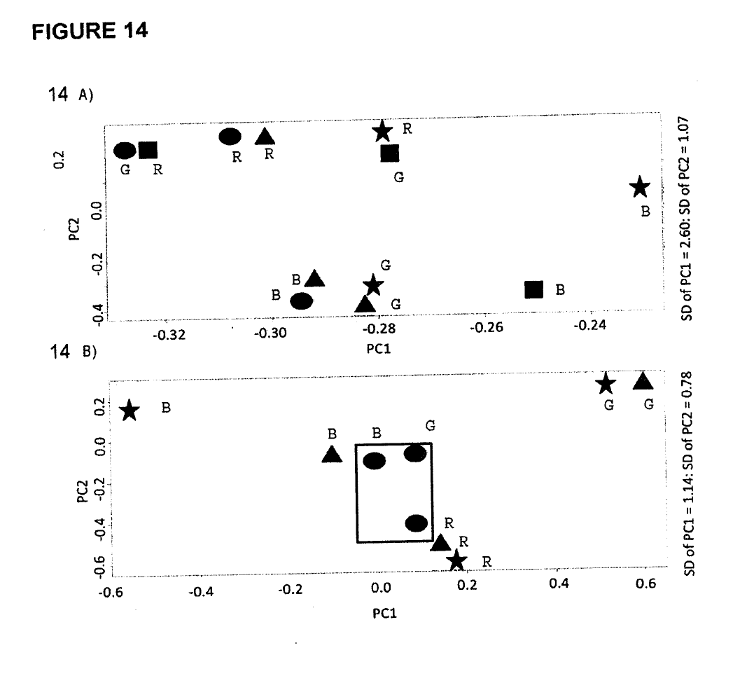

PCA clustering without subtracting the biological controls results in a seemingly random arrangement with respect to animals and treatment conditions [FIG. 14A]. This is not unanticipated as within an outbred bovine population different baselines of cellular activity due to genetic, developmental and/or environmental factors may impact baseline cellular kinase activity. These factors may also influence the dynamic responses of the animals to the stimuli, in particular responses to a complex and multi-faceted stimulus like bacterial infection.

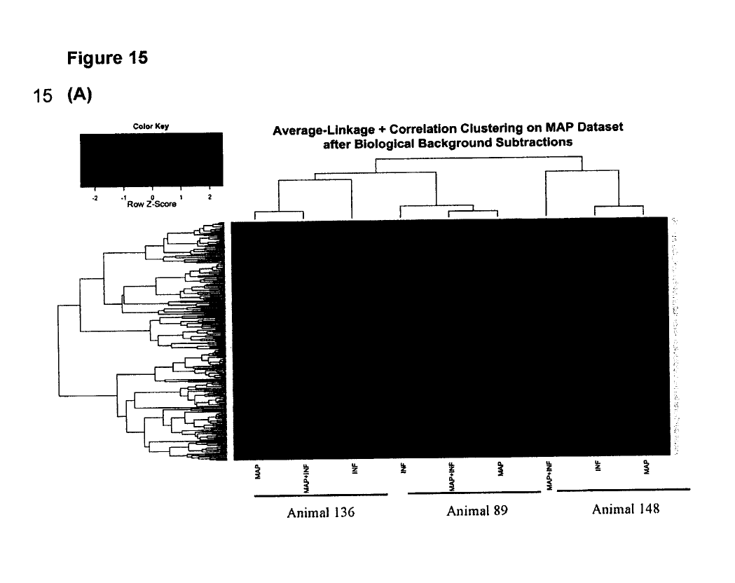

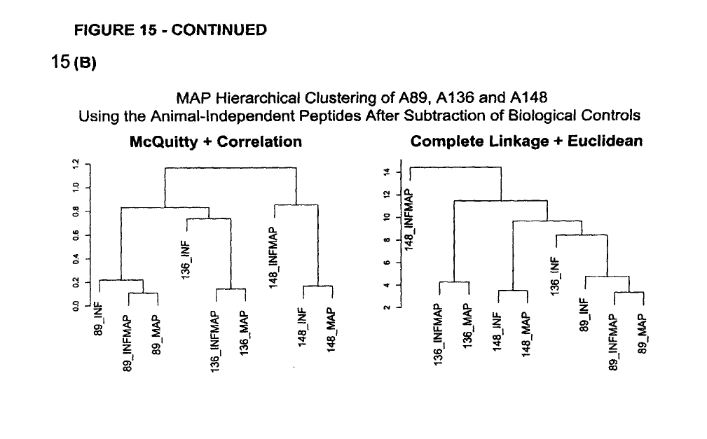

By subtracting the corresponding biological controls for each animal it is possible to determine the dynamic response of the monocytes of each animal to each treatment condition. Investigating the kinome data in this manner reveals a strong pattern of clustering based firstly upon animals, and subsequently upon treatment conditions. That consistent clustering on the basis of animal is discernible was surprising based on the previous results in data processing that 212 peptides of the 300 peptides were found to be animal-independent at 0.01 level of significance. Hierarchical clustering by “Average Linkage+(1−Pearson Correlation)” verifies the animal dependence [FIG. 15]. The results from the other hierarchical clustering methods. This animal dependence may reflect accumulative differences of the selected peptides, which together contributed to the notable variations among animals. Notably the kinome experiments for all the animals were performed simultaneously in a single run minimizing the possibility of technical variances in the analysis.

One possible reason for the strong clustering by animal was the stringent level of confidence used in the Animal-Animal Variability Analysis. Having a lower significance level (e.g. 5%) would mean that more peptides would be determined to have differing expression levels across animals and would be eliminated from further analysis. This may result in less prominent clustering by animal, but would result in fewer peptides being considered in the Pathway Analysis.

Within animals there is further clustering corresponding to conserved responses to the treatment conditions. For example, while the datasets for each of the three animals separate to different quadrants of the plot there is conserved clustering of the responses of uninfected monocytes to IFNγ stimulation to a distinct sub-cluster at the center of the plot. This indicates that in spite of animal specific variances in the baseline kinomic profiles, there is a conserved and consistent response to IFNγ across the biological replicates [FIG. 14B]. A similar pattern of clustering is observed for the datasets through the hierarchical clustering [FIGS. 15 A and B]. Through these approaches, following subtraction of the biological controls, there is a strong tendency for the datasets to first cluster on the basis of animal followed by secondary clustering based on the particular treatment condition. In particular, in two of the three animals, the responses of the MAP-infected monocytes to IFNγ stimulation cluster more closely to the responses of MAP-infected monocytes rather than the IFNγ stimulated monocytes [FIG. 15A]. This suggests MAP blocks the ability of the cells to undergo the same changes in signal transduction as observed in the uninfected cells and is consistent with the IFNγ unresponsiveness [FIG. 13].

Pathway Analysis:

The kinome data was subjected to pathway over-representation analysis to determine which cellular pathways/processes are activated under the different treatment conditions. To ensure the identified pathways represent conserved and consistent biological responses, input data was limited to peptides with a consistent pattern of differential phosphorylation across the three biological replicates (p>0.01) as well as significant (p<0.20) changes in phosphorylation level relative to the control treatment. This select data from the three animals was merged to generate a representative data set for each treatment condition and analyzed through InnateDb (www.InnateDb.ca) (46)

For uninfected monocytes stimulated with IFNγ a number of pathways were suggested to be activated with a high degree of confidence (p<0.05). Most notably, this included five pathways directly associated with activation and regulation of JAK-STAT [Table 5]. Specifically, there are 21 peptides on the array representing JAK STAT intermediates. Following IFNγ stimulation of uninfected monocytes 20 of these show significant (p<0.20) differential phosphorylation relative to the unstimulated monocytes; 18 with increased phosphorylation and two with decreased phosphorylation [Table 5]. JAK STAT is well defined for its role in mediating cellular responses to IFNγ (22, 23). The identification of this pathway in monocytes following IFNγ stimulation provides confidence in the ability of the arrays to detect and reflect biological responses. Specifically, there is a high degree of confidence (p<0.002) for activation of the JAK-STAT pathway following IFNγ treatment of the uninfected monocytes [Table 5]. In contrast, for the same treatment of the MAP-infected monocytes the confidence in activation of JAK-STAT is extremely low (p<0.96) and only 2 of the peptides representing JAK STAT signaling proteins show increased phosphorylation. Instead there is a relatively high degree of confidence (p<0.10) for down regulation of this pathway in the MAP infected cells.

In addition to JAK STAT a number of other pathways relating to cytokine/chemokine signaling as well as activation of the pro-inflammatory Toll-like receptor pathway is observed. Many of these pathways, in particular those associated with cytokine/chemokine signaling, share signaling intermediates with IFNγ induced responses as well as overlap of their biological function. Many of these responses would be anticipated as secondary events following IFNγ stimulation. That activation of these secondary pathways is not observed in MAP infected monocytes following IFNγ stimulation would suggest the pathogen blocks cellular responsiveness at, or near, the receptor rather than intermediate of final effectors which would provide opportunity for activation of secondary signaling responses. Dampening of these responses may also help to facilitate intracellular survival of the pathogen.

Phosphorylation Events within the JAK-STAT Pathway:

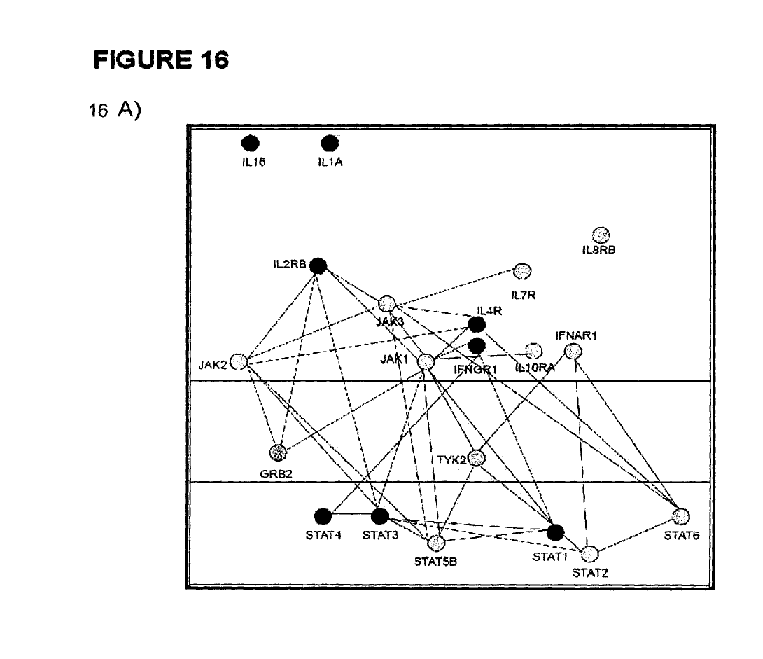

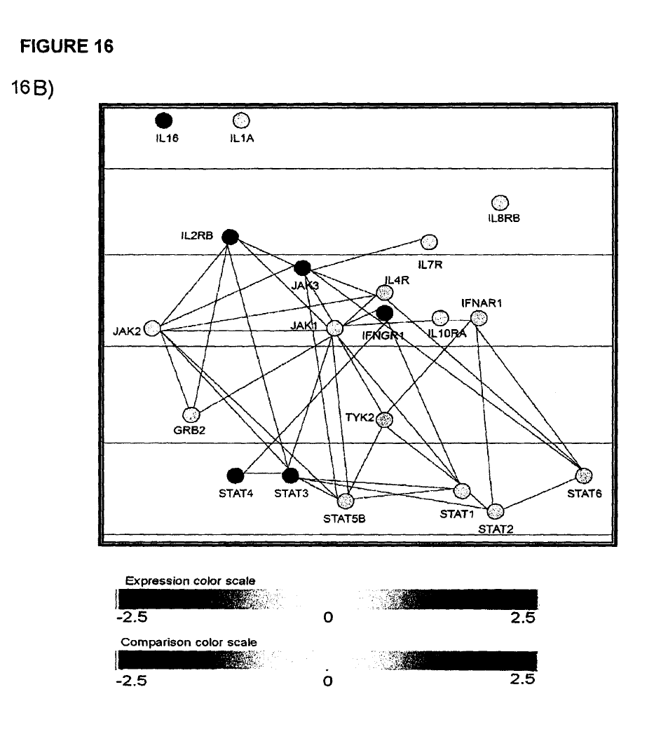

As JAK STAT signaling events are represented quite comprehensively on the array it is possible to investigate the specific level at which MAP blocks IFNγ responsiveness. IFNγ stimulation of the uninfected monocytes results in differential phosphorylation of numerous peptides corresponding to a variety of intermediates along the JAK STAT pathway [Table 6]. This includes phosphorylation events ranging from activation of IFNGR1 to differential phosphorylation of the final STAT effectors. The associated p values indicate the confidence of the fold change relative to the media treatment. In contrast, following IFNγ stimulation of the MAP infected monocytes, there is an absence of signaling activity through-out the JAK STAT pathway. This is observed as early as the IFNγ receptor suggesting MAP blocks signaling events at a very early point [Table 6]. A representation of the JAK STAT pathway highlights activation of JAK STAT by IFNγ in uninfected monocytes [FIG. 16A] while MAP infection blocks IFNγ responsiveness through-out the pathway beginning at the receptor [FIG. 16B].

Altered Expression of SOCS and IFNGR in MAP Infected Monocytes:

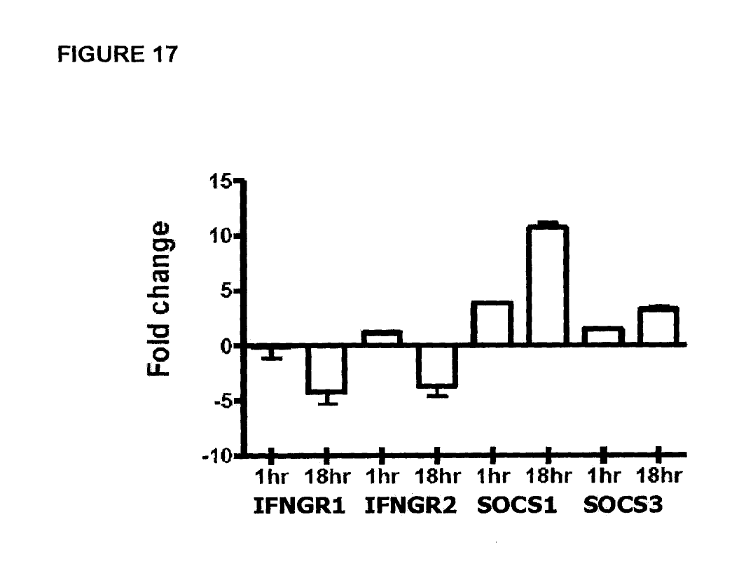

The absence of early JAK STAT signal transduction activity in the infected monocytes in response to IFNγ stimulation suggests MAP influences host responsiveness at, or near, the IFNγ receptor. This could result from decreased expression of the receptor or increased expression of an inhibitory factor which acts at the level of the receptor. Both mechanisms of inhibition have been observed for other mycobacteria. In bovine monocytes MAP infection causes a decrease in expression (˜4 fold) for each of these chains [FIG. 17]. Decreased expression of IFNγ receptor chains has been reported for a number of pathogens which block cellular responsiveness to IFNγ (27-29). Most notably, mycobacterium avium, a closely related pathogen to MAP, decreases expression of both chains of the IFNγ receptor analogous to the present observations. Furthermore, following MAP infection, expression of SOCS1 is increased (˜10 fold) while expression of SOC3 is upregulated (˜2 fold). Collectively the decreased expression of the IFNγ receptor with increased expression of the SOCS regulators is consistent with blocking the ability of the cells to respond to IFNγ stimulation.

Conclusions:

Diseases caused by a relatively small number of Mycobacterium species are responsible for billions of dollars in economic losses in all major terrestrial and aquatic animal production systems as well as tremendous direct impact on human health. For example, tuberculosis, resulting from infection by Mycobacterium tuberculosis, is estimated to infect a third of the world's population and is being reported with increasing prevalence in developed countries including the emergence of drug resistant strains. Within the cattle industry MAP is with ever increasing rates of infection and growing concern over food safety with indications that MAP may represent a zoonotic threat. The lack of effective strategies to treat and/or prevent these diseases relates in large part to the ability of these pathogens to subvert host immune responses and establish chronic infections within host immune cells. While different species of mycobacteria utilize different specific strategies to achieve this objective there is a common opinion that a better understanding of the pathogenic mechanism of these microbes is a first and essential step in the development of rationale therapeutic strategies.

Host responses to infectious challenge are often regulated through phosphorylation. Moreover, the pathogenic mechanism of many mycobacteria involves production of a number of bacterially-encoded, eukarytotic-like protein kinases and phosphatases play essential roles in virulence and establishment of chronic infections (47). These findings highlight the importance of understanding the host-pathogen interaction of MAP from the perspective of dynamic patterns of phosphorylation. Additionally, the success of kinase inhibitors in treatment of other diseases has made the mycobacterium kinases prime therapeutic targets (48). Until recently, however, the absence of the bovine-specific research tools made it very difficult to conduct kinome analysis for Johne's disease. A recent report on the development of species-specific peptide arrays for kinome analysis of non-traditional laboratory species offers the opportunity to obtain more specific insight into host signaling responses to MAP infection in a relevant cell type.

Pathway analysis of the kinome data indicated activation of the JAK-STAT pathway, a hallmark of IFNγ signaling, in uninfected, but not MAP-infected, monocytes. Specifically, the inability of IFNγ to induce differential phosphorylation of peptides corresponding to early JAK-STAT intermediates in infected monocytes indicates MAP rapidly, within 3 hours, blocks responsiveness at, or near, the IFNγ receptor. Consistent with this hypothesis, increased expression of negative regulators of the IFNγ receptor, SOCS1 and SOCS3, as well as decreased expression of IFNγ receptor chains 1 and 2 are observed in MAP infection. These patterns of expression are functionally consistent with the kinome data and offer a mechanistic explanation for this critical MAP behaviour. These mechanisms bear similarity to those reported for other pathogens in the targeted disruption of this critical host response. For example, the targeted down regulation of both chains of the IFNγ receptor is also observed for the closely related Mycobacterium avium (29) but distinct from that observed for Mycobacterium tuberculosis where inhibition of IFNγ signaling is independent of inhibition of STAT1 (49).

Collectively this investigation offers specific insight into the pathogenic mechanisms of MAP which may be of value in the rational design of vaccines and/or therapeutics. This also offers further insight into the various, and often redundant mechanisms used by viral and bacterial pathogens to block IFNγ responsiveness to achieve chronic infections.

### Example 3

With over 500 members catalyzing approximately 100,000 unique phosphorylation events, the eukaryotic protein kinases are the largest, and arguably most important, superfamily of enzymes. Functionally, kinases are at the core of signal transduction with central roles in virtually every cellular behavior including metabolism, transcription, cytoskeletal rearrangement, and immune defense. The central roles of kinases in regulating cellular processes and disease, as well as their conserved catalytic cleft, make them logical targets for drug therapy. Kinases are the most frequent target in cancer therapeutics, and second only to G protein-coupled receptors across all therapeutic areas [77]. For example, nearly half of the research and development budget of the pharmaceutical industry is currently targeted at kinases, largely focused on the development of inhibitors. In addition, there is growing appreciation that investigations of cellular responses at the level of phosphorylation-mediated signal transduction, the kinome, offer both detailed understanding of mechanisms of cellular responses and phenotypes.

The experimental approaches for analysis of cellular phosphorylation can be divided into kinome and phosphoproteome analysis based on whether the focus is the protein kinases mediating phosphorylation, the kinome, or the protein targets of the kinases, the phosphoproteome. These represent distinct experimental approaches, albeit to the same biological phenomenon. The most significant challenges to phosphoproteome analysis are the low abundance of phosphoproteins relative to the proteome and that many proteins are phosphorylated in sub-stoichiometric levels such that only a small fraction (˜1%) is modified at any given time [78]. Another limitation of phosphoproteome analysis is that it is often conducted with phosphorylation-specific antibodies, which are of limited availability. A promising alternative to phosphoproteome analysis is to focus on the kinome because the well-defined, highly-conserved chemistry of enzymatic phosphorylation permits rapid characterization of kinase activity, provided an appropriate substrate is available.

Proteins are the physiological substrates for most kinases. As the specificity of most kinases is dictated by residues surrounding the phosphorylation site, a logical alternative is to employ peptides representing these sequences as substrates. Peptides modeled on the site of phosphorylation can be excellent kinase substrates, with Vₘₐₓ and Kₘ values close to the natural substrate [79]. Peptides are easily produced, relatively inexpensive, chemically stable, and highly amenable to array technology. To date most peptide arrays created for kinome analysis have been based on phosphorylation events characterized from a particular species and utilized for analysis of that same species. However, as sites of phosphorylation and their subsequent biological consequences are often conserved, it was hypothesized that it would be possible to predict the sequence contexts of phosphorylation events in proteins of other species based on genomic information. In 2009 this bioinformatics approach was used to develop an array of 300 peptides corresponding to bovine phosphorylation events of biological interest and having high sequence conservation to their human counterparts [80].

Through adaptation of high-throughput microarray technologies originally developed for gene expression analysis, it is possible to explore kinase activity in a given species. However, kinome microarray experiments have several features distinct from typical gene expression experiments. First of all, the number of kinase targets or peptides with phosphorylation sites included on an array is smaller than the number of oligonucleotides or cDNAs embedded on a transcription array by about 2 orders of magnitude [80, 81]. Thus, it is not desirable to discard data-points because they are deemed “outliers” or because they have negative values which would cause problems with a typical log transformation. In addition, the peptides may be recognized by the correct protein kinase, but with lower efficiency than when the sequence is in the context of an intact protein [80]. Moreover, kinome activities may vary across individual subjects within the same species. Thus, the reduced but still existing problem of dimensionality (i.e., number of variables>>number of samples), and the distinct biological nature of the data may make unsuitable the approaches commonly practised in gene expression analysis [81-84]. This unsuitability is primarily centered around rigorously testing for the variability between the biological replicates, statistical stringency imposed on the differential analysis, and putting into the perspective of known signaling pathways the differential phosphorylation information obtained under a specific treatment relative to a control. A standard and commonly practiced approach in gene expression analysis appears to be directly exploited in some kinome studies [80, 82, 83, 85]. Briefly, after background correction, intensities in each kinome array are normalized to the 50th or 90th percentile of the data points from the same array. Any peptide with standard deviation larger than 1.96 times the mean of its replicate data points from the same array is deemed as an “outlier” and filtered out from further analyses. The average is taken over the replicate spots for each of the remaining peptides. The fold-change ratio for each peptide under a treatment is calculated relative to the control [80,85-87]. Fold-changes above or below a certain threshold are considered significant for the phosphorylated or dephosphorylated peptides, respectively. The limitation of this approach lies within the context of weakly expressed genes. For example, the significance of a ratio of 1.5 is higher in the context of high intensities than in a low intensity range. Furthermore, correction to background intensities may result in non-positive values, for which the fold-change is non-applicable or the ratios are meaningless. Consequently, these latter data points are either set to an arbitrary value or removed from further analysis. Neither of the two strategies seems to be an optimal choice because both discard potentially useful data [88].

Linear Models for Microarray Data (limma), one of the most popular Bioconductor packages in R (www.bioconductor.org/), provides normalization for cDNA microarray data and analysis of differential expression for multi-factor design experiments [89]. The differential analysis component of the limma package uses an empirical Bayes (eBayes) model that estimates the standard errors for each gene by borrowing information across genes and calculating the moderated t-statistic accordingly. Applications of limma for kinome analyses are emerging. In the study of chondrosarcoma by Schrage et al. [90], limma is applied following quantile normalization to the kinome datasets consisting of 1,024 different kinase substrates in triplicate with 16 negative and 16 positive controls. The resulting moderated t-statistics appear to underestimate the true significance of the kinome data, and very few phosphorylated substrates have adjusted p-values less than 0.05, a commonly accepted significance level. This reflects the need to treat kinome data differently than transcription profiles [84]. In particular, a less stringent statistical inference method may be desired.

A pipeline for kinome analysis tackling the aforementioned challenges is provided herein. A set of statistical procedures has been chosen to address the variability issues existing among technical and biological replicates. The aim is to identify truly differentially-phosphorylated peptides specific to a treatment under investigation while eliminating misleading factors that interfere with the interpretation of results. Visualization of p-values is also utilized. The identifiers of the differentially (de)phosphorylated peptides can be used to probe for known signaling pathways from reliable resources such as InnateDB (www.innatedb.ca) [91] or Kyoto Encyclopedia of Genes and Genomes (KEGG) (www.genome.jp/kegg) [92-94]. The results may elucidate the pathways specifically induced by the treatment under study, thus providing insight into the mechanisms that particular cell lines employ in response to the stimuli. Furthermore, by determining GO-term enrichment within groups of differentially phosphorylated peptides, potential new pathways can be identified. Finally, clustering analyses such as hierarchical clustering and principal component analysis (PCA) have been incorporated into the workflow for comparative visualization of kinome patterns from the cells under various treatments. PCA, in particular, is capable of reducing the number of variables down to only the two or three most important ones (i.e., the principal components) that account for most of the variability in the datasets. The data points corresponding to the samples can then be plotted using the derived components to examine their clustering pattern. Software in the pipeline has been implemented primarily in the language R [95], facilitated by some Perl and Bash scripts.

To demonstrate the viability of the approach, the pipeline was applied to phosphorylation datasets associated with exposure of bovine monocytes to interferon gamma (IFNγ), microbial DNA (CpG), and lipopolysaccharide (LPS). IFNγ is responsible for the activation of macrophages for clearance of intracellular pathogens [96, 97]. Signal transduction by IFNγ is known to be associated with a specific Janus family kinase-signal transducer and activator of transcription (JAK-STAT) signaling cascade [98, 99]. The microbe-associated ligand CpG is known to activate the pathways involving toll-like receptors (TLR). Toll-like receptors (TLRs) are pathogen recognition receptors that alert the host to the presence of microbial challenge [86]. Finally, it is well known that LPS treatment of immune cells induces an increase in Interleukin-2 (IL-2) receptor expression [100, 101], so an induction of IL-2 related signaling should be observed. To establish the value of the proposed approach, the results were compared to those from three alternate methodologies applied to the same input data. The comparison methodologies are previously described techniques for analysis of microarray data, two of which have been applied to peptide microarrays. All the methods were compared based on their abilities to reflect the known biology with statistical confidence.

### Methods

### Isolation of Bovine Blood Monocytes

Blood was collected from five cattle (nine month old charolais-cross steers) by venupuncture using tubes containing EDTA as an anti-coagulant. Blood was transferred to 50-mL polypropylene tubes and centrifuged at 1400×g for 20 min at 20° C. White blood cells were isolated from the buffy coat and mixed with PBSA (Ca²⁺ and Mg²⁺-free PBS) to a final volume of 35 mL. The cell suspension was layered onto 15 mL of 54% isotonic PERCOLL (Amersham Biosciences, GH healthcare) and centrifuged at 2000×g for 20 min at 20° C. Peripheral blood mononuclear cells (PBMC) from the PERCOLL-PBSA interface were collected and washed three times with cold PBSA. Monocytes were purified from isolated PBMCs by MACS purification using CD14+ microbeads (Miltenyi Biotec Inc., Auburn, Calif.). Monocytes (>95% pure) were plated at 5×10⁶ cells/well in 6-well plates in RPMI 1640 medium (GIBCO) supplemented with 10% fetal bovine serum (GIBCO). Cells were rested overnight at 37° C. prior to stimulation with 100 ng/mL recombinant bovine IFNγ, 25 μg/mL CpG ODN 2007 or 100 ng/mL LPS.

### Kinome Array Experiment and Data Collection

Cell pellets were lysed with 80 μL lysis buffer (20 mM Tris-HCL pH 7.5, 150 mM NaCl, 1 mM EDTA, 1 mM ethylene glycol tetraacetic acid (EGTA), 1% Triton, 2.5 mM sodium pyrophosphate, 1 mM Na3VO4, 1 mM NaF, 1 μg/mL leupeptin, 1 g/mL aprotinin, 1 mM phenylmethylsulphonylfluoride (PMSF)), incubated on ice for 10 minutes and then spun in a microcentrifuge at maximum speed for 10 minutes at 4° C. An 80 μL aliquot of this supernatant was mixed with 10 μL of the activation mix (50% Glycerol, 500 μM ATP, 60 mM MgCl2, 0.05% v/v Brij-35 and 0.25 mg/mL BSA) and incubated on the chip for two hours at 37° C. in a humidity chamber. Following incubation, slides were washed once in PBS-Triton then submerged in stain (PRO-Q® Diamond Phosphoprotein Stain, Invitrogen) with agitation for one hour. Arrays were then washed in tubes containing destain (20% acetonitrile (EMD Biosciences, VWR distributor, Mississauga, ON) and 50 mM sodium acetate (Sigma) at pH 4.0) for 10 minutes three times with the addition of new destain each time. A final wash was done with distilled water. Arrays were dryed and read using a GENEPIX® professional 4200A microarray scanner (MDS Analytical Technologies, Toronto, ON) at 532-560 nm with a 580 nm filter to detect dye fluorescence. Images were collected and signal collected using the GENEPIX 6.0 software (MDS).

### Overview of Data Analysis

The proposed workflow is outlined in FIG. 1 and presented in the following analytical steps. The three comparison methodologies are described in a later subsection. As an overview, these methods are percentile normalization+fold-change [80, 85-87], quantile normalization+limma [90], and variance stabilization normalization (VSN)+limma [81]. All methods were applied to the same datasets. Evaluation criteria are described in the last subsection. All the calculations below can be performed in R unless noted otherwise [95]. Specific R packages are mentioned wherever used.

### Data Preprocessing

A first step in the proposed methodology is data preprocessing. In all datasets, the specific responses of each peptide are calculated by subtracting local background intensity from foreground intensity. The resulting data is transformed using a variance stabilization (VSN) model [88]. The transformation calibrates all the data to a positive scale while maintaining the structure within the data and alleviating variance-mean-dependence. The latter problem occurs when the variances of signal intensities for individual peptides are not constant, but increase with increased mean intensity. In addition, the data across various experiments are brought to the same scale by VSN to enable comparisons of arrays between experiments, cell types, or treatments. To facilitate subsequent analysis, the dataset is rearranged to have each row contain all the replicates of a unique peptide. The R package vsn can be used for the VSN transformation [102]. Only for the subsequent clustering analysis is the average for each of the peptides in a single treatment taken over the transformed replicate intensities.

### Spot-Spot Variability Analysis

A chi-squared (χ²) test is used to examine the variability for each peptide among the spots across technical replicates, that is replicates on the same chip or multiple chips for the same subject under the same treatment [103]. Peptides with statistically significant variability are eliminated from clustering analysis.

For each peptide, the null hypothesis H₀ claims that there is no difference among intensities from the replicate spots, and alternative hypothesis HA states that there exists significant variation among the replicates. The χ² test statistic (TS₁) is:

$${TS}_{1} = \frac{( n - 1 ) {s}^{2}}{{σ}^{2}}$$

where n is the number of replicates for each peptide in the treatment,

s²=1/nΣᵢ₌₁ⁿ(yᵢ− y̅)²

is the sample variance of the replicates for each peptide in a treatment,

\hat{σ}²=1/MΣⱼ₌₁^{M}sⱼ²

is the mean of all the variances for the replicates of the M peptides in the treatment (i.e., total number of distinct peptides included in an array), and

p-value=P[TS₁>χ²(n−1)]

The peptides with p-values less than a threshold are considered inconsistently phosphorylated across the array replicates and are eliminated from the subsequent clustering analysis. A strict confidence level (i.e. 0.01) is used so that as much data as possible is retained. The p-value is calculated using the R function pchisq from the stats package.

If applicable, the remaining intensities induced by the treatments are adjusted by subtracting the intensities of the biological control of the same subject.

### Subject-Subject Variability Analysis

This step is done after the biological control subtractions (if applicable) and only applied to datasets where there is a concern of animal variation. For each of the peptides, an F-test is used to determine whether there are significant differences among the subjects under the same treatment condition [104]. Data for peptides which are determined to be inconsistently phosphorylated are eliminated from subsequent analysis.

Formally, let a be the number of subjects, n the number of intra-array replicates, N the total number of replicates for each peptide for each treatment, μᵢ the mean response of each peptide in the i^{th} subject for each treatment. The null hypothesis H₀ claims that μ₁=μ₂= . . . =μₐ, or the mean phosphorylation intensities elicited by the identical peptide among the subjects are the same, and alternative hypothesis H_{A} states that not all subject means are equal. The F-statistic (TS₂) is calculated as:

$${TS}_{2} = \frac{{MS}_{B}}{{MS}_{W}}$$

$$where$$

$${MS}_{B} = \frac{{SS}_{B}}{{df}_{B}} = \frac{{\sum }_{i = 1}^{a} {( {\overline{y}}_{i} - \overline{y} )}^{2}}{a - 1}$$

$$( Mean Squared Between Subjects )$$

$${MS}_{W} = \frac{{SS}_{W}}{{df}_{W}} = \frac{{\sum }_{i = 1}^{a} {\sum }_{m = 1}^{n} {( {y}_{im} - {\overline{y}}_{i} )}^{2}}{N - a}$$

$$( Mean Squared Within Subjects )$$

Above y̅ᵢ≡\hat{μ}ᵢ is the sample mean for the i^{th} subject, y̅≡\hat{μ} the grand mean of all the subjects, and the individual response of the m^{th} replicate in the i^{th} subject. Finally,

p-value=P[TS₂>F(a−1,N−a)]

Under the same treatment condition, the peptides with p-value less than a threshold are considered inconsistently phosphorylated among the subjects and are eliminated from subsequent analysis. A strict confidence level (i.e. 0.01) is used so that as much data as possible are retained.

### Treatment-Treatment Variability Analysis

All peptides identified as having consistent patterns of response to various treatments across the subjects are the objects of one-sided paired t-tests to compare their signal intensities under a treatment condition with those under control conditions [104]. The goal is to identify those peptides for which the signal intensities are truly different under alternate treatments; i.e. those peptides which are differentially phosphorylated.

Formally, the t-test statistic (TS₃) is calculated as:

$${TS}_{3} = \frac{\overline{D}}{{S}_{D} / \sqrt{n}}$$

where D̅ is the mean of the differences between responses for the same peptides induced by two different treatments, S_{D} the standard deviation of the differences, and n the number of replicate differences for that peptide between each treatment and control. Finally,

p-value=P[TS₃>t(n−1)](phosphorylation)

p-value=P[TS₃<−t(n−1)](dephosphorylation)

Thus each peptide has two p-values, one associated with the peptide being differentially phosphorylated and the other with being dephosphorylated. The peptides with p-values less than a threshold (i.e. 0.1) are considered as differentially (de)phosphorylated and are used for the subsequent analyses. To retain as much data as possible no adjustment (as for multiple hypothesis testing) is made to the p-value. The paired t-test is performed using the R built-in function t.test from the stats package with paired=True.

The paired t-test is used here because it takes into account the interdependence between the same peptides under treatment and control conditions. Also note that the t-test is able to account for the variability (in terms of S_{D}) among the replicates so that replicates with significant p-values from the χ²-tests will automatically have insignificant p-values from the t-test. However, this does not apply to datasets with multiple subjects, because significant variation for the same peptide among the subjects under the same treatment condition might be biologically meaningful, and it may confound the analysis if these peptides are treated as if they came from the same source.

### Visualization

The results from the treatment-treatment variability analysis are recorded in tables and also presented in pseudo-images (FIGS. 22 and 23). The latter can be generated based on the p-values from the one-sided t-tests for phosphorylation or dephosphorylation of each peptide. Each peptide is represented by one small colored circle. The depths of the coloration in red and green are inversely related to the corresponding p-values. For example, if the p-value for phosphorylation is 0.001, then the redness in percentage will be 100%×(1−0.001)=99.9%. The same rationale is applied to dephosphorylated peptides and degree of greenness. Thus, the combined color depths of red and green represent the phosphorylation status of each peptide in the microarray. In addition, each circle in the plot is partitioned into sectors, each of which represents a different treatment. Moreover, the circles are arranged in such a way that, going downwards by column and from left to right, the consistently phosphorylated peptides across treatments are presented first followed by the inconsistent ones. Within the consistently phosphorylated peptides, the ones with the most significant p-values for phosphorylation/dephosphorylation on average over the treatments being compared are presented first followed by less significant ones. Similarly, the inconsistent ones with the largest differences between the p-values from the treatments are presented first followed by the ones with smaller differences. The original numbering for a peptide (i.e., the label below each circle) from the physical array layout is unchanged for indexing detailed information of the peptide. The plots are generated using R functions plot (for plotting the circles in different coordinates), rgb (for coloration), and polygon (for drawing sectors to represent treatments). This visualization of the results from differential analysis facilitates the identification of conspicuous intensities of peptides, or patterns of intensities, across treatments.

### Gene Ontology Enrichment Analysis

To find previously unidentified pathways, the methodology incorporates a step that looks for statistically significant GO term enrichment among the differentially phosphorylated peptides. A complete list of the GO terms for all the differentially phosphorylated peptides is generated from the GOTermFinder on-line server (go.princeton.edu/cgi-bin/GOTermFinder) based on their UniProt accession numbers. These GO terms are then analyzed for commonalities among groups which are unlikely to have occurred at random. While this step is part of the overall methodology, it was not utilized in this analysis since the goal was to evaluate the new method's ability to find known pathways rather than identify previously unknown ones.

Probing Signaling Transduction Pathways from a Database

The UniProt or GeneSymbol identifier of differentially phosphorylated peptides detected in each treatment by the differential analysis step (refer to the Treatment-Treatment Variability Analysis subsection) can be used to probe databases such as InnateDB (www.innatedb.com) to discover known signaling pathways that are specifically induced by the treatment under investigation [86,91,91-94]. Because InnateDB requires fold-change (FC) values as input (with p-values optional), the differences between the VSN transformed intensities under control and treatment are converted first to ratios and then to fold-change values using antilogarithm and the R function ratio2foldchange, respectively. The synthetic fold-change value and one of p-values from the one-sided t-test for each of the 300 peptides (less those removed during the subject-subject variability analysis) are input to InnateDB. If a peptide has a positive calculated fold-change value, then the p-value associated with phosphorylation is chosen. Otherwise, if the calculated fold-change value is negative, the p-value associated with dephosphorylation is chosen.

Other inputs to InnateDB are a p-value threshold and a fold-change threshold. These thresholds specify the confidence in the data set and resulting pathways. InnateDB eliminates from analysis all peptides with p-value greater than the former threshold, or a fold-change value less in absolute value than the latter threshold. For the datasets used in this analysis the p-value threshold was set to 0.1 and the FC threshold to 1. The latter threshold is non-selective since the synthetic fold-change values will all be equal or greater than 1, or equal or less than −1. This non-selectivity was a deliberate choice. Since the p-value is a calculation of how significant the difference is between treatment and control, it is the preferred basis for determining whether a peptide should be included rather than relying on FC.

The calculated fold-change values and p-values from the treatment-treatment variability analysis were input to InnateDB for each of the three cases of bovine monocytes treated with IFN, LPS, and CpG. The resultant p-values as calculated by InnateDB for the over-represented JAK-STAT, IL2, and TLR pathways were recorded. These pathways are known to be activated by IFN, LPS, and CpG, respectively.

For the comparison methodologies, pathway identification was again preformed using InnateDB. All peptides except those determined to have inconsistent intensities were considered. Thresholds were the same as for the new method (p-value of 0.1 and FC of 1) described hereherein. For QNorm+limma and VSN+limma methods identifiers of the peptides along with p-values and synthetic fold-change values were again input. The log ratios provided by limma were converted to fold-change values using the R function ratio2foldchange. For PNORM+FC only peptide identifiers and fold-change values were input as no p-values are available from this method.

Pathways identified by InnateDB for each methodology and each dataset were then visualized using the Cerebral plugin [105] for the interaction viewer Cytoscape [106].

### Clustering Analysis

Peptides with consistent intensities in technical replicates and biological replicates are determined in the previous spot-spot and subject-subject variability analyses. For each such peptide, an average intensity is taken over the technical replicates. The averaged data with or without biological control subtractions is subjected to hierarchical clustering and principal component analysis (PCA) to cluster peptide response pro les across treatments or subject-treatment combinations. The dendograms from the hierarchical clustering are augmented by heatmaps showing the averaged (de)phosphorylation intensities. The goal is to make visually evident patterns in kinome data from cells under various treatments.

For hierarchical clustering, three popular independent combinations of clustering method and distance measurement are implemented, namely “Average Linkage+(1−Pearson Correlation)”, “Complete Linkage+Euclidean Distance”, and “McQuitty+(1−Pearson Correlation)” [107-110]. In general, each subject/treatment vector is considered as a singleton (i.e., a cluster with a single element) at the initial stage of the clustering. The two most similar clusters are merged and the distances between the newly merged clusters and the remaining clusters are updated, iteratively. The calculations of similarity/distance between the clusters and the update step are algorithm specific. The “Average Linkage+(1−Pearson Correlation)” is the method used by Eisen et al. [111]. It takes the average over the merged (i.e., the most correlated) kinome profiles and updates the distances between the merged clusters and other clusters by recalculating the correlations between them. In “Complete Linkage+Euclidean Distance”, the distance between any two clusters is considered as the Euclidean distance between the two farthest data points in the two clusters [109, 110]. Finally, the McQuitty method updates the distance between the two clusters in such a way that upon merging clusters C_{X} and C_{Y} into a new cluster C_{XY}, the distance between C_{XY} and each of the remaining clusters, say C_{R}, is calculated taking into account the sizes of C_{X} and C_{Y [}108].

PCA is a variable reduction procedure. Basically, the calculation is a singular value decomposition of the centered and scaled data matrix [112]. As a result, PCA transforms a number of possibly correlated variables into a smaller number of uncorrelated or orthogonal variables (i.e., principal components). The first principal component accounts for the most variability in the data, and each succeeding component accounts for as much of the remaining variability as possible. Usually, the first three components account for more than 50% of the variability in the data, and can be used as a set of the most important coordinates in a 3D plot to reveal the structure of the data.

The R functions heatmap.2 from the gplots package and prcomp from stats are used for hierarchical clusterings and PCA, respectively. The 3D plot for the PCA using the first three principal components is produced by the R function scatterplot3d from package scatterplot3d.

### Comparison Methodologies

Much of the kinome analysis published to date adopts methodologies from nucleotide (gene expression) microarray data analysis. To compare the present pipeline, 3 previously published workflows for microarray analyses were implemented in R and applied to the same datasets. Those are percentile normalization (PNorm)+fold-change (FC) [80,85-87], quantile normalization (QNorm)+limma [90], and VSN+limma [81]. All three methods operate on background-corrected data. The PNorm procedure was implemented in R based on the algorithm reviewed by Fundel et al. [83]. The 90th percentile was used as in the kinome analysis by Lowenberg et al. [85]. Briefly, after background correction, intensities in each array were divided by the 90th percentile of the data points from the same array in order to achieve a uniform intensity at the 90th percentile across all the arrays. The QNorm and VSN steps were carried out using the limma function NormalizeBetweenArrays by setting the parameter method to quantile and vsn, respectively [113]. Note that the NormalizeBetweenArrays provides the VSN method. After VSN, however, it further scales the transformed data by taking the logarithm to base 2 (log₂), which is not carried out in the present pipeline.

In the PNorm+FC approach, data with standard deviation (SD) larger than 1.96 (approximated as 2×SD) of the mean from the same array were deemed inconsistent and excluded from subsequent analysis [85, 87]. In QNorm+limma and VSN+limma, a function called duplicateCorrelation in the limma package was used to estimate the correlation between the duplicates within an array [114]. The resulting correlations for each peptide were used as a weighting factor for the subsequent differential analysis. Finally, an F-test provided by the limma package was used to compare the log₂ fold-changes (logFC) of each peptide across biological replicates. The use of duplicateCorrelation and F-test are not mentioned in the two corresponding publications [81,90], but both seem to be reasonable steps and should only put the comparison methodologies in a stronger position.

In the differential analysis, the PNorm+FC approach identifies differentially phosphorylated peptides by comparing their combined FC to an arbitrary threshold, td. The peptides with FC larger than +td are determined as significantly phosphorylated, and those with FC less than −td are deemed to be significantly dephosphorylated. The two other comparison methods involving limma use the function eBayes [90] to determine the p-values associated with the moderated t-statistics. A peptide is determined as differentially phosphorylated if its p-value is less than 0.1.

Novel visualizations of differential phosphorylation patterns and determination of GO term enrichment were not presented in the papers describing the comparison methodologies and none was added as part of this work. However, hierarchical clustering and PCA are established techniques that are easily applied to the normalized and filtered intensities from the comparison methodologies.

### Comparison Criterion

The p-values for the over-represented JAK-STAT, IL2, and TLR pathways from InnateDB were used as the central criterion for the comparisons between the present proposed pipeline and the three published methods described above. Due to fairly small total number (i.e. 300) of different kinase substrates included in the present datasets, a reasonably lenient thresholds for the p-value and FC for filtering differentially phosphorylated peptides were chosen to be 0.1 and 1, respectively, in order to increase the chance to discover meaningful pathways in each of the four methods.

### Results

### Datasets

Datasets were compiled for three different experiments conducted at different times. The kinome microarray had the same design in all three experiments. As 300 peptides are spotted on the array and there are three intra-array replicates, 900 signal intensities were obtained from ArrayVision for each experimental run. In the first experiment, monocytes from three outbred cattle labelled “89”, “136”, and “149”, were treated with IFNγ or Media control (denoted as “IFN” and “MonoIFN”, respectively, in the subsequent discussion). The second and third experiments examined the kinomic responses of monocytes induced by CpG and LPS relative to separate media controls, respectively. The media controls are denoted as “MonoCpG” and “MonoLPS”, respectively. Only one treatment replicate was obtained for each of these experiments, with different animals being used than for the IFN experiment.

### Data Preprocessing

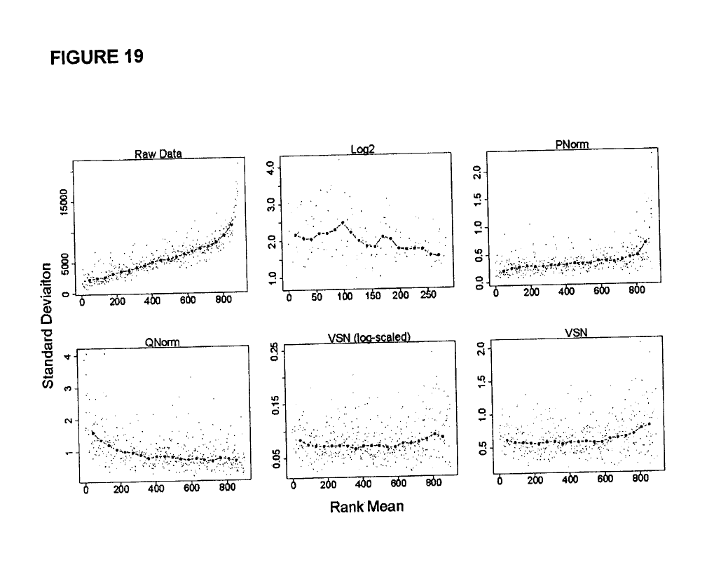

The raw data exhibit noticeable mean-variance-dependence for signals elicited by the 900 peptides. This can be observed in a graph where ranks of the 900 means of the peptide signals are plotted against the corresponding standard deviations (SD) (top left panel of FIG. 19). The dependence is diagnosed as an increasing (rising to the right) curve. The systematic trend largely diminishes after normalization by any of the four techniques, plus a fifth technique of log₂ alone, which is made possible after eliminating negative values resulting from background correction. Among these methods, the VSN transformations yield the best results, as indicated by almost horizontal lines (bottom middle and bottom right panels of FIG. 19). However, the log₂-scaled VSN appears to achieve the best result of the two.

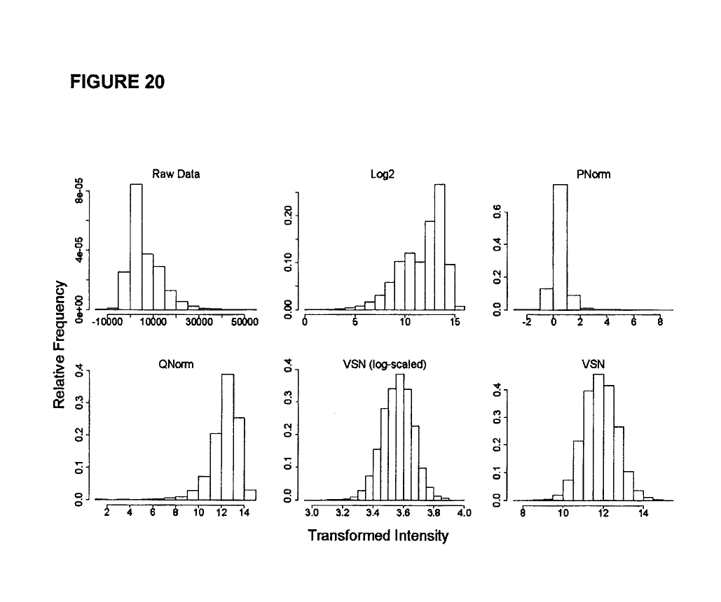

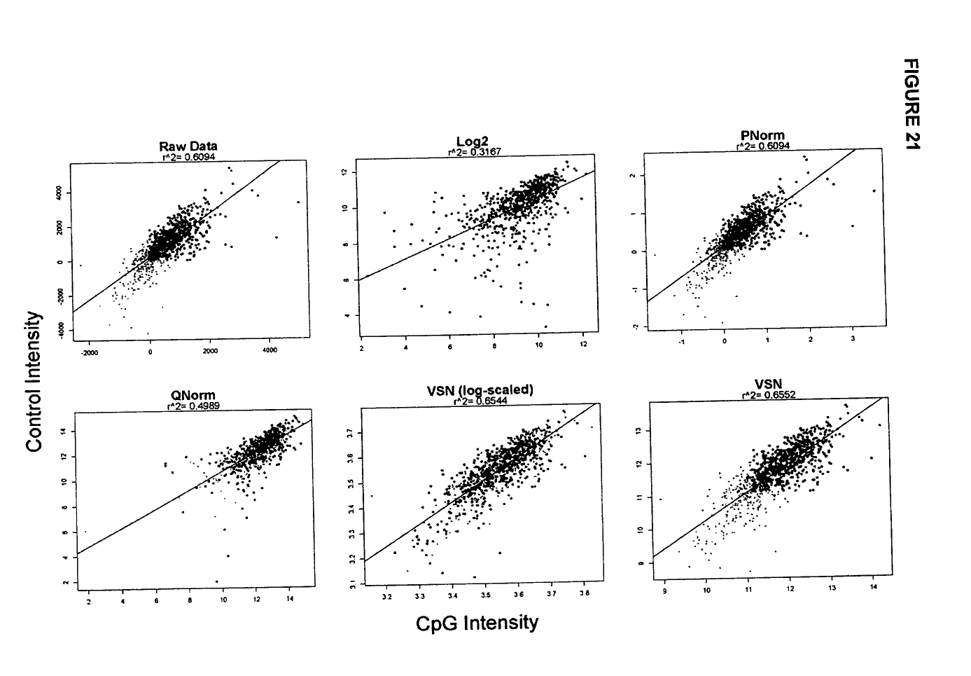

The data matrix from each normalization method can be collapsed into a single vector, whose frequency distribution is examined in FIG. 20. Only the transformed data from log₂-scaled VSN or standalone VSN approach a normal distribution. Distributions derived from other techniques appear skewed. However, as exemplified by scatterplots of the signal intensities for CpG vs. its own media control (FIG. 21), patterns within the responses of the same peptides under any two different treatments in the raw data are better preserved by PNorm and VSN without log-scaling. The patterns are poorly preserved by the log₂-based VSN and the remaining methods (FIG. 21). Overall then, standalone VSN—the transformation used in the methodology disclosed here—appears to be the method of choice as a preprocessing step.

### Spot-Spot Variability Analysis

In general, fewer than 19 but more than 3 peptides were inconsistently phosphorylated on a chip (i.e., p-value <0.01 based on the χ²-test statistic TS/in each replicate). As discussed earlier, these peptides will be automatically eliminated from consideration in subsequent steps. In contrast, the comparison method PNorm+FC produces a larger range of inconsistent peptides (from 2 to 28). These inconsistent peptides were manually eliminated from subsequent differential analysis. Although no explicit test for consistency of spot intensities across multiple chips was performed in QNorm+limma and VSN+limma, the correlations of the technical replicates calculated by duplicateCorrelation had subsequent effects on the p-values determined in the corresponding differential analyses.

### Subject-Subject Variability Analysis

In an outbred species, such as cattle, a degree of individual-to-individual variability in biological responses is observed [115, 116]. To identify conserved biological processes, an F-test was applied to the IFN datasets from the three bovine animals to determine animal-dependent and animal-independent responses. This test was performed after biological subtractions (i.e., considering only the IFN intensities after subtracting the corresponding MonoIFN control signals). Under the same treatment condition, any peptides having a p-value less than 0.01 was considered animal-dependent. By this criterion, four peptides out of 300 (just over 1%) appear to be animal-dependent in treatment IFN relative to the control MonoIFN, and were eliminated from the subsequent differential analysis on IFN. As a comparison, the F-test from limma identified only two animal-dependent peptides (with no overlap with the previous set of four peptides). The proportion from either test seems very low. However, it is a result of the very stringent p-value.

Since there were no biological replicates in the experiments for CpG and LPS, subject-subject variability analysis was not applied to those datasets.

### Treatment-Treatment Variability Analysis

Table 9 lists for all methods except PNorm+FC the total numbers of differential peptides and numbers of significantly phosphorylated and dephosphorylated peptides at 90% statistical con dence. Because PNorm+FC does not calculate a statistical significance for the peptides deemed to be differentially phosphorylated, it is not included in the comparisons. Due to the experimental design described here, a considerable number of substrates are expected to exhibit significantly different phosphorylation levels relative to the controls. However, both QNorm+limma and VSN+limma seem to be over-stringent and identify only a few kinase targets. This is especially the case for VSN+limma. In contrast, the method described here (VSN+paired t-test) identifies a much larger set of differentially phosphorylated peptides under each treatment. Note that despite the use of the same data transformation method, the additional logarithmic transformation in the VSN+limma method leads to a significantly different outcome for each treatment.

### Visualization

In the Methodology section earlier, a novel visualization scheme was proposed for comparative analysis of kinome patterns induced by all 3 ligands (i.e., IFN, CpG and LPS). The pseudo-image (FIG. 22) with labels indicating the actual microarray layout depicts the significance level of the phosphorylation status of each peptide elicited from bovine monocytes treated by IFN, CpG and LPS relative to the corresponding controls (the upper, bottom left, and bottom right sectors in each circle in FIG. 22, respectively). The animal-dependent peptides under IFN treatment identified from the F-test in Subject-Subject Variability Analysis are indicated by a grey color in the corresponding upper sectors in the circles at the bottom right corner of the plot. Significant phosphorylation and dephosphorylation are presented in colors red and green, respectively. The color depths are inversely proportional to the corresponding p-values from the one-sided paired t-test. Facilitated by the plot, it is evident that 96 peptides have common differential phosphorylation status across the three treatments (circles from 85 on the top to 160 at the bottom). Fifty-seven peptides appear to have the similar phosphorylation under treatment CpG and LPS but not IFN (circles from 3 on the top to 294). These commonly active peptides may be involved in shared signaling pathways specifically induced by the two similar ligands, CpG and LPS. A higher degree of conservation between CpG and LPS, rather than with IFNγ, induced signaling is anticipated. LPS and CPG are both ligands for the TLR system and it has been demonstrated that initiation of overlapping cellular responses at the levels of phosphorylation-mediated signaling as well as gene expression following activation of immune cells with these ligands [84, 117]. The similarities and differences of phosphorylation results for CpG and LPS are more evident in FIG. 23.

Probing Signaling Transduction Pathways from InnateDB

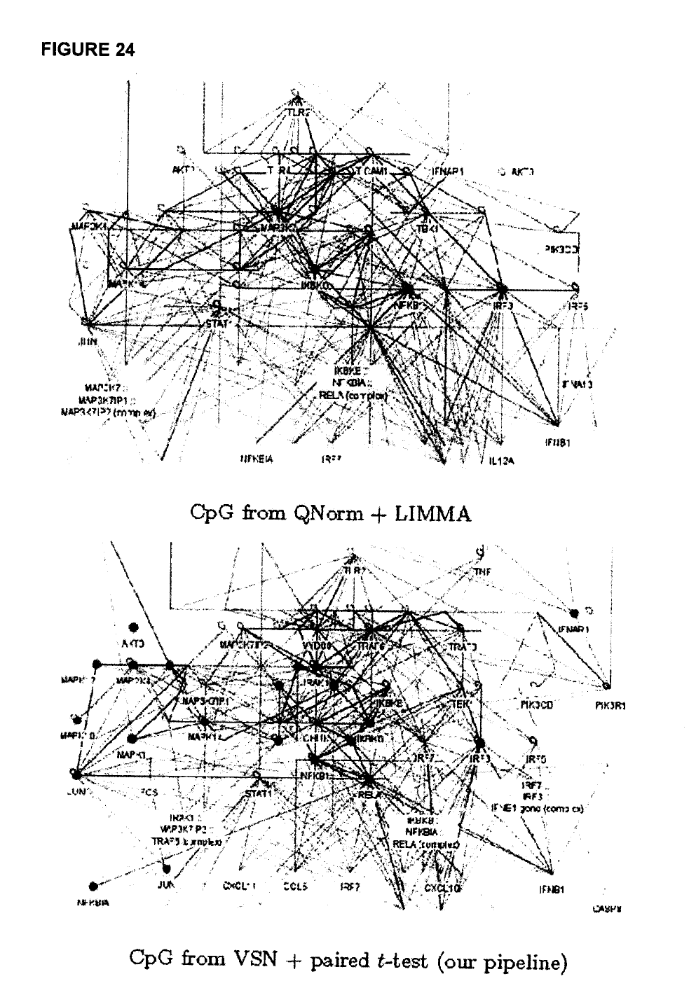

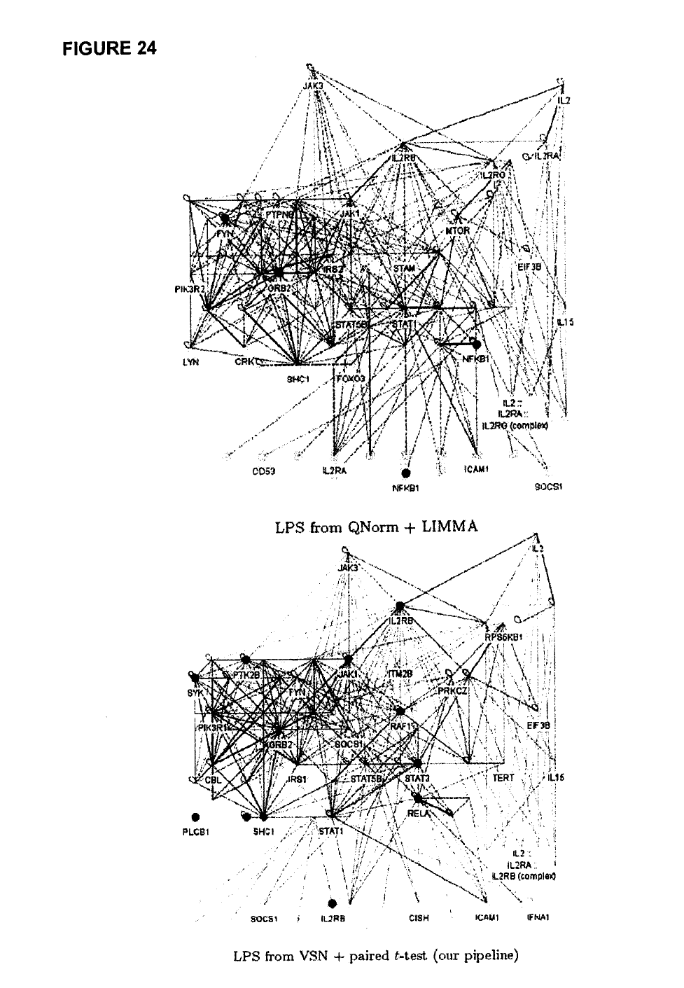

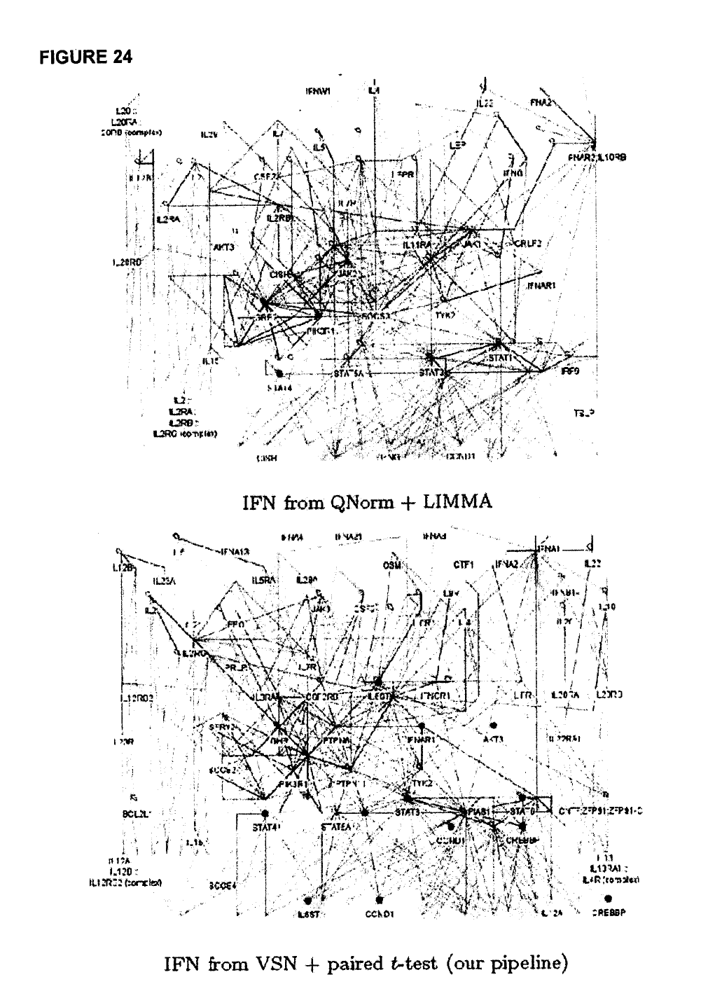

The previous step allowed us to identify sets of peptides that are differentially (de)phosphorylated under specific conditions. Identifiers of the peptides in the three data sets were input to the online pathway database InnateDB [91] along with p-values and fold-change values. This was done for the analysis data from the methodology described here as well as the three comparison methodologies. The query mechanism at the online database in response provided a list of pathways and associated p-values for the pathways, and identified those of the input peptides that appear in the output pathways. The model ligands used to generate the input datasets for the present experiment were CpG, LPS and IFN. The model signaling pathways known for each of these ligands are, respectively, the TLR, IL2 and Jak-STAT. Table 10 indicates the number of peptides corresponding to proteins in each dataset that are found in these model pathways as well as the significance level of the pathway as calculated from the whole data set by InnateDB. Results indicate an improved p-value achieved by the analysis pipeline described here as opposed to the comparison methods. For instance, as shown in Table 10, the methodology described here involving VSN+paired t-test produces the strongest significance level assessed in each of the three pathways. Specifically, comparing with the best p-values in all the 3 published methods, the method described here improves the p-values for the known pathways TLR, IL2, and JAK-STAT from 0.019 to 0.008, 0.405 to 0.002, and 0.122 to 0.003, respectively. FIG. 24 is a visual representation of the respective signaling pathways indicating how the present analysis method (the right panel in each row) identifies more proteins in the signaling pathways creating a more robust network as compared to QNorm+limma. Only QNorm+limma is presented because it is more accurate and discriminating than PNorm+FC and better at representing the model pathways than VSN+limma and QNorm+limma.

### Clustering Analysis

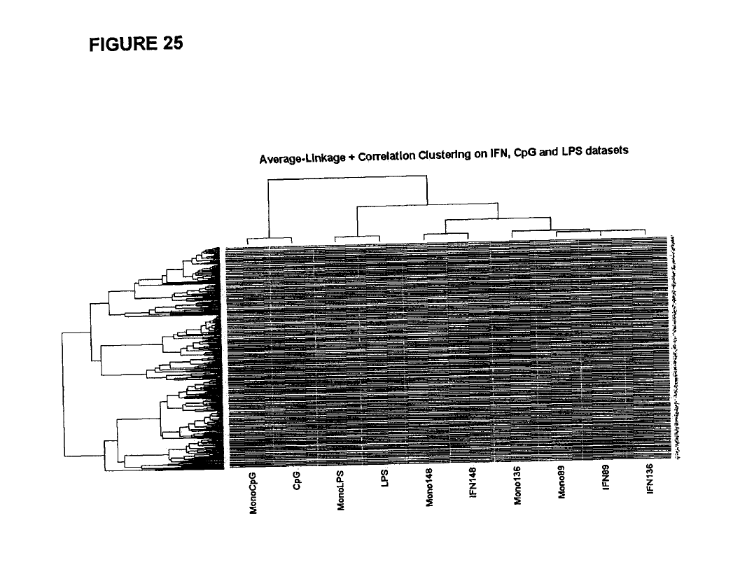

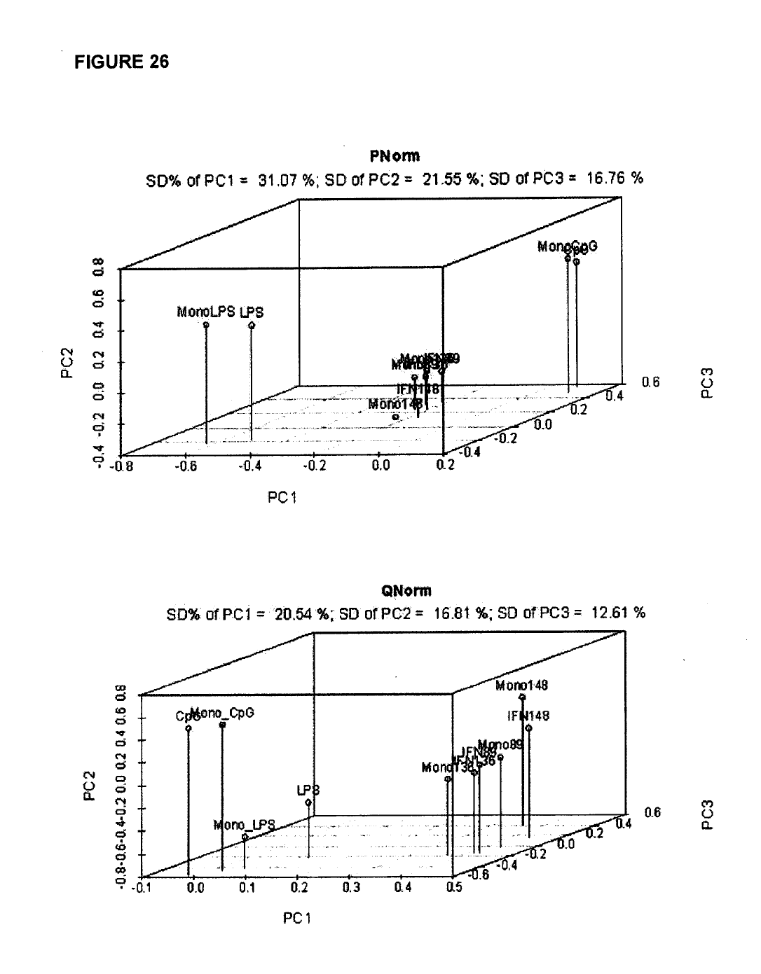

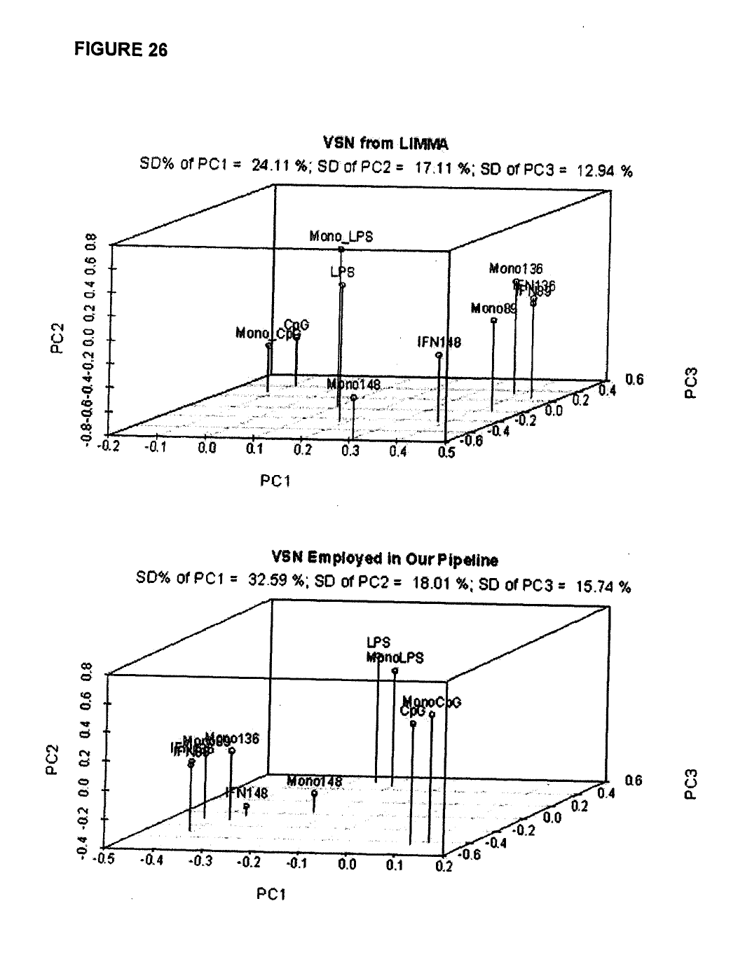

Hierarchical clustering using “Average Linkage+(1−Pearson Correlation)” and PCA was performed on averaged data without biological control subtraction. As shown in FIGS. 25 and 26, this gave mixed results in terms of revealing expected phosphorylation patterns. For instance, tight clusters are formed by the pairs CpG, MonoCpG and LPS, MonoLPS in FIG. 25. This is reasonable given probable experiment—and animal-specific biological effects. However, within the hierarchical clustering results for IFN where subject-subject variability analysis was performed, clustering by treatment was expected. The pattern is only partially observed. IFN89 and IFN136 cluster most tightly suggesting a common pattern of phosphorylation induced by the treatment as the overwhelming biological factor. Unfortunately, this pattern is disrupted by the data for animal “148” for which the strongest biological factor in phosphorylation is the identity of the animal.

Clustering analysis using the normalized and filtered intensities under the comparison methodologies was also performed. The results were again mixed, being qualitatively similar to the patterns from the new methodology described here.

### Discussion

Given the similarity in data acquisition techniques between kinome arrays and gene expression nucleotide arrays, it is understandable that data analysis methods previously developed for gene expression data are being used for kinome data. Numerous software packages exist for interpretation of gene expression data, and many researchers assume that these techniques are also generally applicable to kinome data [85,87,90]. There have been no systematic studies to determine which gene expression techniques are, in fact, applicable, or how they should be modified or tuned to deal with kinome data. Kinome data has different characteristics from gene expression data. For instance the number of peptides included on a kinome array is much lower than the number of oligonucleotides embedded on a nucleotide (transcription) array. Thus, it is not desirable to discard data-points because they are deemed “outliers” or because they have negative values after background subtraction. Peptides may be recognized by the correct protein kinase, but with lower efficiency than in the context of an intact protein. Moreover, kinome activities may vary depending on the individual subjects even for the same species. Thus, the distinct biological nature of the data generates concern when using the same systematic approaches as in gene expression analysis. Three specific issues are rigorously testing for the variability between biological replicates, statistical stringency imposed on the differential analysis, and putting known signaling pathways into perspective given the information obtained from the arrays under specific treatment conditions.

A framework to address the challenges presented by kinome microarray data analysis has been established here. A set of statistical tests has been selected to address the variability between technical and biological replicates and to identify true differential phosphorylation of a peptide specific to a treatment. A conforming kinome analysis software pipeline was then implemented. Briefly, the signal intensities measuring specific phosphorylation events of the peptides on a kinome array are subjected to a variance stabilization transformation (VSN) to bring all the data onto the same scale while alleviating variance-versus-mean dependence. Spot-spot and animal-animal variability are examined to identify and eliminate inconsistently phosphorylated peptides due to technical and biological factors, respectively. One-sided paired t-tests are used to identify differentially phosphorylated peptides from the processed kinome data. The set of differentially phosphorylated peptides is then used to probe pathway databases to identify signalling pathways induced by the treatment. To conduct a comparative analysis of the value of the kinome data analysis pipeline described here, kinome analysis of monocytes stimulated with three different ligands of well understood signaling pathways was conducted. Each data set was analyzed by the methodology described here and by three popular alternative strategies. The results of this comparative analysis suggest that the framework and pipeline described here offer improved extraction of biologically relevant information in terms of the confidence (p-value) with which signalling pathways are identified as well as the number of phosphorylation events implicating those pathways.

The signal intensities elicited by the peptides come from radio-labeled ATP that can non-covalently link to the peptides, occasionally resulting in background intensities higher than the corresponding foreground intensities. This consequently leads to negative intensity values after the background corrections [80]. The negative values are observed in the current datasets. The commonly used workflow from gene expression studies with percentile/quantile normalization, averaging, and foldchange calculation in the differential analysis is not directly applicable to the negative values, but has been nonetheless applied to kinome analyses in many studies [85, 87, 118]. The technique excludes any negative values and is therefore subject to information loss. In contrast, the method and systems described here use an affine linear mapping as the calibration step. This is part of VSN, and it brings all the data points including the negative ones onto the same positive scale while maintaining the correlations between them [88] as illustrated in the bottom right panels of FIGS. 19, 20, and 21. Therefore, all the information from the kinome experiments is preserved by the VSN transformation. Despite starting with the same VSN transformation, the function normalizeBetweenArrays from limma applies a further log₂ function over the transformed intensities, which tends to disturb the intrinsic data structure as shown in the bottom middle panel of FIG. 20.

Fundel et al. [83] point out that different normalization procedures may have profound effects on the distribution as well as the significance values of gene expression levels. The phenomenon carries over to kinome data. Indeed, the outcomes from QNorm, PNorm, VSN (log-scaled), and VSN differ greatly from each other as illustrated in FIGS. 19, 20, and 21. Only PNorm and (standalone) VSN appear to preserve the inherent correlations between the treatment and control responses (FIG. 21). Moreover, despite using the same limma method, QNorm+limma and VSN+limma yield significantly different outcomes in the differential analysis (Table 9), further demonstrating the importance of the choice of transformation procedure.

During the course of microarray data analysis, data points must sometimes be removed from the analysis. In the presently proposed software pipeline, this operation may be automatic, or may need to be performed manually. An example is in the spot-spot variability analysis and subsequent t-test. A p-value from the χ²-test for a peptide less than a threshold is due to the peptide's large variation across replicates. Consequently, it will have an insignificant p-value for the t-test because of the large denominator of the t-statistic. Thus, it will be automatically discarded in the t-test, so there is no need to manually remove it at the earlier stage. Further, due to its high p-value the highly variable peptide will also be eliminated during the InnateDB database lookup. In the visualization stage (as shown in FIG. 22), some manual intervention for peptides with inconsistent variation is necessary. Peptides with large subject-subject variability are color-coded in grey. Peptides that have large variation across replicates will have insignificant p-values and hence tend to be colored in a brown (combined red-green) color. However, for the clustering analysis, these peptides need to be removed because there is no procedure that takes into account their inconsistent variation. Hence for clustering analysis they must be eliminated manually.

In analysis of microarray data, a single dataset is used multiple times to accept or reject hypotheses. For instance, in the methodology described here many one-sided paired t-tests are performed based on the same set of preprocessed signal intensities. This is an instance of a multiple testing problem in statistics. To complicate matters, the paired t-tests assume independence between any two tests for any two peptides. However, independence of phosphorylation events is not guaranteed since several peptides with different phosphorylation sites may come from the same protein, so their phosphorylations may be correlated. To deal with this multiple testing situation, techniques such as Bonferroni or Benjamini [104,119] can be used. A potential problem for these techniques is the over-stringency they tend to impose in order to achieve a small global type I error (say 5%). This is typically not a problem for gene expression data where tens of thousands of genes are considered at one time, and an aim is to reduce dimensionality. In that case, high specificity is favoured over sensitivity to avoid false positives as much as possible at the cost of false negatives. However, the dimensionality of kinome datasets is not as high as with transcription datasets, and phosphorylation of peptides may not be as efficient as hybridizations of oligonucleotides on transcription arrays in vitro [80]. Therefore, it is advisable to less readily eliminate peptides as some of them may turn out to be crucial in the pathway analysis, which has been shown to be the case in the above results (Table 9 and 10).

Witten and Tibshirani [120] have noted that, in the analysis of real microarray data, there is no correct answer as to whether fold-change or the modified t-statistic should be used. However, the choice can have a dramatic effect on the set of genes or peptides that are identified. Therefore, the measure of differential expression used must be based on the biological system under investigation. Specifically, if large absolute changes in expression are relevant to the system, then fold-change should be used; on the other hand, if changes in expression relative to the underlying noise are important, then p-values or modified t-statistics (e.g., paired t-test in the pipeline described here) are preferable. Based on the criteria for the assessment of the four transformation plus differential analysis methods set out here, the outcomes strongly suggest that the correct decisions were made in choosing the appropriate transformation and statistical test to elucidate biologically meaningful signaling pathways in all three treatments.

The clustering results in FIGS. 25 and 26 were inconclusive. For example, for IFN clustering by treatment was expected but the pattern was only partially present. Other types of clustering mentioned in the “Clustering Analysis” subsection of the Methodology section may give improved results. However, a more likely cause for the inconclusive clustering is the small number of biological replicates. Extending the experiment by having more biological replicates would address this shortcoming. Another potential explanation for the clustering results is residual spot-spot and subject-subject variability. More experimentation with the thresholds in the two variability analyses—so that more data are deemed inconsistent and discarded, but not to the point of seriously impacting identification of pathways—is thus warranted. Finally, the clustering may be more applicable to cases of more severe stimuli, such as infectious agents.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

TABLE 1
Sample GO-encoding table for differential peptides identified by
the paired t-test
Table 1. Sample GO-encoding table for differential peptides identified by the paired t-test

| | | | cell surface | | | | |
|---|---|---|---|---|---|---|---|
| | Paired | | receptor | regulation | | | |
| | t-test | cell | linked signal | of gene | immune system | | |
| | p-value | communication | transduction | expression | process | . . . | Others |
| PLCG1_Y783 | 0.00003 | 1 | 0 | 0 | 0 | . . . | cellular |
| | | | | | | | response to |
| | | | | | | | hormone |
| | | | | | | | stimulus, . . . |
| IGF1R_Y1166 | 0.00595 | 1 | 1 | 0 | 1 | . . . | . . . |
| Lyn_Y507 | 0.00845 | 1 | 0 | 0 | 1 | . . . | . . . |
| RIPK1_Y384/7/9 | 0.00882 | 1 | 1 | 1 | 0 | . . . | . . . |
| eNOS_S1176 | 0.00906 | 1 | 1 | 0 | 0 | . . . | . . . |
| . | . | . | . | . | . | . | . |
| . | . | . | . | . | . | . | . |
| . | . | . | . | . | . | . | . |
| Syk_Y525/6 | 0.04984 | 1 | 1 | 0 | 1 | . . . | . . . |

Paired t-test was performed to identify differential phosphorylation status at a statistical significance level among the peptides under a treatment condition relative to a control condition in a kinome study. The UniProt accession numbers from the significantly regulated peptides is used to probe the relevant GO terms using GOTermFinder on-line server (go.princeton.edu/cgi-bin/GOTermFinder). The GO terms that occur ≧5 times each will have their own columns with the abbreviateddescriptions of their meanings as the column names (e.g., cell communication). The binary (0/1) encoding indicates whether the corresponding peptide (indicated by the row name) belong to that GO category. The less frequent GO terms for each differential peptide are placed into the last column called “Others” (e.g., cellular response to hormone stimulus).

TABLE 2
Common differential peptides in PrP and 6H4
at 80% confidence from the prion datasets
Table 2. Common differential peptides in PrP and 6H4
at 80% confidence from the prion datasets

| spot# | |
|---|---|
| | Up-reg peptide |
| 29 | ATF-2_T51/3/5 |
| 65 | Jak1_Y1022/3 |
| 106 | APE1_S289 |
| 111 | PLCB1_S887 |
| 152 | mucin1_{—}T1224/7/9 |
| 153 | IKK-alpha_T23 |
| 218 | VASP_S156 |
| 219 | Ezrin_T566 |
| 284 | IL-8R-B_S351/2/3 |
| | Down-reg peptide |
| 8 | KK-gamma_S31 |
| 10 | STAT1_Y701 |
| 16 | STAT4_S721 |
| 22 | CTNNB1_Y142 |
| 39 | NFAT2_S245 |
| 40 | NFAT2_S294 |
| 164 | FLT3_Y597/9 |
| 173 | TrkB_Y706/7 |
| 300 | FADD_NA |

One-sided paired t-test was performed to identify differential phosphorylation status among the 300 peptides for human neuron under treatments PrP and 6H4 relative to the controls Scram and Iso, respectively. The peptide in bold face is also at 5% significance level.

TABLE 3
KEGG top 10 pathways probed by differential peptides identified by
paired t-test at 95% confidence from the prion datasets
Table 3. KEGG top 10 pathways probed by differential peptides identified
by paired t-test at 95% confidence from the prion datasets.

| | |
|---|---|
| Pathway | Peptides |

PrP induced pathway

| | |
|---|---|
| Pathways in cancer | 11 |
| MAPK signaling pathway | 6 |
| Adherens junction | 6 |
| Cytokine-cytokine receptor interaction | 4 |
| Toll-like receptor signaling pathway | 4 |
| Jak-STAT signaling pathway | 4 |
| Colorectal cancer | 4 |
| Prostate cancer | 4 |
| Endocytosis | 4 |
| Neurotrophin signaling pathway | 4 |

6H4 induced pathway

| | |
|---|---|
| Pathways in cancer | 7 |
| MARK signaling pathway | 7 |
| Prostate cancer | 6 |
| Neurotrophin signaling pathway | 6 |
| Chemokine signaling pathway | 5 |
| Wnt signaling pathway | 5 |
| Toll-like receptor signaling pathway | 5 |
| Glioma | 4 |
| Fc epsilon RI signaling pathway | 4 |
| Calcium signaling pathway | 4 |

The GeneSymbols were collected according to the differential peptides identified by the paired t-test at 95% confidence level for human neuron under treatments PrP and 6H4 relative to the controls Scram and Iso, respectively. They were used to query the KEGG database for signaling transduction pathways involving the corresponding proteins. The pathways in boldface are the common pathways shared by both PrP and 6H4.

TABLE 4
KEGG top 10 pathways probed by differential peptides identified
by the paired t-test at 95% confidence from the MAP databases
Table 4. KEGG top 10 pathways probed by differential peptides identified
by the paired t-test at 95% confidence from the MAP datasets

| | |
|---|---|
| Pathway | Peptides |

IFN induced pathway

| | |
|---|---|
| Pathways in cancer | 8 |
| MAPK signaling | 7 |
| pathway | |
| Focal adhesion | 5 |
| Fc gamma R-mediated | 5 |
| phagocytosis | |
| B cell receptor | 5 |
| signaling pathway | |
| Pancreatic cancer | 5 |
| Chemokine signaling | 5 |
| pathway | |
| Natural killer cell | 5 |
| mediated cytotoxicity | |
| ErbB signaling | 4 |
| pathway | |
| Jak-STAT signaling | 3 |
| pathway | |

MAP induced pathway

| | |
|---|---|
| Pathways in cancer | 3 |
| NOD-like receptor | 2 |
| signaling pathway | |
| Focal adhesion | 2 |
| Oocyte meiosis | 2 |
| Progesterone-mediated | 2 |
| oocyte maturation | |
| Alzheimer's disease | 2 |
| Melanoma | 2 |
| Axon guidance | 2 |
| Adherens junction | 2 |
| Toll-like receptor | 2 |
| signaling pathway | |

MAP + IFN induced pathway

| | |
|---|---|
| MAPK signaling | 7 |
| pathway | |
| Pathways in cancer | 7 |
| Neurotrophin signaling | 5 |
| pathway | |
| Toll-like receptor | 5 |
| signaling pathway | |
| NOD-like receptor | 3 |
| signaling pathway | |
| ErbB signaling | 3 |
| pathway | |
| Fc epsilon RI signaling | 3 |
| pathway | |
| GnRH signaling | 3 |
| pathway | |
| Adipocytokine | 3 |
| signaling pathway | |
| RIG-I-like receptor | 3 |
| signaling pathway | |

The Gene Symbols were collected according to the differential peptides identified by the paired t-test at 95% confidence level for bovine monocyte under treatments IFN, MAP, and MAP + IFN relative to the control Mono. They were used to query the KEGG database for signaling transduction pathways involving the corresponding proteins. The pathways in blue are enriched by differential peptides under IFNγ and MAP + IFN, and the ones in red are enriched by differential peptides under MAP and MAP + IFN. The Jak-STAT signaling pathway (in bold) is the representative pathway for IFNγ.

TABLE 5
Pathway Analysis of Bovine Monocytes and MAP-Infected
Bovine Monocytes in Response to IFN Stimulation

| | | | | | | | MAP-IFNected | | | |
|---|---|---|---|---|---|---|---|---|---|---|
| | | | Monocytes | | | | Monocytes | | | |
| | | | Up | | Down | | Up | | Down | |
| | | | Regulated | | regulated | | Regulated | | regulated | |
| | Pathway | [symbol] | ↑ | p | ↓ | p | ↑ | p | ↓ | p |
| Jak Stat | Jak-STAT signaling | 21 | 18 | 0.002 | 2 | 1 | 2 | 0.958 | 9 | 0.104 |
| Signaling | pathway | | | | | | | | | |
| | JAK-STAT | 17 | 15 | 0.003 | 2 | 1 | 2 | 0.936 | 8 | 0.154 |
| | pathway/regulation | | | | | | | | | |
| | Gene expression of | 6 | 6 | 0.027 | 0 | 1 | 0 | 1 | 2 | 0.360 |
| | SOCS | | | | | | | | | |
| | Gene expression of | 6 | 6 | 0.027 | 0 | 1 | 0 | 1 | 2 | 0.360 |
| | SOCS1 | | | | | | | | | |
| | Gene expression of | 6 | 6 | 0.027 | 0 | 1 | 0 | 1 | 2 | 0.360 |
| | SOCS3 | | | | | | | | | |
| Cytokine/ | IL27-mediated | 6 | 6 | 0.027 | 0 | 1 | 0 | 1 | 4 | 0.125 |
| Chemokine | signaling events | | | | | | | | | |
| Signaling | IL12-mediated | 14 | 12 | 0.015 | 2 | 0.990 | 1 | 0.900 | 4 | 0.335 |
| | signaling events | | | | | | | | | |
| | Il22 soluble | 5 | 5 | 0.050 | 0 | 1 | 0 | 1 | 3 | 0.213 |
| | receptor signaling | | | | | | | | | |
| | AndrogenReceptor | 12 | 11 | 0.007 | 0 | 1 | 3 | 0.368 | 3 | 0.833 |
| | IFN beta enhancer | 6 | 6 | 0.027 | 0 | 1 | 0 | 1 | 1 | 0.603 |
| | IFNormation | | | | | | | | | |
| | processing | | | | | | | | | |
| TGFB | TGF-beta | 5 | 5 | 0.050 | 0 | 1 | 2 | 1 | 1 | 0.941 |
| Signaling | (canonical) | | | | | | | | | |
| | Tgf beta signaling | 5 | 5 | 0.050 | 0 | 1 | 2 | 2 | 2 | 0.829 |
| | pathway | | | | | | | | | |
| | TGFBR | 15 | 12 | 0.038 | 2 | 0.994 | 5 | 2 | 2 | 0.994 |
| NFkB | Nfkb activation | 9 | 8 | 0.037 | 1 | 0.988 | 2 | 1 | 1 | 0.977 |
| Signaling | | | | | | | | | | |

InnateDb (www.innatedb.com) is a publicly available pathway analysis tool. Based on levels of differential expression or phosphorylation InnateDb is able to predict pathways which are consistent with the experimental data. Pathways are assigned a probability value (p) based on the number of proteins present for a particular pathway. Output also includes the number of the uploaded pathways associated with a particular pathway as well as the subset of those which are differentiallyphosphorylated. For our investigation fold change cut-offs are set at p <0.2 confidence of difference between treatment and monocyte control. [symbol]
indicates the number of peptides on the array relating to the pathway, ↑ and ↓ indicate the number of peptides with increased or decreased phosphorylation respectively with respect to the control condition.

TABLE 6
Differential phosphorylation of peptides of
the JAK-STAT pathway following IFNγ stimulation
of monocytes and MAP infected monocytes

| | |
|---|---|
| | MAP-IFNected |
| Monocytes | Monocytes |

| | Fold | | Fold | |
|---|---|---|---|---|
| Phosphoprotein* | Change ‡ | p § | Change ‡ | p § |
| IFNAR1 | 1.21 | 0.11 | 1.13 | 0.33 |
| IFNGR1 | 1.95 | 0.15 | 1.15 | 0.36 |
| IL10RA | 1.43 | 0.11 | −1.08 | 0.14 |
| IL16 | 1.86 | 0.16 | 1.59 | 0.20 |
| IL2RB | 2.24 | 0.16 | 1.35 | 0.45 |
| IL4R | 1.59 | 0.18 | 1.31 | 0.35 |
| I16ST | 1.86 | 0.16 | 1.30 | 0.22 |
| I17R | 1.56 | 0.13 | 1.52 | 0.20 |
| JAK1 | 1.23 | 0.46 | −1.14 | 0.09 |
| JAK2 | 1.00 | 0.61 | −1.10 | 0.13 |
| JAK3 | 1.01 | 0.53 | −1.30 | 0.05 |
| STAT1 | 1.72 | 0.09 | 1.83 | 0.21 |
| STAT2 | 1.22 | 0.11 | −1.24 | 0.03 |
| STAT3 | 3.11 | 0.02 | 1.27 | 0.36 |
| STAT4 | 2.18 | 0.09 | 1.50 | 0.48 |
| STAT5B | 1.55 | 0.19 | 1.58 | 0.43 |
| STAT6 | 1.30 | 0.07 | 1.13 | 0.11 |
| Tyk2 | 1.09 | 0.11 | 1.14 | 0.37 |

*Common name for substrate protein with a peptide for a phosphorylation site on the array.
‡ Relative change calculated by comparing the background-corrected and normalized signal values of these samples to the media control, p values correspond to how significant a difference there is between IFNγ treated cells and control cells.

TABLE 7
Non-treatment-exclusive differential peptides from
MAP kinome identified by one-sided paired t-test.

| | | | |
|---|---|---|---|
| Peptide | UniProt | GeneSymbol | p-value |

IFN
Significantly dephosphorylated in IFN Treatment (23 peptides)

| | | | |
|---|---|---|---|
| iNOS_S739 | P35228 | NOS2A | 0.001466 |
| PKCT_Y90 | Q04759 | PRKCQ | 0.001964 |
| Fes_Y713 | P07332 | FES | 0.002031 |
| TNIK_S764 | Q9UKE5 | TNIK | 0.002632 |
| ApoE_S314 | P02649 | APOE | 0.006205 |
| Raf1_S259 | P04049 | RAF1 | 0.007832 |
| TPH1_S58 | P17752 | TPH1 | 0.008185 |
| FGFR1_Y463 | P11362 | FGFR1 | 0.008628 |
| Raf1_S499 | P04049 | RAF1 | 0.011613 |
| JIP1_T103 | Q9UQF2 | MAPK8IP1 | 0.012386 |
| H-Ras-1_T35 | P01112 | KRAS | 0.012857 |
| ADCY8_Y406 | P40145 | ADCY8 | 0.014562 |
| ASK1_S83 | Q99683 | MAP3K5 | 0.014658 |
| CD45_Y1216 | P08575 | PTPRC | 0.015508 |
| DAPK1_S308 | P53355 | DAPK1 | 0.018340 |
| Shc1_Y349/0 | P29353 | SHC1 | 0.019842 |
| PKCA_T637 | P17252 | PRKCA | 0.021891 |
| PKCT_T219 | Q04759 | PRKCQ | 0.022792 |
| iNOS_S909 | P35228 | NOS2A | 0.025359 |
| TNIK_T987 | Q9UKE5 | TNIK | 0.025806 |
| FADD_NA | Q13158 | FADD | 0.027210 |
| iNOS_Y151 | P35228 | NOS2A | 0.033124 |
| RBL2_SYMSP_NA | P10796 | AT5G38430 | 0.047798 |

Significantly phosphorylated in IFN Treatment (23 peptides)

| | | | |
|---|---|---|---|
| TAK1_T184 | 043318 | MAP3K7 | 0.005071 |
| NFkB-p65_S276 | Q04206 | RELA | 0.005824 |
| PLCG1_Y783 | P19174 | PLCG1 | 0.007018 |
| BLNK_Y96 | Q8WV28 | BLNK | 0.011354 |
| Smad2_S255 | Q15796 | SMAD2 | 0.013388 |
| IRF-3_S385/6 | Q14653 | IRF3 | 0.013477 |
| Etk_Y40 | P51813 | BMX | 0.017378 |
| VEGFR-2_Y1214 | P35968 | KDR | 0.017385 |
| MKP-1_S323 | P28562 | DUSP1 | 0.020520 |
| IRF-5_S437 | Q13568 | IRF5 | 0.024628 |
| STAT3_S727 | P40763 | STAT3 | 0.026523 |
| Grb10_S150 | Q13322 | GRB10 | 0.026598 |
| cyclinD1_T286/8 | P24385 | CCND1 | 0.026603 |
| MKP-1_S359 | P28562 | DUSP1 | 0.026762 |
| CSK_Y184 | P41240 | CSK | 0.034227 |
| Syk_Y525/6 | P43405 | SYK | 0.038339 |
| RIPK1_Y384/7/9 | Q13546 | RIPK1 | 0.038506 |
| Btk_Y551 | Q06187 | BTK | 0.038531 |
| Bad_S118 | Q92934 | BAD | 0.045111 |
| NFkB-p105_S337 | P19838 | NFKB1 | 0.046092 |
| gp130_S782 | P40189 | IL6ST | 0.047440 |
| Akt1_Y326 | P31749 | AKT1 | 0.048040 |
| IRAK1_T100 | P51617 | IRAK1 | 0.048253 |

MAP + IFN
Significantly dephosphorylated in MAP + IFN Treatment (12 peptides)

| | | | |
|---|---|---|---|
| TPH1_S58 | P17752 | TPH1 | 0.003911 |
| ERK3_S189 | Q16659 | MAPK6 | 0.007198 |
| BATF_T48 | Q16520 | BATF | 0.011665 |
| ERK2_Y205 | P28482 | MAPK1 | 0.012944 |
| STAT2_Y690 | P52630 | STAT2 | 0.028055 |
| DAPK1_S308 | P53355 | DAPK1 | 0.028484 |
| STAT3_Y705 | P40763 | STAT3 | 0.034457 |
| IGF1R_Y1166 | P08069 | IGF1R | 0.037842 |
| Casp8_S347 | Q14790 | CASP8 | 0.038638 |
| Casp3_S150 | P42574 | CASP3 | 0.045127 |
| PKCT_Y90 | Q04759 | PRKCQ | 0.046457 |
| Jak3_Y981 | P52333 | JAK3 | 0.048436 |

Significantly phosphorylated in MAP + IFN Treatment (5 peptides)

| | | | |
|---|---|---|---|
| EphA2_Y772 | P29317 | EPHA2 | 0.002192 |
| DAPK3_T225 | O43293 | DAPK3 | 0.002812 |
| Bad_S118 | Q92934 | BAD | 0.005615 |
| CSK_Y184 | P41240 | CSK | 0.009962 |
| PKR_T446 | P19525 | EIF2AK2 | 0.030460 |

MAP
Significantly dephosphorylated in MAP Treatment (17 peptides)

| | | | |
|---|---|---|---|
| TNIK_T987 | Q9UKE5 | TNIK | 0.0005518 |
| Fes_Y713 | P07332 | FES | 0.0011813 |
| Kit_S821 | P10721 | KIT | 0.0020445 |
| iNOS_Y151 | P35228 | NOS2A | 0.0053159 |
| PKCA_S656 | P17252 | PRKCA | 0.0101612 |
| PKCT_Y90 | Q04759 | PRKCQ | 0.0104398 |
| RasGAP_Y460 | P20936 | RASA1 | 0.0114515 |
| caveolin-1_Y14 | Q2TNI1 | NA | 0.0130772 |
| iNOS_S909 | P35228 | NOS2A | 0.0139231 |
| TPH1_S58 | P17752 | TPH1 | 0.0153082 |
| DAPK1_S308 | P53355 | DAPK1 | 0.0219371 |
| TNFRSF5_T254 | P25942 | CD40 | 0.0257518 |
| JIP1_T103 | Q9UQF2 | MAPK8IP1 | 0.0318567 |
| IkB-beta_T19/23 | Q15653 | NFKBIB | 0.0394560 |
| iNOS_S739 | P35228 | NOS2A | 0.0431141 |
| Fyn_Y531 | P06241 | FYN | 0.0444556 |
| APE1_S289 | P27695 | APEX1 | 0.0459345 |

Significantly phosphorylated in MAP Treatment (24 peptides)

| | | | |
|---|---|---|---|
| CDK7_T170 | P50613 | CDK7 | 0.0001871 |
| DAPK3_T225 | O43293 | DAPK3 | 0.0003863 |
| CSK_Y184 | P41240 | CSK | 0.0015281 |
| GSK3-beta_S9 | P49840 | GSK3A | 0.0035230 |
| p300_S1834 | Q09472 | EP300 | 0.0041558 |
| STMN1_S62 | P16949 | STMN1 | 0.0058764 |
| RIPK1_Y384/7/9 | Q13546 | RIPK1 | 0.0083611 |
| NFkB-p100_S865 | Q00653 | NFKB2 | 0.0091208 |
| PLCG1_Y783 | P19174 | PLCG1 | 0.0098030 |
| Akt1_Y326 | P31749 | AKT1 | 0.0098695 |
| STAT1_Y701 | P42224 | STAT1 | 0.0122150 |
| TAK1_S192 | O43318 | MAP3K7 | 0.0138718 |
| MEK2_Y216 | P36507 | MAP2K2 | 0.0162401 |
| Etk_Y40 | P51813 | BMX | 0.0202439 |
| NFkB-p65_S276 | Q04206 | RELA | 0.0230360 |
| JNK2_T404/7 | P45984 | MAPK9 | 0.0232015 |
| NFkB-p105_S337 | P19838 | NFKB1 | 0.0246715 |
| ATF-2_S44 | P15336 | ATF2 | 0.0289219 |
| JNK1_S377 | P45983 | MAPK8 | 0.0309081 |
| Btk_Y223 | Q06187 | BTK | 0.0344371 |
| MKP-1_S323 | P28562 | DUSP1 | 0.0366842 |
| NFAT2_S294 | O95644 | NA | 0.0460595 |
| ATF-4_S245 | P18848 | ATF4 | 0.0475701 |
| TrkB_Y706/7 | Q16620 | NTRK2 | 0.0477721 |

The 212 consistently phosphorylated peptides identified by the F-tests were subjected to one-sided paired t-test to identify significantly phosphorylated or dephosphorylated peptides in treatments IFN, MAP + IFN, and MAP relative to the Mono control (no treatment). For each of these peptides, the responses from all three animals were pooled to increase the statistical confidence. Only the peptides with p-values less than 0.05 are shown here. The numbers of differential peptides are shown in the parentheses besides the treatment name. The first column contains the common names of the corresponding proteins for the peptides and the phosphorylation sites separated by underscores. The second column contains the UniProt accession numbers, which can be used to query detailed IFNormation of the corresponding proteins from the Protein Knowledgebase (http://www.uniprot.org/). The third column includes the GeneSymbol for the corresponding genes, which can be used as inputs to the KEGG database (http://www.genome.ip/kegg/tool/search pathway.html) to search for pathways with those genes involved. The last column has the p-values.

TABLE 8
Treatment-exclusive differential peptides from MAP
kinome identified by one-sided paired t-test

| | | | |
|---|---|---|---|
| Peptide | Uniprot | GeneSymbol | p-value |

IFN
Significantly dephosphorylated ONLY in IFN Treatment (14 peptides)

| | | | |
|---|---|---|---|
| TNIK_S764 | Q9UKE5 | TNIK | 0.002632 |
| ApoE_S314 | P02649 | APOE | 0.006205 |
| FGFR1_Y463 | P11362 | FGFR1 | 0.008628 |
| Raf1_S499 | P04049 | RAF1 | 0.011613 |
| H-Ras-1_T35 | P01112 | KRAS | 0.012857 |
| ADCY8_Y406 | P40145 | ADCY8 | 0.014562 |
| ASK1_S83 | Q99683 | MAP3K5 | 0.014658 |
| CD45_Y1216 | P08575 | PTPRC | 0.015508 |
| Shc1_Y349/0 | P29353 | SHC1 | 0.019842 |
| PKCA_T637 | P17252 | PRKCA | 0.021891 |
| PKCT_T219 | Q04759 | PRKCQ | 0.022792 |
| FADD_NA | Q13158 | FADD | 0.027210 |
| RBL2_SYMSP_NA | P10796 | AT5G38430 | 0.047798 |

Significantly phosphorylated ONLY in IFN Treatment (12 peptides)

| | | | |
|---|---|---|---|
| TAK1_T184 | O43318 | MAP3K7 | 0.005071 |
| BLNK_Y96 | Q8WV28 | BLNK | 0.011354 |
| Smad2_S255 | Q15796 | SMAD2 | 0.013388 |
| VEGFR-2_Y1214 | P35968 | KDR | 0.017385 |
| IRF-5_S437 | Q13568 | IRF5 | 0.024628 |
| STAT3_S727 | P40763 | STAT3 | 0.026523 |
| Grb10_S150 | Q13322 | GRB10 | 0.026598 |
| cyclinD1_T286/8 | P24385 | CCND1 | 0.026603 |
| MKP-1_S359 | P28562 | DUSP1 | 0.026762 |
| Syk_Y525/6 | P43405 | SYK | 0.038339 |
| Btk_Y551 | Q06187 | BTK | 0.038531 |
| gp130_S782 | P40189 | IL6ST | 0.047440 |

MAP + IFN
Significantly dephosphorylated ONLY in MAP + IFN Treatment
(6 peptides)

| | | | |
|---|---|---|---|
| ERK3_S189 | Q16659 | MAPK6 | 0.007198 |
| BATF_T48 | Q16520 | BATF | 0.011665 |
| ERK2_Y205 | P28482 | MAPK1 | 0.012944 |
| IGF1R_Y1166 | P08069 | IGF1R | 0.037842 |
| Casp8_S347 | Q14790 | CASP8 | 0.038638 |
| Jak3_Y981 | P52333 | JAK3 | 0.048436 |

Significantly phosphorylated ONLY in MAP + IFN Treatment (1 peptide)

| | | | |
|---|---|---|---|
| EphA2_Y772 | P29317 | EPHA2 | 0.002192 |

MAP
Significantly dephosphorylated ONLY in MAP Treatment (5 peptides)

| | | | |
|---|---|---|---|
| Kit_S821 | P10721 | KIT | 0.002044 |
| RasGAP_Y460 | P20936 | RASA1 | 0.011452 |
| TNFRSF5_T254 | P25942 | CD40 | 0.025752 |
| IkB-beta_T19/23 | Q15653 | NFKBIB | 0.039456 |
| APE1_S289 | P27695 | APEX1 | 0.045935 |

Significantly phosphorylated ONLY in MAP Treatment (9 peptides)

| | | | |
|---|---|---|---|
| p300 S1834 | Q09472 | EP300 | 0.004156 |
| NFkB-p100_S865 | Q00653 | NFKB2 | 0.009121 |
| STAT1_Y701 | P42224 | STAT1 | 0.012215 |
| MEK2_Y216 | P36507 | MAP2K2 | 0.016240 |
| JNK2_T404/7 | P45984 | MAPK9 | 0.023201 |
| ATF-2_S44 | P15336 | ATF2 | 0.028922 |
| JNK1_S377 | P45983 | MAPK8 | 0.030908 |
| NFAT2_S294 | O95644 | NA | 0.046059 |
| TrkB_Y706/7 | Q16620 | NTRK2 | 0.047772 |

Peptides that are significantly phosphorylated or dephosphorylated at the 95% confidence level in a single treatment were selected from the 212 animal-independent peptides. Please refer to the caption for Table 7 for detailed information of each column.

TABLE 9
Total number of differentially phosphorylated peptides at
90% significance level discovered by the three methods

| | QNorm + | | | VSN + | | | VSN + paired t- | | |
|---|---|---|---|---|---|---|---|---|---|
| | LIMMA | | | LIMMA | | | test (our pipeline) | | |
| Treatments | [symbol] | ↑ | ↓ | [symbol] | ↑ | ↓ | [symbol] | ↑ | ↓ |
| CpG | 11 | 8 | 3 | 3 | 3 | 0 | 85 | 44 | 41 |
| LPS | 17 | 11 | 6 | 9 | 5 | 4 | 55 | 28 | 27 |
| IFN | 16 | 7 | 9 | 8 | 4 | 4 | 133 | 71 | 62 |

Differentially phosphorylated peptides under treatments CpG, LPS, and IFN were identified by three different methods including QNorm + limma, VSN + limma, and VSN + paired t-test.
↑ and ↓ indicate the number of identified peptides with increased or decreased phosphorylation, respectively, with respect to the control condition and [symbol] indicates the total number of differentially phosphorylated peptides.
The PNorm + FC method was not included in the above table since it does not allow for a calculation of the significance of the presence of phosphorylated peptides.

TABLE 10
Pathway Analysis Results from InnateDB

| | | | | | | | | | | | | VS + | | |
|---|---|---|---|---|---|---|---|---|---|---|---|---|---|---|
| | | | | | | | | | | | | paired t- | | |
| | | | PNorm + | | | QNorm + | | | VSN + | | | test (our | | |
| | | Pep | FC | | | LIMMA | | | LIMMA | | | pipeline) | | |
| Ligand | Pathway | [symbol] | ↑ | ↓ | p | ↑ | ↓ | p | ↑ | ↓ | p | ↑ | ↓ | p |
| CpG | TLR | 34 | 15 | 12 | 0.021 | 4 | 0 | 0.019 | 1 | 0 | 1.000 | 14 | 4 | 0.008 |
| LPS | IL2 | 25 | 8 | 10 | 0.587 | 1 | 2 | 0.600 | 1 | 2 | 0.405 | 9 | 0 | 0.002 |
| IFN | JAK- | 25 | 18 | 2 | 0.122 | 1 | 1 | 0.700 | 1 | 0 | 1.000 | 12 | 0 | 0.003 |
| | STAT | | | | | | | | | | | | | |

InnateDB (www.innatedb.com) is a publicly available pathway analysis tool. Based on levels of differential phosphorylation, InnateDB is able to predict pathways which are consistent with the experimental data. Each pathway is assigned a probability value (p) based on the number of proteins (corresponding to input peptides) present from that pathway. Output includes the number of uploaded peptides associated with a particular pathway as well as the subset of those peptides which aredifferentially phosphorylated. [symbol]
indicates the number of peptides on the array relating to the pathway, and ↑ and ↓ indicate the number of identified peptides of the pathway with increased or decreased phosphorylation, respectively, relative to the control condition.

### CITATIONS FOR REFERENCES REFERRED TO IN THE SPECIFICATION

1) N. B. Harris, R. G. Barletta, Mycobacterium avium subsp. Paratuberculosis in Veterinary Medicine. Clin. Microbiol. Rev. 14, 489-512 (2001).
2) A. Tiwari, J. A. VanLeeuwen, S. L. McKenna, G. P. Keefe, H. W. Barkema, Johne's disease in Canada Part I: clinical symptoms, pathophysiology, diagnosis, and prevalence in dairy herds. Can. Vet. J. 47, 874-882 (2006).
3) J. Chi, J. A. VanLeeuwen, A. Weersink, G. P. Keefe, Direct production losses and treatment costs from bovine viral diarrhoea virus, bovine leukosis virus, Mycobacterium avium subspecies paratuberculosis, and Neospora caninum. Prev. Vet. Med. 55, 137-153 (2002).
4) J. A. VanLeeuwen, G. P. Keefe, R. Tremblay, C. Power, J. J. Wichtel, Seroprevalence of infection with Mycobacterium avium subspecies paratuberculosis, bovine leukemia virus, and bovine viral diarrhea virus in maritime Canada dairy cattle. Can. Vet. J. 42, 193-198 (2001).
5) A. R. Shin, H. J. Kim, S. N. Cho, M. T. Collins, E. J. Manning, S. A. Naser, S. J. Shin, Identification of seroreactive proteins in the culture filtrate antigen of Mycobacterium avium ssp. paratuberculosis human isolates to sera from Crohn's disease patients. FEMS Immunol. Med. Microbiol. 58, 128-137 (2010).
6) M. M. Eltholth, V. R. Marsh, S. Van Winden, F. J. Guitian, Contamination of food products with Mycobacterium avium paratuberculosis: a systematic review. J. Appl. Microbiol. 107, 1061-1071 (2009).
7) I. Olsen, S. Tollefsen, C. Aagaard, L. J. Reitan, J. P. Bannantine, P. Andersen, L. M. Sollid, K. E. Lundin, Isolation of Mycobacterium avium subspecies paratuberculosis reactive CD4 T cells from intestinal biopsies of Crohn's disease patients. PLoS One. 4, e5641 (2009).
8) D. J. Weiss, C. D. Souza, Review paper: modulation of mononuclear phagocyte function by Mycobacterium avium subsp. paratuberculosis. Vet. Pathol. 45, 829-841 (2008).
9) S. R. Woo, J. A. Heintz, R. Albrecht, R. G. Barletta, C. J. Czuprynski, Life and death in bovine monocytes: the fate of Mycobacterium avium subsp. paratuberculosis. Microb. Pathog. 43, 106-113 (2007).
10) R. W. Sweeney, D. E. Jones, P. Habecker, P. Scott, Interferon-gamma and interleukin 4 gene expression in cows infected with Mycobacterium paratuberculosis. Am. J. Vet. Res. 59, 842-847 (1998).
11) P. M. Coussens, N. Verman, M. A. Coussens, M. D. Elftman, A. M. McNulty, Cytokine gene expression in peripheral blood mononuclear cells and tissues of cattle infected with Mycobacterium avium subsp. paratuberculosis: evidence for an inherent proinflammatory gene expression pattern. Infect. Immun. 72, 1409-1422 (2004).
12) M. G. Bonecini-Almeida, S. Chitale, I. Boutsikakis, J. Geng, H. Doo, S. He, J. L. Ho, Induction of in vitro human macrophage anti-Mycobacterium tuberculosis activity: requirement for IFN-gamma and primed lymphocytes. J. Immunol. 160, 4490-4499 (1998).
13) J. L. Flynn, J. Chan, K. J. Triebold, D. K. Dalton, T. A. Stewart. B. R. Bloom, An essential role for interferon gamma in resistance to Mycobacterium tuberculosis infection. J. Exp. Med. 178, 2249-2254 (1993).
14) M. Denis, E. O. Gregg, E. Ghandirian, Cytokine modulation of Mycobacterium tuberculosis growth in human macrophages. Int. J. Immunopharmacol. 12, 721-727 (1990).
15) A. K. Robertson, P. W. Andrew, Interferon gamma fails to activate human monocyte-derived macrophages to kill or inhibit the replication of a non-pathogenic mycobacterial species. Microb. Pathog. 11, 283-288 (1991).
16) S. E. Dorman, S. M. Holland, Mutation in the signal-transducing chain of the interferon-gamma receptor and susceptibility to mycobacterial infection. J. Clin. Invest. 101, 2364-2369 (1998).
17) R. Döffinger, E. Jouanguy, S. Dupuis, M. Fondane'che, J. Stephan, J. Emile, S. Lamhamedi-Chemadi, F. Altare, A. Pallier, G. Barcenas-Morales, E. Meinl, C. Krause, S. Pestka, R. D. Schreiber, F. Novelli, J. L. Casanova, Partial interferon-gamma receptor signaling chain deficiency in a patient with bacilli Calmette-Guerin Mycobacterium abscesses infection. J. Infect. Dis. 181, 379-384 (2000).
18) D. K. Dalton, S. Pitts-Meek, S. Keshav, I. S. Figari, A. Bradley, T. A. Stewart, Multiple defects of immune cell function in mice with disrupted interferon-gamma genes. Science 259, 1739-1742 (1993).
19) A. M. Cooper, D. K. Dalton, T. A. Stewart, J. P. Griffin, D. G. Russell, I. M. Orme, Disseminated tuberculosis in interferon gamma gene disrupted mice. J. Exp. Med. 178, 2243-2247 (1993).
20) E. Jouanguy, S. Lamhamedi-Chemadi, D. Lammas, S. E. Dorman, M. C. Fondaneche, S. Dupuis, R. Doffinger, F. Altare, J. Girdlestone, J. F. Emile, H. Ducoulombier, D. Edgar, J. Clarke, V. A. Oxelius, M. Brai, V. Novelli, K. Heyne, A. Fischer, S. M. Holland, D. S. Kumararatne, R. D. Schreiber, J. L. Casanova, A human IFNGR1 small deletion hotspot associated with dominant susceptibility to mycobacterial infection. Nat. Genet. 21, 370-378 (1999).
21) S. Dupuis, R. Doffinger, C. Picard, C. Fieschi, F. Altare, E. Jouanguy, L. Abel, J. L. Casanova, Human interferon-gamma-mediated immunity is a genetically controlled continuous trait that determines the outcome of mycobacterial invasion. Immunol. Rev. 178, 129-137 (2000).
22) J. E. Darnell, STATS and gene regulation. Science. 277, 1630-1635 (1997).
23) E. A. Bach, M. Aguet, R. D. Schreiber, The IFN gamma receptor: a paradigm for cytokine receptor signaling. Annu. Rev. Immunol. 15, 563-591 (1997).
24) K. Igarashi, G. Garotta, L. Ozmen, A. Ziemiecki, A. F. Wilks, A. G. Harpur, A. C. Larner, D. S. Finbloom, Interferon-gamma induces tyrosine phosphorylation of interferon-gamma receptor and regulated association of protein tyrosine kinases, Jak1 and Jak2, with its receptor. J. Biol. Chem. 269, 14333-14336 (1994).
25) E. A. Bach, J. W. Tanner, S. Marsters, A. Ashkenazi, M. Aguet, A. S. Shaw, R. D. Schreiber. Ligand-induced assembly and activation of the gamma interferon receptor in intact cells. Mol. Cell. Biol. 16, 3214-3221 (1996).
26) A. C. Greenlund, M. O. Morales, B. L. Viviano, H. Yan, J. Krolewski, R. D. Schreiber, Stat recruitment by tyrosine-phosphorylated cytokine receptors: an ordered reversible affinity-driven process. Immunity 2, 677-687 (1995).
27) F. Kierszenbaum, H. Mejia Lopez, M. K. Tanner, M. B. Sztein, Trypanosoma cruzi-induced decrease in the level of interferon-gamma receptor expression by resting and activated human blood lymphocytes. Parasite Immunol. 17, 207-214 (1995).
28) M. Ray, A. A. Gam, R. A. Boykins, R. T. Kenney, Inhibition of interferon-gamma signaling by Leishmania donovani. J. Infect. Dis. 181, 1121-1128 (2000).
29) S. Hussain, B. S. Zwilling, W. P. Lafuse, Mycobacterium avium infection of mouse macrophages inhibits IFN-gamma Janus kinase-STAT signaling and gene induction by down-regulation of the IFN-gamma receptor. J. Immunol. 163, 2041-2048 (1999).
30) D. M. Miller, B. M. Rahill, J. M. Boss, M. D. Lairmore, J. E. Durbin, W. J. Waldman, D. D. Sedmak, Human cytomegalovirus inhibits major histocompatibility complex II expression by disruption of the Jak/Stat pathway. J. Exp. Med. 187, 675-683 (1998).
31) N. Fujii, N. Yokosawa, S. Shirakawa, Suppression of interferon response gene expression in cells persistently infected with mumps virus, and restoration from its suppression by treatment with ribavirin. Virus Res. 65, 175-185 (1999).
32) A. Abendroth, B. Slobedman, E. Lee, E. Mellins, M. Wallace, A. M. Arvin, Modulation of major histocompatibility class II protein expression by varicella-zoster virus. J. Virol. 74, 1900-1907 (2000).
33) J. Blanchette, N. Racette, R. Faure, K. A. Siminovitch, M. Olivier, Leishmania-induced increases in activation of macrophage SHP-1 tyrosine phosphatase are associated with impaired IFN-gamma-triggered JAK2 activation. Eur. J. Immunol. 29, 3737-3744 (1999).
34) R. Eckner, M. E. Ewen, D. Newsome, M. Gerdes, J. A. DeCaprio, J. B. Lawrence, D. M. Livingston, Molecular cloning and functional analysis of the adenovirus E1A-associated 300-kD protein (p300) reveals a protein with properties of a transcriptional adaptor. Genes. Dev. 8, 869-884 (1994).
35) D. C. Look, W. T. Roswit, A. G. Frick, Y. Gris-Alevy, D. M. Dickhaus, M. J. Walter, M. J. Holtzman. Direct suppression of Stat1 function during adenoviral infection. Immunity. 9, 871-880 (1998).
36) N. Mookherjee, H. L. Wilson, S. Doria, Y. Popwych, R. Falsafi, J. Yu, Y. Li, S. Veatch, F. M. Roche, K. L. Brown, F. S. L. Brinkman, K. Hokamp, A. Potter, L. A. Potter, L. A. Babiuk, P. J. Gribel and R. E. W. Hancock, Bovine and human cathelicidin cationic host defese peptides similarly suppress transcriptional responses to bacterial lipopolysaccharide. J. Leuko. Biol. 80, 1563-1574 (2006)
37) S. Jalal, R. Arsenault, A. A. Potter, L. A. Babiuk, P. J. Griebel. S, Napper, Genome to Kinome: Species-Specific Arrays for Kinome Analysis. Science Signaling. Sci. Signal. 2, pl1 (2009).
38) W. Huber, A. V. Heydebreck, H. Sultmann, A. Poustka, M. Vingron, Variance stabilization applied to microarray data calibration and to the quantification of differential ex-pression. Bioinformatics, 18 Suppl 1:S96-104 (2002). 39) R Development Core Team. R: A Language and Environment for Statistical

Computing. R Foundation for Statistical Computing, Vienna, Austria. ISBN 3-900051-07-0 (2009).
40) D. C. Montgomery, Design and analysis of experiments. Hoboken, N.J.: Wiley, c2009, 7th edition (2009).
41) B. Everitt, Cluster Analysis. London: Heinemann Educ. Books (1974).
42) J. A. Hartigan, Clustering Algorithms. New York: Wiley (1975).
43) L. L. McQuitty, Similarity Analysis by Reciprocal Pairs for Discrete and Continuous Data. Educational and Psychological Measurement, 26, 825-831 (1966).
44) K. Pearson, Mathematical contributions to the theory of evolution. III. Regression, heredity and panmixia” Philos. Trans. Royal Soc. London Ser. A, 187, 253-318 (1896).
45) M. B. Eisen, P. T. Spellman, P. O. Brown, D. Botstein, Cluster analysis and display of genome-wide expression patterns. Proc. Natl. Acad. Sci. USA, 95(25):14863-8 (1998).
46) D. J. Lynn, G. L. Winsor, C. Chan, N. Richard, M. R. Laird, A. Barsky et al., InnateDB: facilitating systems-level analysis of the mammalian innate immune response. Molecular Systems Biology. 4, 218 (2008)
47) T. Alber, Signaling mechanisms of the Mycobacterium tuberculosis receptor Ser/Thr protein kinases. Curr. Opin. Struct. Biol. 6, 650-657 (2009)
48) M. Schreiber, I. Res, A. Matter, A. Protein kinases as antibacterial targets. Curr. Opin. Cell Biol. 2, 325-330 (2009)
49) L. Ting, A. C. Kim, A. Cattamanchi, J. D. Ernst, Mycobacterium tuberculosis inhibits IFN-gamma transcriptional responses without inhibiting activation of STAT1. J. Immunol. 163, 3898-3906 (1999).
50) Bebek, G. and Yang, J. (2007). Pathfinder: mining signal transduction pathway segments from protein-protein interaction networks. BMC Bioinformatics, 8, 335.
51) Boyle, E. I., Weng, S., Gollub, J., Jin, H., Botstein, D., Cherry, J. M., and Sherlock, G. (2004). Go::termfinder—open source software for accessing gene ontology information and finding significantly enriched gene ontology terms associated with a list of genes. Bioinformatics, 20(18), 3710-5.
52) Chang, L. and Karin, M. (2001). Mammalian map kinase signalling cascades. Nature, 410(6824), 37-40.
53) D\check{r}aghici, S. (2003). Data analysis tools for DNA microarrays. Chapman & Hall/CRC, Boca Raton, Fla.
54) Fletcher, H. A., Keyser, A., Bowmaker, M., Sayles, P. C., Kaplan, G., Hussey, G., Hill, A. V. S., and Hanekom, W. A. (2009). Transcriptional profiling of mycobacterial antigen-induced responses in infants vaccinated with bcg at birth. BMC Med Genomics, 2, 10.
55) Gomase, V. S, and Tagore, S. (2008). Kinomics. Curr Drug Metab, 9(3), 255-8.
56) Grewal, A. and Conway, A. (2000). Tools for analyzing microarray expression data. Journal of the Association for Laboratory Automation, 5(5), 62-64.
57) Hestvik, A. L. K., Hmama, Z., and Av-Gay, Y. (2003). Kinome analysis of host response to mycobacterial infection: a novel technique in proteomics. Infect Immun, 71(10), 5514-22.
58) Hobbs, M. R., Udhayakumar, V., Levesque, M. C., Booth, J., Roberts, J. M., Tkachuk, A. N., Pole, A., Coon, H., Kariuki, S., Nahlen, B. L., Mwaikambo, E. D., Lal, A. L., Granger, D. L., Anstey, N. M., and Weinberg, J. B. (2002). A new nos2 promoter polymorphism associated with increased nitric oxide production and protection from severe malaria in tanzanian and kenyan children. Lancet, 360(9344), 1468-75.
59) Huber, W., von Heydebreck, A., Sueltmann, H., Poustka, A., and Vingron, M. (2003). Parameter estimation for the calibration and variance stabilization of microarray data. Stat Appl Genet Mol Biol, 2, Article 3.
60) Kanehisa, M. and Goto, S. (2000). Kegg: kyoto encyclopedia of genes and genomes. Nucleic Acids Res, 28(1), 27-30.
61) Kanehisa, M., Goto, S., Hattori, M., Aoki-Kinoshita, K. F., Itoh, M., Kawashima, S., Katayama, T., Araki, M., and Hirakawa, M. (2006). From genomics to chemical genomics: new developments in kegg. Nucleic Acids Res, 34(Database issue), D354-7.
62) Kanehisa, M., Goto, S., Furumichi, M., Tanabe, M., and Hirakawa, M. (2010). Kegg for representation and analysis of molecular networks involving diseases and drugs. Nucleic Acids Res, 38(Database issue), D355-60.
63) Kawai, T. and Akira, S. (2007). Tlr signaling. Semin Immunol, 19(1), 24-32.
64) Kristensson, K., Feuerstein, B., Taraboulos, A., Hyun, W. C., Prusiner, S. B., and DeArmond, S. J. (1993). Scrapie prions alter receptor-mediated calcium responses in cultured cells. Neurology, 43(11), 2335-41.
65) Löwenberg, M., Tuynman, J., Scheffer, M., Verhaar, A., Vermeulen, L., van Deventer, S., Hommes, D., and Peppelenbosch, M. (2006). Kinome analysis reveals nongenomic glucocorticoid receptor-dependent inhibition of insulin signaling. Endocrinology, 147(7), 3555-62.
66) Manning, G., Whyte, D. B., Martinez, R., Hunter, T., and Sudarsanam, S. (2002). The protein kinase complement of the human genome. Science, 298(5600), 1912-34.
67) Mardia, K. V., Kent, J. T., and Bibby, J. M. (1979). Multivariate analysis. Probability and mathematical statistics. Academic Press, London.
68) Miller, F. D. and Kaplan, D. R. (2001). Neurotrophin signalling pathways regulating neuronal apoptosis. Cell Mol Life Sci, 58(8), 1045-53.
69) Prusiner, S. B. (1998). Prions. Proc Natl Acad Sci USA, 95(23), 13363-83.
70) Schafer, J. L. (1997). Analysis of incomplete multivariate data. Chapman & Hall, London.
71) Schrage, Y. M., Briaire-de Bruijn, I. H., de Miranda, N. F. C. C., van Oosterwijk, J., Taminiau, A. H. M., van Wezel, T., Hogendoorn, P. C. W., and Bovée, J. V. M. G. (2009). Kinome profiling of chondrosarcoma reveals src-pathway activity and dasatinib as option for treatment. Cancer Res, 69(15), 6216-22.
72) Simons, K. and Toomre, D. (2000). Lipid rafts and signal transduction. Nat Rev Mol Cell Biol, 1(1), 31-9.
73) Smyth, G. K. (2004). Linear models and empirical bayes methods for assessing differential expression in microarray experiments. Stat Appl Genet Mol Biol, 3, Article 3.
74) Teng, K. K. and Hempstead, B. L. (2004). Neurotrophins and their receptors: signaling trios in complex biological systems. Cell Mol Life Sci, 61(1), 35-48.
75) van Baal, J. W. P. M., Diks, S. H., Wanders, R. J. A., Rygiel, A. M., Milano, F., Joore, J., Bergman, J. J. G. H. M., Peppelenbosch, M. P., and Krishnadath, K. K. (2006). Comparison of kinome profiles of barrett's esophagus with normal squamous esophagus and normal gastric cardia. Cancer Res, 66(24), 11605-12.
76) Wettenhall, J. M. and Smyth, G. K. (2004). Iimmagui: a graphical user interface for linear modeling of microarray data. Bioinformatics, 20(18), 3705-6.
77) Cohen P (2002) Protein kinases|the major drug targets of the twenty-first century? Nat Rev Drug Discov 1: 309-315
78) Mann M, Ong S E, Gr nborg M, Steen M, Jensen O N, et al. (2002) Analysis of protein phosphorylation using mass spectrometry: deciphering the phosphoproteome. Trends Biotechnol 20:261-268.
79) Kemp B E, Graves D J, Benjamini E, Krebs E G (1977) Role of multiple basic residues in determining the substrate specificity of cyclic amp-dependent protein kinase. J Biol Chem 252: 4888-4894.
80) Jalal S, Arsenault R, Potter A A, Babiuk L A, Griebel P J, et al. (2009) Genome to kinome: species-specific peptide arrays for kinome analysis. Sci Signal 2: pl1.
81) Fletcher H A, Keyser A, Bowmaker M, Sayles P C, Kaplan G, et al. (2009) Transcriptional profiling of mycobacterial antigen-induced responses in infants vaccinated with BCG at birth. BMC Med Genomics 2: 10.
82) Fundel K, Küffner R, Aigner T, Zimmer R (2008) Normalization and gene p-value estimation: issues in microarray data processing. Bioinform Biol Insights 2: 291-305.
83) Fundel K, Haag J, Gebhard P M, Zimmer R, Aigner T (2008) Normalization strategies for mRNA expression data in cartilage research. Osteoarthritis and Cartilage 16: 947-955.
84) Smyth G K (2004) Linear models and empirical bayes methods for assessing differential expression in microarray experiments. Stat Appl Genet Mol Biol 3: Article 3.
85) 9. Lowenberg M, Tuynman J, Scheer M, Verhaar A, Vermeulen L, et al. (2006) Kinome analysis reveals nongenomic glucocorticoid receptor-dependent inhibition of insulin signaling. Endocrinology 147: 3555-62.
86) Arsenault R J, Jalal S, Babiuk L A, Potter A, Griebel P J, et al. (2009) Kinome analysis of toll-like receptor signaling in bovine monocytes. J Recept Signal Transduct Res 29: 299-311.
87) van Baal J W P M, Diks S H, Wanders R J A, Rygiel A M, Milano F, et al. (2006) Comparison of kinome pro les of barrett's esophagus with normal squamous esophagus and normal gastric cardia. Cancer Res 66: 11605-12.
88) Huber W, von Heydebreck A, Sultmann H, Poustka A, Vingron M (2002) Variance stabilization applied to microarray data calibration and to the quantification of differential expression. Bioinformatics 18 Suppl 1: S96-104.
89) Wettenhall J M, Smyth G K (2004) IimmaGUI: a graphical user interface for linear modeling of microarray data. Bioinformatics 20: 3705-6.
90) Schrage Y M, Briaire-de Bruijn I H, de Miranda N F C C, van Oosterwijk J, Taminiau A H M, et al. (2009) Kinome pro ling of chondrosarcoma reveals SRC-pathway activity and dasatinib as option for treatment. Cancer Res 69: 6216-22.
91) Lynn D J, Winsor G L, Chan C, Richard N, Laird M R, et al. (2008) InnateDB: facilitating systems level analyses of the mammalian innate immune response. Mol Syst Biol 4: 218.
92) Kanehisa M, Goto S (2000) KEGG: Kyoto encyclopedia of genes and genomes. Nucleic Acids Res 28: 27-30.
93) Kanehisa M, Goto S, Hattori M, Aoki-Kinoshita K F, Itoh M, et al. (2006) From genomics to chemical genomics: new developments in KEGG. Nucleic Acids Res 34: D354-7.
94) Kanehisa M, Goto S, Furumichi M, Tanabe M, Hirakawa M (2010) KEGG for representation and analysis of molecular networks involving diseases and drugs. Nucleic Acids Res 38: D355-60.
95) R Development Core Team (2009) R: A Language and Environment for Statistical Computing. R Foundation for Statistical Computing, Vienna, Austria. URL http://www.R-project.org. ISBN 3-900051-07-0.
96) Dorman S E, Holland S M (1998) Mutation in the signal-transducing chain of the interferon-gamma receptor and susceptibility to mycobacterial infection. J Clin Invest 101: 2364-9.
97) Döffnger R, Jouanguy E, Dupuis S, Fondaneche M C, Stephan J L, et al. (2000) Partial interferongamma receptor signaling chain deficiency in a patient with bacille calmette-guérin and mycobacterium abscessus infection. J Infect Dis 181: 379-84.
98) Darnell J E Jr (1997) Stats and gene regulation. Science 277: 1630-5.
99) Pestka S, Kotenko S V, Muthukumaran G, Izotova L S, Cook J R, et al. (1997) The interferon gamma (IFN-gamma) receptor: a paradigm for the multichain cytokine receptor. Cytokine Growth Factor Rev 8: 189-206.
100) Le J, Lin J X, Henriksen-DeStefano D, Vilcek J (1986) Bacterial lipopolysaccharide-induced interferon-gamma production: roles of interleukin 1 and interleukin 2. J Immunol 136: 4525-30.
101) Scheibenbogen C, Keilholz U, Richter M, Andreesen R, Hunstein W (1992) The interleukin-2 receptor in human monocytes and macrophages: regulation of expression and release of the alpha and beta chains (p55 and p75). Res Immunol 143: 33-7.
102) Huber W, von Heydebreck A, Sueltmann H, Poustka A, Vingron M (2003) Parameter estimation for the calibration and variance stabilization of microarray data. Stat Appl Genet Mol Biol 2: Article 3.
103) Dr aghici S (2003) Data analysis tools for DNA microarrays. Boca Raton, Fla.: Chapman & Hall/CRC.
104) Montgomery D C (2009) Design and analysis of experiments. Hoboken, N.J.: Wiley, 7 edition.
105) Barsky A, Gardy J L, Hancock R E W, Munzner T (2007) Cerebral: a Cytoscape plugin for layout of and interaction with biological networks using subcellular localization annotation. Bioinformatics 23: 1040-1042.
106) Shannon P, Markiel A, Ozier O, Baliga N S, Wang J T, et al. (2003) Cytoscape: a software environment for integrated models of biomolecular interaction networks. Genome Res 13: 2498-2504.
107) Pearson K (1896) Mathematical contributions to the theory of evolution. III. Regression, heredity and panmixia. Philos Trans Royal Soc London Ser A 187: 253-318.
108) McQuitty L L (1966) Similarity analysis by reciprocal pairs for discrete and continuous data. Educational and Psychological Measurement 26: 825-831.
109) Everitt B (1974) Cluster Analysis. London: Heinemann Educ.
110) Hartigan J A (1975) Clustering Algorithms. New York: Wiley.
111) Eisen M B, Spellman P T, Brown P O, Botstein D (1998) Cluster analysis and display of genome-wide expression patterns. Proc Natl Acad Sci USA 95: 14863-8.
112) Mardia K V, Kent J T, Bibby J M (1979) Multivariate analysis. London: Academic Press.
113) Smyth G K, Speed T (2003) Normalization of cDNA microarray data. Methods 31: 265-73.
114) Smyth G K, Michaud J, Scott H S (2005) Use of within-array replicate spots for assessing differential expression in microarray experiments. Bioinformatics 21: 2067-75.
115) Wilkie B, Mallard B (1999) Genetic effects on vaccination. Adv Vet Med 4: 39-51.
116) Pal P, Lewis J (2004) Parasite aggregations in host populations using a reformulated negative binomial model. J Helminthol 78: 57-61.
117) Yi A K, Yoon J G, Hong S C, Redford T W, Krieg A M (2001) Lipopolysaccharide and CpG DNA synergize for tumor necrosis factor-alpha production through activation of NF-kappaB. Int Immunol 13: 1391-1404.
118) Hestvik A L K, Hmama Z, Av-Gay Y (2003) Kinome analysis of host response to mycobacterial infection: a novel technique in proteomics. Infect Immun 71: 5514-22.
119) Benjamini Y, Hochberg Y (1995) Controlling the false discovery rate: a practical and powerful approach to multiple testing. J Roy Statist Soc, B 57: 289-300.
120) Witten D, Tibshirani R (2007) A comparison of fold-change and the t-statistic for microarray data analysis. Technical report, Stanford University. URL http://www.stanford.edu/˜dwitten/FCandT/WittenTibshirani07.pdf.
121) Gentleman et al. Missing from the list of references. Genome Biology 2004; 5(10):R80.

1. A method of analyzing a phosphorylation data of a plurality of peptides, each peptide of the plurality present in at least two replicates comprising:
a. obtaining one or more datasets, each dataset comprising a phosphorylation signal intensity for each replicate of the plurality of peptides;
b. transforming the phosphorylation signal intensity of each replicate of the plurality of peptides using a variance stabilizing transformation to provide a variance stabilized signal intensity for each replicate of the plurality of peptides; and
c. identifying one or more peptides of the plurality of peptides that are consistently phosphorylated or consistently unphosphorylated by calculating a phosphorylation consistency value for each peptide of the plurality of peptides, calculating the phosphorylation consistency value optionally comprising calculating a replicate variability for each peptide using the variance stabilized signal intensity of each replicate of the at least two replicates for each peptide.

2. The method of claim 1 wherein the phosphorylation consistency value is calculated using a chi-square (χ²) statistic.

3. The method of claim 1, further comprising determining a phosphorylation characteristic of at least one of the one or more peptides that is consistently phosphorylated or consistently unphosphorylated, and optionally outputting the phosphorylation characteristic.

4. (canceled)

5. The method of claim 1, wherein the method is used to analyse phosphorylation data of more than one subject, and calculating the phosphorylation consistency value in step c) comprises determining subject variability, optionally using a F-test statistic.

6. (canceled)

7. The method of claim 1, wherein the one or more datasets includes a control dataset and an experimental dataset, wherein a control variance stabilized signal intensity for each replicate of the plurality of peptides is calculated for the control dataset according to the method of claim 1 steps a) to b) and optionally subtracted from the variance stabilized signal intensity of each corresponding replicate of the plurality of peptides the experimental dataset.

8. The method of claim 3, wherein the output comprises a graphic representation of the phosphorylation status and/or the phosphorylation consistency value, optionally using colour coding and/or a colour scale.

9. (canceled)

10. (canceled)

11. A method of identifying one or more peptides of a plurality of peptides that are phosphorylated or unphosphorylated, each peptide of the plurality present in at least two replicates, the method comprising:
a. obtaining one or more datasets, each dataset comprising a phosphorylation signal intensity for each replicate of the plurality of peptides for a sample, wherein the dataset is generated using at least one peptide array probed with the sample;
b. transforming the phosphorylation signal intensity of each replicate of the plurality of peptides using a variance stabilizing transformation according to claim 1 step b) to provide a variance stabilized signal intensity for each replicate of the plurality of peptides;
c. determining a phosphorylation consistency value for each peptide of the plurality of peptides wherein the phosphorylation consistency value is a measure of the phosphorylation status variability among replicates and optionally comprises assessing replicate variability of variance stabilized signal intensities using a χ² statistic and/or optionally comprises determining subject variability optionally using an F-test statistic; and
d. identifying one or more peptides identified as consistently phosphorylated or consistently unphosphorylated,
wherein a peptide is identified as consistently phosphorylated or consistently unphosphorylated if the phosphorylation consistency value for the peptide is above a selected consistency threshold.

12. (canceled)

13. (canceled)

14. A method of identifying one or more peptides that are differentially phosphorylated in an experimental sample treated with a stressor compared to a control sample, the method comprising:
a. for a plurality of peptides, each peptide of the plurality present in at least two replicates:
i. obtaining an experimental dataset comprising an experimental phosphorylation signal intensity for each replicate of the plurality of peptides;
ii. obtaining a control dataset comprising a control phosphorylation signal intensity for each replicate of the plurality of peptides;
b. transforming the signal intensity of each replicate of the plurality of peptides using a variance stabilizing transformation according to claim 1 step b) to provide a variance stabilized experimental signal intensity for each replicate of the plurality of peptides of the experimental dataset and a variance stabilized control signal intensity for each replicate of the plurality of peptides of the control dataset:
c. identifying one or more peptides that are consistently phosphorylated or consistently unphosphorylated in the experimental dataset, optionally by assessing replicate variability of variance stabilized signal intensities using a χ² test and/or by assessing subject variability optionally using a F-test statistic;
d. identifying one or more peptides that are consistently phosphorylated or consistently unphosphorylated in the control dataset, optionally by assessing replicate variability of variance stabilized signal intensities using a χ² test and/or by assessing subject variability (such as animal to animal variability) using a F-test statistic;
e. determining an overlapping set of peptides consistently phosphorylated or consistently unphosphorylated in the experimental dataset and the control dataset;
f. for the set of peptides consistently phosphorylated or consistently unphosphorylated in the experimental dataset and the control dataset, calculating a variability value of the variability between the variance stabilized experimental signal intensity and the variance stabilized control signal intensity for each peptide, optionally using a one-sided t-test; and
g. identifying one or more peptides that is/are differentially phosphorylated in the experimental sample compared to the control sample.

15. (canceled)

16. (canceled)

17. The method of claim 14, wherein a plurality of differentially phosphorylated peptides are identified, the method further comprising clustering the average of the variance stabilized VSN transformed replicates.

18. (canceled)

19. A method for comparing kinome data between a control sample and an experimental sample treated with a stressor, comprising:
a. obtaining an experimental dataset according to claim 14(a)(i), each peptide present in at least 2 replicates;
b. obtaining a control dataset according to claim 14(a)(ii), each peptide present in at least 2 replicates;
c. transforming the phosphorylation signal intensity of each replicate of the plurality of peptides of the experimental dataset and of the control dataset using a variance stabilizing transformation to provide an experimental variance stabilized signal intensity and a control stabilized signal intensity respectively for each replicate of the plurality of peptides;
d. averaging the replicate experimental variance stabilized signal intensities and the replicate control variance stabilized signal intensities for each peptide to obtain for each peptide, an average experimental intensity and an average control intensity respectively; and
e. clustering the average replicate intensities optionally by hierarchical clustering or principal component analysis.

20. The method of claim 19 wherein step c) further comprises subtracting the control intensity from the experimental intensity and performing the cluster analysis on the subtracted treatment intensity.

21. The method of claim 1, wherein one or more of the phosphorylation datasets comprises foreground and background phosphorylation signal intensities for each replicate and the phosphorylation signal intensity for each replicate is obtained by subtracting each background phosphorylation intensity from each foreground phosphorylation signal intensity for each replicate.

22. (canceled)

23. The method of claim 14, wherein the stressor comprises a biological agent, a physical agent, or a chemical agent.

24. (canceled)

25. (canceled)

26. The method of claim 1, wherein the phosphorylation signal intensity comprises a fluorescent signal intensity or a radioactive signal intensity.

27. (canceled)

28. (canceled)

29. (canceled)

30. (canceled)

31. The method of claim 1, comprising one or more of the following:
a) wherein the signal intensity of each replicate is transformed using R package vsn;
b) wherein determining the phosphorylation consistency value comprises determining x² statistic (TS₁) wherein:
$${TS}_{1} = \frac{( n - 1 ) {s}^{2}}{{σ}^{2}}$$
wherein n is the number of replicates for each peptide for each sample, wherein s²=1/nΣᵢ₌₁ⁿ(yᵢ− y̅)² which is a sample variance of the replicates for each peptide of the sample, wherein \hat{σ}²=1/MΣⱼ₌₁^{M}sⱼ² which is a mean of all the variances for the replicates of the plurality of peptides (M); and p-value=P[TS₁>χ²(n−1)];
c) wherein the method comprises comparing more than one subject or experimental sample and subject variability is determined by assessing whether there are significant differences among samples treated with a same stressor using a F-test statistic calculated as:
TS₂=MS_{B}/MS_{W}; or
d) wherein one or more peptides that is/are differentially phosphorylated in the experimental sample compared to the control sample, is/are identified using a one-sided paired t-test, and wherein the p-value is calculated as:
p-value=P[TS₃>t(n−1)](phosphorylation)
p-value=P[TS₃<−t(n−1)](dephosphorylation)
wherein peptides with a p-value less than a selected threshold are differentially phosphorylated.

32. (canceled)

33. (canceled)

34. (canceled)

35. (canceled)

36. The method of claim 31, wherein the differentially phosphorylated peptides have a p-value of less than 0.05 or 0.01 and/or wherein the one-sided paired t-test is calculated using R program t.test with paired=True.

37. (canceled)

38. The method of claim 36, wherein the p-value for each differentially phosphorylated peptide is displayed in a Table or as a graphic, optionally as a pseudoimage, wherein the p-value is represented using a colour scale, wherein depth of coloration is inversely related to the p-value.

39. (canceled)

40. (canceled)

41. (canceled)

42. The method of claim 38, wherein the graphic is generated using R program plot, rgb and/or polygon.

43. The method of claim 1, wherein the method further comprises querying a database comprising protein annotations for descriptive terms associated with a plurality of proteins to compile a list of descriptive terms associated with the one or more peptides identified as consistently phosphorylated or consistently unphosphorylated and/or differentially phosphorylated.

44. The method of claim 43, wherein querying a database comprising protein annotations for descriptive terms associated with a protein comprising the peptide, optionally gene ontology (GO) terms, comprises inputting a protein identifier for the protein comprising the peptide, optionally an accession number such as a UniProt accession number or an Entrez Gene ID, and optionally generating a list of characteristic terms, optionally GO terms, for one or more of the plurality of peptides, optionally:
a) wherein the list of GO terms is ranked according to frequency;
b) wherein GO terms with a predetermined frequency are identified as common GO terms; or
c) wherein the list of GO terms, optionally common GO terms, is outputted to a table, and at least one of the one or more differentially phosphorylated peptides is mapped to the GO term or terms identified.

45. (canceled)

46. (canceled)

47. (canceled)

48. (canceled)

49. (canceled)

50. The method of claim 20, wherein the clustering comprises a hierarchical clustering method and/or a principal component analysis (PCA) to cluster the one or more peptides according to treatment and/or sample-treatment combinations, optionally wherein the hierarchical clustering method comprises considering each subject/treatment combination as a cluster with a single element; identifying two most similar clusters and merging the two most similar clusters; and iteratively calculating a distance between remaining clusters and the merged cluster to cluster the kinomic profiles of one or more peptides that are consistently phosphorylated.

51. (canceled)

52. The method of claim 50, wherein the hierarchical clustering method comprises a clustering method and a distance measurement optionally “Average Linkage+(1−Pearson Correlation)”; “Complete Linkage+Euclidean Distance”; and “McQuitty+(1−Person Correlation)”, optionally wherein the hierarchical clustering is performed using R program heatmap.2 from the glpots package and/or wherein the PCA is performed using R program prcomp from the stats package.

53. (canceled)

54. (canceled)

55. A computerized control system for controlling and receiving data, the computerized control system comprising at least one processor and memory configured to provide:
a. a control module 20 to receive one or more datasets, each dataset comprising a plurality of phosphorylation signal intensities, each signal intensity corresponding to a replicate of a peptide, each peptide present in at least two replicates;
b. an analysis module 30 to:
i. transform the phosphorylation signal intensity to provide a variance stabilized signal intensity for each replicate of the plurality of peptides using a variance stabilizing transformation;
ii. determine a phosphorylation consistency value for each peptide; and
iii. identify for consistently phosphorylated or consistently unphosphorylated peptides, one or more peptides differentially phosphorylated compared to a control, optionally using a t-test.

56. (canceled)

57. A non-transitory computer-readable storage medium comprising an executable program stored thereon, wherein the program instructs a processor to perform the following:
a. transform a phosphorylation signal intensity for each replicate of a plurality of peptides using a variance stabilizing transformation;
b. determine a phosphorylation consistency value for each peptide; and
c. identify one or more peptides consistently phosphorylated or consistently unphosphorylated based on the phosphorylation consistency value.
